(19) United States
(12) Patent Application Publication
(10) Pub. No.: US 2017/0029716 A1
(43) Pub. Date: Feb. 2, 2017

(54) APPARATUS AND PROCESS FOR REMOVAL OF WATER (BOTH BOUND AND UNBOUND) FROM PETROLEUM SLUDGES AND EMULSIONS THROUGH APPLICATION OF HEAT ALONE, WITH VIEW TO RETRIEVE ENTIRE HYDROCARBONS PRESENT THEREIN

(71) Applicant: NAGAARJUNA SHUBHO GREEN TECHNOLOGIES PRIVATE LIMITED, Hyderabad (IN)

(72) Inventor: Dhruva Jyoti Dasgupta, Hyderabad (IN)

(21) Appl. No.: 15/122,070

(22) PCT Filed: Mar. 4, 2015
(86) PCT No.: PCT/IN2015/050018

§ 371 Date: Aug. 26, 2016

(30) Foreign Application Priority Data
Mar. 6, 2014 (IN) 4008/CHE/2013

(51) Int. Cl. C10G 33/00; B01D 1/00; C10G 7/00; B01D 5/00; C02F 1/16; C02F 1/08; B01D 19/04

(52) U.S. Cl. CPC C10G 33/00; C02F 1/08; B01D 1/0058; B01D 1/0047; B01D 19/04; B01D 5/006; B01D 5/0069; B01D 1/0082; C02F 1/16; C10G 7/00; C02F 2103/365

(57) ABSTRACT

The present invention discloses a process and an apparatus for treatment of petroleum sludges, emulsions and water bearing hydrocarbons wherein initially unbound water; salts; solids; water-free, free-flowing hydrocarbons are removed followed by separation into plurality of fractions that undergo rapid foam induced boiling and consequent steam-stripping of low boiling hydrocarbons from viscous hydrocarbons followed by hot water spray to enhance said foaming and steam-stripping, for further removal of fine water droplets present in a thin film through boiling during thermal foam breaking. The high boiling point water droplets are boiled out in the thermal foam breaker followed by separation of entrained liquid, condensation and separation of water and low boiling hydrocarbons. The residual water fraction in viscous hydrocarbons is removed through thin film boiling. The original hydrocarbons are recovered in marketable forms in two separate fractions thereby recovering bound and unbound water for environmentally safe applications thereof.

### FIELD OF THE INVENTION

The present invention relates to processes for treatment of petroleum/crude sludge, and emulsions. More particularly, the present invention relates to a process and an apparatus for removal of bound water from crude, sludges, emulsions, any oil or fat or hydrocarbon or mixtures thereof, preferably after desalting and removing solids from therein.

### BACKGROUND OF THE INVENTION

In refineries, production, transportation, storage and refining of the crude oil mostly create sludge. Sludge is generally a tightly held viscous emulsion of oil, water and solids wherein the solid content could vary widely. Whenever oil and water is mixed and agitated, the sludge is formed. In refineries, sludge is also formed in the desalting unit where crude is washed with fresh water to remove alkalis that had ingressed with seawater. Also, the sludge gets produced in hydro-crackers, crude storage tanks, slop oil, API separators and the like. Normally 1.6 Kg of sludge is produced per ton of crude. As per 1992 US-EPA report, petroleum refineries unavoidably generate about 30,000 tons of oil sludge waste streams per year per refinery. More than 80% of this sludge comes under the EPA hazardous waste nos. F037 and F038. In India, more than 2.62 lac ton of sludge is being produced in a year.

Sludge also gets formed, when water in crude is vigorously agitated/sheared by transfer pumps. Being heavier than light oils, the sludge tends to settle at the bottom of ship load, but gets removed from ship, when crude is pumped out at the refinery. Apart from that, tank sludge, which is a solid layer that accumulates with time at ship bottom, is removed once in 5 years or so. Typically a 60-M tank disgorges 1,000 MT of material. About 85 to 90% of it constitutes heavy hydrocarbons like paraffin, asphalt, micro-crystalline wax, etc. Often this material is removed using high pressure water jets. Sludge also gets generated in post refinery operations. When heavy liquid fuels like LSHS or furnace oil are used for power generation through low speed DG sets 0.5 wt % to 1 wt % sludge gets formed. These DG sets could either be land based or marine. Sludge also gets produced in waste-oil re-conditioning plants. Formation of sludge is a great problem in overall world.

Accordingly, it is evident that petroleum sludge is a huge issue all around the world. Each year US produces 30,000 tons of oily sludge, whereas China produces about 3 million tons of sludge each year. Even with all the developments made in the petroleum industry, we produce 1 ton of oily sludge waste for every 500 tons of crude oil that is processed. There have been several inventions made to solve this problem and yet there is 11.589 billion tons of sludge sitting in lagoons containing 5.79 billion tons of crude oil.

There are various efforts seen in the art for treating the sludge using various techniques for removing water from petroleum sludges using various techniques like centrifugation, distillation, heating and use of de-emulsifiers. However, none of the above techniques has been found satisfactorily effective to remove bound water. The term “Bound water” referred herein is defined as water that cannot be separated from hydrocarbons after subjecting it to centrifugation at 21,893 RCF for 10 minutes.

For example, International Patent Publication No. WO 2012141024 teaches a method for recovering oil fraction in crude oil sludge by heating said sludge in a vacuum vaporizing chamber up to temperature of 70-150° C. under pressure −85 to −100 kPa. The sludge is also continuously agitated by an impeller. However, maintaining such low pressure in the process may increase operating cost as well as capital cost. In addition, use of impeller to agitate high viscosity sludge is energy intensive. The process in cited patent document does not have any provision for handling high foaming sludges, hence cannot be used universally for all sludges. Moreover, impeller assisted agitation may increase the amount of foam formed during the process by incorporating air bubbles into foam due to low surface tension of liquid. Further, said process fails to disclose or suggest removal of solids from the sludge prior to heating it to remove water. In addition, it may cause fouling and scaling on heat transfer surfaces equipments used in said process. Moreover, separation of solids from hydrocarbons may lead to loss of hydrocarbons due to oily solids or increase the cost of de-oiling of solids.

Also, Russian Patent document No. RU 2417245 provides a method of dewatering highly stable water-hydrocarbons emulsions by heating and evaporation of water phase of emulsion under mechanical agitation. However, agitation provided in said method is such that Reynolds number is greater than 2300, which requires high RPM during agitation and hence more energy to rotate viscous sludge at the high RPM. The cited method of dewatering has limitations to process highly viscous emulsions like bitumen resins which cannot be completely dewatered at 100° C.-120° C. by boiling in an evaporator. Hence, more stable sludge needs to be processed multiple times by re-circulating back into the evaporator using cited method for dewatering thereby resulting into an inefficient method for dewatering of viscous emulsions. Moreover, stable foams may form in said process due to presence of emulsifiers in the sludge which are highly difficult to be broken by mechanical agitation present in pool of liquid. Moreover, said process is incompetent to handle foaming as it could make foaming even worse by incorporating air bubbles into the liquid.

In addition, Canadian Patent document No. CA 1201403 discloses an apparatus for boiling emulsion and a process for implementing the same. The apparatus in cited patent document includes inclined trays onto which sludge flows as a thin layer. However, substantially long length of these trays is not sufficient enough to remove vapours formed by boiling. The apparatus includes limited number of trays hence there are less chances for the vapours trapped in sludge to escape when sludge flows from one tray to the next tray. Also, the vapours under the layer of sludge may increase the velocity of liquid flow as well as reduce the rate of heat transfer to liquid during the operation. The apparatus retains hydrocarbons in the evaporator after water removal in quiescent condition to further separate solids and allowing any water vapour to break out thereby effectively increases overall residence time for which the sludge remains in the evaporator without any increase in residence time of liquid in contact with heating surface that is important for boiling out water from sludge. Thin film evaporator in the cited patent document is a complex and expensive equipment which is necessarily used in cases where removal of water is difficult and other mechanisms for water removal are not viable. The thin film evaporator is not optimal enough for the sludge with high water content as it causes intense foaming of the sludge leading to entrainment. Moreover, solids separation from hydrocarbons using said apparatus may lead to loss of hydrocarbons due to oily solids or alternatively it may increase the cost of de-oiling of solids.

Further, U.S. Pat. No. 4,904,345 teaches a method and apparatus for cleaning petroleum emulsion thereby heating said emulsion in an evaporator to remove water therein. According to the cited patent document, the evaporator consists of multiple sections that hold shallow pool of liquid which are subsequently heated to varying temperature. The temperature within the evaporator varies from 230° F. to 350° F. that leads to unnecessary heating of the hydrocarbons at high temperature. Moreover, the shallow liquid pool formed in said evaporator may lead to trapping of water vapour in the liquid. Hence, more time and higher temperature are required to remove water in liquid or vapour form. The cited thin film evaporator is a complex and expensive equipment that is used in cases where removal of water is difficult and other mechanisms for water removal are not viable. The thin film evaporator is not optimal for sludge with high water content, as it would cause intense foaming of the sludge thereby leading to entrainment. The oily solids separated from sludge are mixed with fuel oil and an oxidizer to make solids usable in a furnace depending on the type of minerals present in the sludge as such fuel with solids may severely damage the furnace.

In addition, U.S. Pat. No. 3,840,468 and European Patent document No. 2512615 disclose processes to treat sludge by boiling with the help of a thin film, however they utilize a falling film evaporator to achieve that objective. The cited patent document U.S. Pat. No. 3,840,468 discloses a process to treat used oil and water emulsion in a falling film evaporator while a scraper continuously spreads said emulsion onto the heating surface to maintain the thin film for a longer residence time. However, said scrapers consume more energy to spread the sludge and also residence time provided by such arrangement is not sufficient enough to remove entire bound water. The cited Patent document EP 2512615 discloses a process for handling mud containing oil-water emulsion, consisting of an emulsion decomposing device that applies high voltage electric current for desorption of emulsion from solids. Thereafter, said process boils entire oil water phase followed by condensation thereof to obtain separated oil and water. This cited process utilizes huge amount of electricity for desorbing emulsion and consumes substantial heat energy at high temperature to vaporize entire oil and water content of mud.

Further, International Patent Publication No. WO 2013043728 discloses an apparatus for removing volatile contaminants from oil comprising of a distillation chamber with cascading steps on which, pressurized, hot, lubricating oil is passed. The cited steps have a sharp edge to break the velocity of oil providing necessary turbulence and enhance residence time wherein about three such steps are provided. However, residence time for 3 steps is not sufficient enough for complete removal of water thereby requiring multiple passes for complete dewatering of the oil. Moreover, substantial energy is required for pumping and re-pressurizing oil for providing multiple passes of oil in the distillation chamber. Also not direct heating source is provided to distillation chamber rather heat from oil is in turn relied upon for vaporization of volatile contaminants which is observed to be a substantially inefficient method for removing water from the oil.

In addition, U.S. Pat. No. 5,240,617 discloses phase separation equipment and method for thermally separating water oil emulsion. The apparatus in cited patent document employs mechanical agitation through an impeller and fluidization through air bubbles. However, mechanical agitation is energy intensive due to high viscosity of sludge and in order generates fine air bubbles through a multitude of openings such that air has to be compressed to a very high pressure thereby again requiring a lot of energy. Moreover, the sludge with emulsifier present cause formation of lot of foam due to air bubbles trapped in the sludge due to lower surface tension thereof.

Moreover, U.S. Pat. No. 4,197,190 discloses a process for dehydrating tar that includes passing hot sludge through an atomizer to vaporize water present therein. Also, the viscosity of sludge is very high even at temperature close to boiling point of water. Hence, high pressure needs to be applied to atomize sludge with high viscosity, which makes it a complex and energy intensive mechanism for dewatering sludge. In addition, atomizing the sludge with emulsifiers may cause intense foaming and said foams are difficult to break as vapour bubbles are stabilized by emulsifiers. If solids are present in sludge, atomization will not work as solids can choke the atomizer opening.

In addition, U.S. Pat. No. 4,477,356 discloses a method and apparatus for separating emulsion by heating alone. The apparatus described in cited patent document does not have direct heating to separating chamber itself. Instead, said apparatus includes a recirculating stream that is superheated which is an inefficient mode of heating the bulk of sludge. Moreover, oil is continuously recovered from separating chamber in said process while that may get mixed with fresh sludge in separating chamber. Further, the sludge containing emulsifiers causes intense foaming due to agitation provided by recirculating stream. Moreover, if foam enters the recirculating stream in said process then it may seriously damage the recirculating pump by cavitations.

Moreover, U.S. Pat. No. 5,269,906 discloses a process for recovery of oil from waste oil sludges specifically from low viscosity waster oil sludges. However, the cited process is not equipped to treat viscous hydrocarbon sludges on its own without diluting the sludge to reduce its viscosity. In addition, the cited process is incompetent to remove solids that are not removed from sludge before heating it to remove water. This may cause fouling and scaling on heat transfer surfaces. In said process, both water and hydrocarbons are boiled from the sludge leave friable solids as residue. The sludge is exposed to very high temperature in said process, up to 400° F. during water removal and up to 700° F. during oil boiling, which is likely to damage the hydrocarbons present in sludge due to thermal cracking of said hydrocarbons thus diminishing the overall commercial value of recovered hydrocarbons. Moreover, the energy and utility requirement for heating the sludge to 700° F. in said process requires lot of energy.

In addition, the United States Patent document U.S. Pat. No. 3,692,668 discloses a process for recovery of oil from refinery sludges by adding oil diluent to make the sludge that can be pumped by reducing its viscosity. However, the diluents used in said process are likely to be contaminated by high boiling hydrocarbons present in sludge thereby reducing effectiveness of overall process. In said process, the solids are not removed from the sludge before heating it to remove water. This may cause fouling and scaling on heat transfer surfaces used in said process. In the cited process, both water and hydrocarbons are boiled from the sludge thereby leaving friable solids as residue. The sludge is exposed to very high temperature in the cited process, up to 800° F., that is likely to damage the hydrocarbons present in the sludge by thermal cracking thus diminishing overall commercial value of recovered hydrocarbons. Moreover, heating of the sludge to 800° F. requires lot of energy in the cited process. Similar high temperatures are used in United States patent document No. U.S. Pat. No. 4,512,878, wherein a process for used oil re-refining is disclosed. In the cited process, the sludge is heated to 300° C. under vacuum in a thin film evaporator to remove water and other impurities from lubricating oil.

Russian Patent document No. RU 2490305 discloses a method for treatment of stable emulsified crude oils and used oil sludge. The cited method of treatment includes holding the sludge for 48-72 hrs at 100°-102° C. This is observed to be a very slow process for dewatering of the sludge. In addition, the cited process may lead to a plurality of losses such as condensation of vapours in evaporation chamber and losses to surrounding due to poor insulation. Moreover, holding the sludge for 3 days at 100° C. is also very energy intensive hence not an economically viable option for dewatering viscous sludges. In cited process, some vapors may remain trapped in the sludge after 72 hours. If the sludge is highly viscous then escape of vapours from the sludge is not aided by ant other mechanism like agitation or thin film evaporation.

Accordingly, there exists a need of a process and an apparatus for removal of entire water, preferably bound water, either entirely by itself or in combination with other processes, from Petroleum or Hydrocarbon Sludges and Emulsions, preferably after removal of salts and solids from therein, at a fastest rate, with least rise in sludge/emulsion temperature, thereby retrieving entire hydrocarbons present therein in a marketable form with highest commercial value thereof.

### SUMMARY OF THE INVENTION

In an embodiment, the present invention discloses a process wherein petroleum sludges, emulsions and water bearing hydrocarbons, preferably with determined quantity of water present are processed. The process comprising an initial step of pretreating a sludge mixture for removal of unbound water; salts; solids; water soluble emulsifiers; water-free, free flowing hydrocarbons followed by segregating remaining sludge on account of viscosity using a plurality of separation equipments for recovering a plurality of fractions therefrom. In next step, the recovered fractions in earlier step are separately treated for removal of both bound and unbound water by a rapid foam induced boiling in a heating vessel with heat induced turbulent circulation of liquid through a distributed, multi layered, rapid heat flux leading to rapid generation of a foamed mass consisting of vapours of water and steam-stripped low boiling hydrocarbons, and a film consisting of remaining hydrocarbons and high boiling, smaller sized, dispersed water droplets. In next step, a fine spray of hot water is sprayed at the end of foam stage with a view to sustain foaming of the mass over an even longer period to aid steam-stripping of even more of low boiling hydrocarbons from viscous hydrocarbons and also to facilitate further removal of fine water droplets present in thin film through boiling during thermal foam breaking. In next step, the foamed layer in earlier steps is treated with a thermal foam breaker thereby additionally boiling out higher boiling point fine water droplets from thin foam layer followed by separating vapours of water and low boing hydrocarbons from liquid and aiding their easy release from very low density and low viscosity layer, thus avoiding their subsequent condensation and entrainment in viscous hydrocarbons once foams subside. In next step, entire fraction of water contained in said viscous hydrocarbons is removed through thin film boiling along with further steam stripping of even high boiling hydrocarbons with substantially reduced heat flux over an extended time as the thin film requires less superheat for vapour to expand for facilitating escape thereof from said viscous hydrocarbons thereby avoiding explosive discharge of said vapour without overheating. In final step, the original hydrocarbons are recovered in two separate fractions, one a viscous layer as residue and the other a lighter fraction collected through steam-stripping, in marketable forms with highest possible commercial value thereof in addition to recovering bound and unbound water present in said sludge mixture for subsequent, environmentally safe and useful applications thereof.

In an alternative embodiment, the present invention provides an apparatus for boiling sludges, emulsions and water bearing hydrocarbons under intense foaming conditions. The apparatus includes a heating vessel having conical or conical frustum shape. The heating vessel has a surface heated by circulating hot heating oil. The heated surface heats a sludge mixture in the heating vessel thereby forming a mass of foam therein. The heating vessel includes a hot water dispenser positioned therein. The hot water dispenser disperses fine spray of water towards a heating surface at a bottom portion of the heating vessel. The fine spray of water has a diameter in a range of 10 μm to 150 μm. The hot water dispenser disperses fine droplets only after foam boiling begins to subside for sustaining foaming for a longer period of time.

The apparatus of the present invention also includes a foam breaker that receives the foam from the heating vessel. The foam breaker includes a series of heated, inclined tubes positioned therein at a predefined angular orientation. Each heated tube has a narrow slit section that is connected longitudinally across a length thereof. The foam breaker has substantially hot heating oil circulating across entire outer surface thereof. The heated tubes have a distended volume for aiding separation of vapours from the foam. The heated tube and narrow slit section ruptures the foam film surrounding said vapours thereby allowing separated vapours with or without entrained liquid droplets to pass through a liquid droplet collector. The thermal foam breaker sends back the liquid into the heating vessel preferably through a bottom portion thereof such that said liquid is not in contact with vapour. The liquid droplet collector removes entrained liquid droplets from outgoing vapour thereby sending back the collected liquid into the heating vessel preferably through a bottom portion thereof such that said liquid is not in contact with vapour. The thermal foam breaker and liquid droplet collector dispense collected liquid below the liquid level in the heating vessel.

### BRIEF DESCRIPTION OF DRAWINGS

FIG. 1 is a process flow diagram showing a process for boiling out bound water from petroleum crude, viscous hydrocarbon sludges and emulsions in accordance with the present invention;

FIG. 2 is a process flow diagram showing a process for rapidly boiling out bound water from non-viscous sludges and emulsions at least temperature;

FIG. 3 illustrates a laboratory scale setup of an apparatus for boiling of highly viscous sludge in accordance with the present invention;

FIG. 4 illustrates a laboratory scale setup of an apparatus for boiling of non-viscous sludge in accordance with the present invention;

FIG. 5 illustrates an anti-blasting apparatus for boiling of highly viscous sludge in accordance with the present invention;

FIG. 6A illustrates a perspective view of a thermal foam breaking apparatus for boiling of sludge with intense foaming in accordance with the present invention;

FIG. 6B is a front view of the thermal foam breaking apparatus of FIG. 6A;

FIG. 6C is a partially expanded cross-sectional view of section the thermal foam breaking apparatus of FIG. 6B taken along lines A-A;

FIG. 6D is a partially expanded cross-sectional view of a section-C of the thermal foam breaking apparatus of FIG. 6B;

FIG. 6E is a partially expanded cross-sectional view of a section-B of the thermal foam breaking apparatus of FIG. 6B;

FIG. 7A illustrates a perspective view of a thermal foam breaking apparatus for boiling all varieties of sludges with extremely high heat flux in accordance with the present invention;

FIG. 7B is a front view of the thermal foam breaking apparatus of FIG. 7A;

FIG. 7C is a partially expanded cross-sectional view of section the thermal foam breaking apparatus of FIG. 7B taken along lines D-D;

FIG. 7D is a partially expanded cross-sectional view of a section-F of the thermal foam breaking apparatus of FIG. 7B;

FIG. 7E is a partially expanded cross-sectional view of a section-E of the thermal foam breaking apparatus of FIG. 7C;

FIG. 7F is a perspective view of the section-E of the thermal foam breaking apparatus of FIG. 7E;

FIG. 8 is a graphical representation of a temperature profile for boiling 300 g furnace oil sludge;

FIG. 9 is a graphical representation of a temperature profile for boiling 900 g furnace oil sludge;

FIG. 10 is a graphical representation of an instantaneous rate of water collected (g/min) vs. temperature (° c.) by boiling 900 g of furnace oil sludge with different minutes of mixing;

FIG. 11 is a graphical representation of a cumulative wt. % of water collected vs. temperature (° c.) by boiling 900 g of furnace oil sludge with different minutes of mixing;

FIG. 12 is a graphical representation of an instantaneous rate of water collected (g/min) vs. temperature (° c.) by boiling 900 g of furnace oil sludge with different heating rates

FIG. 13 is a graphical representation of an instantaneous rate of water collected (g/min) vs. temperature (° c.) by boiling 700 g of furnace oil sludge in an RB flask using an oil bath;

FIG. 14 is a graphical representation of an instantaneous rate of water collected (g/min) vs. temperature (° c.) by boiling 700 g of furnace oil sludge in a conical flask using an oil bath;

FIG. 15 is a graphical representation of a temperature profile of boiling 2000 g sludge (test-1); and

FIG. 16 is a graphical representation of a temperature profile of boiling 2000 g sludge (test-2).

### DETAILED DESCRIPTION OF THE INVENTION

The invention described herein is explained using specific exemplary details or better understanding. However, the invention disclosed can be worked on by a person skilled in the art without the use of these specific details.

References in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

References in the specification to “preferred embodiment” means that a particular feature, structure, characteristic, or function described in detail thereby omitting known constructions and functions for clear description of the present invention.

In the description and in the claims, the term “Sludge” is defined broadly a mixture of hydrocarbons, solids, salts, emulsifiers, unbound water and bound water thereby having a viscosity varying from about 10 centiPoise (cP, hereinafter) to 1,25,000 cP at 30° C.

In the description and in the claims, the term “Free flowing hydrocarbons” is a mixture of hydrocarbons with or without bound water, solids and salts thereby having a viscosity values less than about 100 cP at 30° C.

In the description and in the claims, the term “Viscous hydrocarbons” is a sludge mixture having bound water, solids, salts and viscosity values from about 100 cP to 1,25,000 cP at 30° C.

In the description and in the claims, the term “Non-viscous Sludge” is broadly defined as solids-free, salts-free non-viscous hydrocarbons with bound water.

In the description and in the claims, the term “Solids” are the materials whose content can vary from 0 to 80% of the total material.

In the description and in the claims, the term “Bound Water” is defined broadly as water that does not come out from hydrocarbon inspite centrifuging the sludge at 21893 RCF for at least 10 minutes.

In the description and in the claims, the term “Unbound Water” is defined broadly as any water apart from bound water.

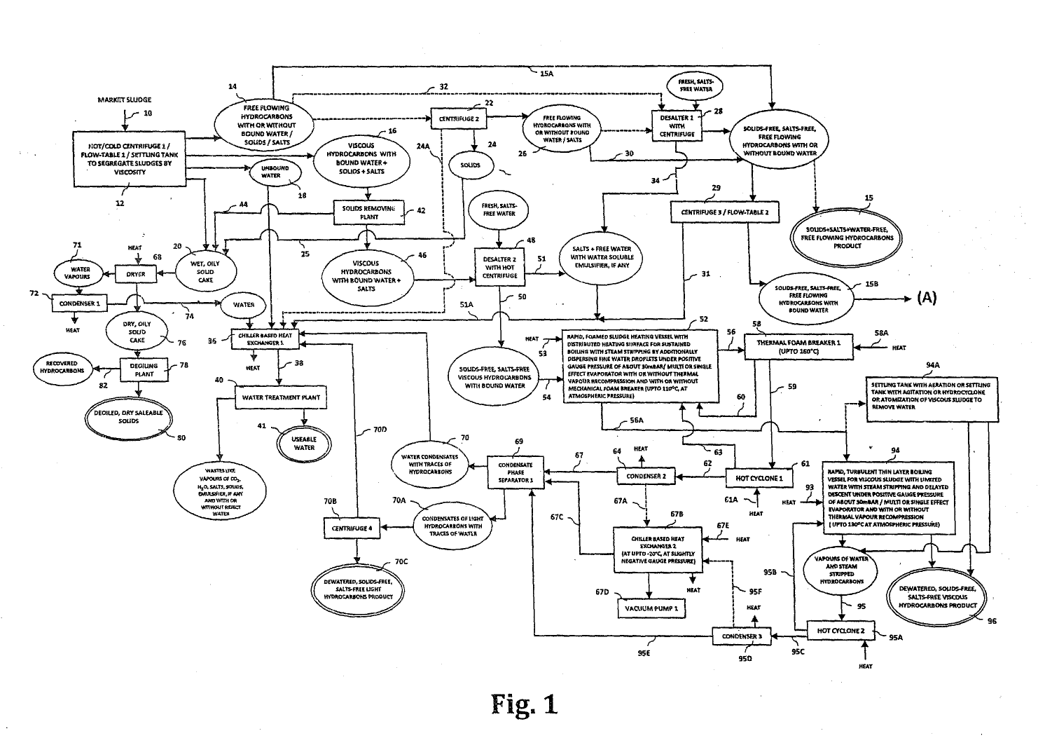

Referring to FIG. 1, a process for boiling out bound water from petroleum crude, viscous hydrocarbon sludges and emulsions in accordance with the present invention is shown. In the context of the present invention, the sludge mixture is a market sludge that acts as a feed stream 10. In an initial step, the feed stream 10 is fed to a centrifuge 12 to segregate sludges on account of viscosity. In this one embodiment the centrifuge 12 is selected from a hot centrifuge, a cold centrifuge, a flow table, a settling tank and the like, either alone or in combination, to segregate sludge in the feed stream 10 on account of viscosity. The centrifuge 12 is maintained at a temperature range of about 30° C. to 95° C. The centrifuge 12 separates a free flowing hydrocarbon layer 14 from a viscous hydrocarbon layer 16 thereby removing an unbound water layer 18 and retaining a residual wet, oily solid cake layer 20 in the centrifuge 12.

The free flowing hydrocarbon layer 14 contains free flowing hydrocarbons with or without bound water, solids and salts. The free flowing hydrocarbon layer 14 is directly stored as a solids-free, salts-free, water-free free flowing hydrocarbon product 15 thereby recovering the same along line 15A, if it is free from salts, solids and bound water. Alternatively, the free flowing hydrocarbon layer 14 is sent to a centrifuge 22 if it contains solids with or without salts. The centrifuge 22 separates solids along line 24 and a water layer along line 24A, if any, thereby obtaining a free flowing hydrocarbon layer 26 with or without bound water and salts. The solids separated along line 24 are mixed with the wet, oily solid cake layer 20 along line 25 as shown. The free flowing hydrocarbon layer 26 is sent to a desalter with centrifuge 28, if salts are present therein. Alternatively, the free flowing hydrocarbon layer 26 is passed along line 30 if it contains bound water without any salts or solids present therein. The free flowing hydrocarbon layer 14 is stored as solids-free, salts-free, water-free free flowing hydrocarbon product 15 if it is free from bound water else it is treated in a centrifuge or flow-table 29 for separating water along line 31 for obtaining solids-free, salts-free, free flowing hydrocarbons with bound water 15B that is used in further process as an input material along line-A. In one embodiment, the free flowing hydrocarbon layer 14 is directly sent to the desalter with centrifuge 28 along line 32 without being passed through the centrifuge 22, if it is free from solids. In this step, a predefined amount of salts-free water is added in the desalter with centrifuge 28 thereby obtaining a free water layer 34 containing salts with water soluble emulsifiers present, if any.

In next step, the unbound water layer 18 is sent to a chiller based heat exchanger 36 for removing heat therefrom. In this step, the chiller based heat exchanger 36 removes heat from the unbound water layer 18. The chiller based heat exchanger 36 provides a product water layer 38 that is further treated in a water treatment plant 40 thereby obtaining usable water product 41. In this step, the water recovered along line 31 is also added to the water treatment plant 40, after being passed through chiller based heat exchanger 36, for obtaining usable water product 41.

In next step, the viscous hydrocarbon layer 16 is passed sent to a solid removal plant 42 that removes solids from the viscous hydrocarbon layer 16 along line 44 thereby obtaining solids-free viscous hydrocarbon layer 46 with bound water, solvent and salts. The solids removed along line 44 are mixed with wet, oily solid cake layer 20 as shown. It is understood here that the solids removed along line 25 are also mixed with the wet, oily solid cake layer 20 in this step. The solid-free viscous hydrocarbon layer 46 is sent to a desalter with hot centrifuge 48 wherein a predefined amount of fresh salt-free water is added such that a viscous hydrocarbon layer 50 is obtained which contains bound water, solvent and is free from solids and salts. In this step, a predefined amount of free water is recovered along line 51 containing salts, free water with traces of solvent and water soluble emulsifiers present, if any. The free water recovered along line 51 is mixed with the free water layer 34 and subsequently sent to the chiller based heat exchanger 38 along line 51A for recovery of usable water after passing through water treatment plant 40.

The solids-free, salts-free viscous hydrocarbon layer 50 is sent to a first reactor 52 along line 54. Additionally, a predefined heat source is supplied to the first reactor 52 along line 53. In the context of the present invention, the first reactor 52 is a rapid, foamed sludge heating vessel with distributed heating surface for sustained boiling with steam stripping by additionally dispersing fine water droplets under positive gauge pressure of about 30 mBar. It is understood here that keeping this positive gauge pressure in the first reactor 52 depends on the cost-effectiveness and it may vary in other alternative embodiments of the present invention. Alternatively, the first reactor 52 is a single/multi-effect evaporator with/without thermal vapor recompression and with or without mechanical foam breaker. The thermal vapor recompression in the first reactor 52 avoids thermal cracking of the product hydrocarbon stream. The mechanical foam breaker in the first reactor 52 avoids entrainment of hydrocarbons. The first reactor 52 operates at a predefined pressure. In this one particular embodiment, the predefined pressure is an atmospheric pressure. The first reactor 52 operates at a predefined temperature. In this one particular embodiment, the first reactor 52 is designed attain a maximum temperature up to 110° C. However, the reactor 52 may work below 100° C. in other alternative embodiments of the present invention because collection temperature changes depending on different types of sludges being treated in said reactor 52. It is understood here that the foam collects at about 97° C. and 933 mBar atmospheric pressure if the particle size in the sludge is more, whereas when particle size is less then it gets collected at temperature more than 97° C. The reactor 52 has a specific feature incorporated therein to sustain the time based, foam based boiling to further enhance quantum of steam stripped light hydrocarbons from viscous hydrocarbons. The reactor 52 is configured to boil out water with the sludge in foamed state in accordance with the present invention.

The first reactor 52 boils out the reaction mixture thereby generating a foamed layer 56 and a hot liquid layer 56A. The hot liquid layer 56A contains hot liquid hydrocarbons with residual water after foams have subsided. The foamed layer 56 is subjected to a first thermal foam breaker 58 that is supplied with a heat source 58A. The heat source 58A is a thermic fluid in this one particular embodiment. The first thermal foam breaker 58 operates at a predefined pressure and a predefined temperature. The predefined pressure is an atmospheric pressure in the context of the present invention. The first foam breaker 58 is designed to attain to a maximum temperature up to 160° C. The first thermal foam breaker 58 breaks the foamed layer 56 into a vapour layer 59 and a liquid layer 60. The vapor layer 59 contains vapours of water, steam-stripped hydrocarbons and entrained hydrocarbons. The liquid layer 60 contains liquid hydrocarbons with fine dispersed water droplets from foam skin. The liquid layer 60 is recycled back to the first reactor 52 as shown. The vapour layer 59 is subjected to a first hot cyclone 61. The first hot cyclone 61 is adapted in said process to avoid condensation and in order to keep the viscosity at a low level. The first hot cyclone 61 separates liquid hydrocarbons particles with fine droplets of water are separated along line 63 thereby obtaining a vapor layer 62 containing vapors of low boiling hydrocarbons and water. The hot cyclone 61 is supplied with a heat source 61A. The liquid hydrocarbon particles with fine droplets of water obtained along line 63 are recycled back to the first reactor 52 as shown. The vapor layer 62 is sent to a condenser 64 wherein the vapor layer 62 is condensed to obtain liquid condensates along line 67 thereby obtaining traces of vapours along line 67A, if any. It is understood here that the condenser 64 is an Ambient Air based condenser in this one particular embodiment. The traces of vapours obtained along line 67A are fed to a chiller based heat exchanger 67B that operates at a predefined temperature and a predefined pressure. The chiller based heat exchanger 67B is designed to attain a maximum temperature up to −20° C. The predefined pressure of the chiller based heat exchanger 67B is a slightly negative gauge pressure. The chiller based heat exchanger 67B recovers water with steam stripped hydrocarbons along line 67C thereby applying a vacuum using vacuum pump 67D. It is understood here that the vacuum pump 67D may be replaced with induced draft fans in other alternative embodiments of the present invention to provide cost-effectiveness in said process. A heat source 67E is applied to the chiller based heat exchanger 67B to fluidize the ice formed in said chiller based heat exchanger 67B. The chiller based heat exchanger 67B ensures that vapors containing hydrocarbons are not let out to atmosphere. The chiller based heat exchanger 67B is supplied with heat source 67E to fluidize ice which may form at a very low temperature maintained in said heat exchanger 67B. The heat source 67E is adapted only to fluidize formation of ice. The water with steam stripped hydrocarbons recovered along line 67C are added to a condensate phase separator 69 along with liquid condensates obtained along line 67 such that water condensates with traces of hydrocarbons are obtained along line 70 and condensates of light hydrocarbons with traces of water are obtained along line 70A. The light hydrocarbons with traces of water obtained along line 70A are sent to a centrifuge 70B in order to obtain dewatered, solids-free, salt-free light hydrocarbons product 70C thereby separating water with traces of hydrocarbons along line 70D.

The wet, oily solid cake layer 20 is fed to a dryer 68, after being mixed with wet, oily solid cake layers recovered along lines 25 and 44. A heat source is provided to the dryer 68 to achieve a predefined temperature in this one embodiment. The predefined temperature is about 108° C. The heat source in the dryer 68 is preferably a waste heat source that reduces cost of energy involved in said process. The dryer 68 evaporates water vapors from the wet, oily solid cake layer 20 which are recovered along line 71. The water vapors recovered along line 71 are condensed in a condenser 72 for obtaining water in liquid form along line 74. The water obtained along line 74 is fed to the chiller based heat exchanger 36 for recovery of usable water through water treatment plant 40 as illustrated. The wet, oily solid cake layer 20 is dried in the dryer 68 thereby obtaining dried solid cake 76. The dried solid cake 76 is sent to a de-oiling plant 78 for obtaining hydrocarbon-free de-oiled dry, saleable solid product 80, thereby recovering hydrocarbons along line 82 as illustrated.

The hot liquid layer 56A, containing hot liquid hydrocarbons, is added to a second reactor 94. It is understood here that the hot liquid layer 56A may be added to an alternative vessel 94A that may be optionally selected from a settling tank with aeration or settling tank with agitation or hydrocyclone or atomization of viscous sludge to remove water. Additionally, a predefined amount heat source is supplied to the second reactor 94 along line 93. In the context of the present invention, the second reactor 94 is a rapid, turbulent thin layer boiling vessel adapted for the viscous sludge with limited water, with limited steam stripping and delayed descent under positive gauge pressure of about 30 mBAR or single/multi-effect evaporator with/without thermal vapor recompression and with or without mechanical foam breaker. The thermal vapor recompression in the second reactor 94 avoids thermal cracking of the product hydrocarbon stream. It is understood here that keeping this positive gauge pressure in the second reactor 94 depends on the cost-effectiveness and it may vary in other alternative embodiments of the present invention.

The second reactor 94 operates at a predefined pressure. In this one particular embodiment, the predefined pressure is an atmospheric pressure. The second reactor 94 operates at a predefined temperature. In this one particular embodiment, the second reactor 94 is designed to attain a maximum temperature up to 130° C. However, it is understood here that the second reactor 94 may operate at a maximum temperature of 130° C., where most of the viscous hydrocarbons comes out at below 120° C. Further, it is understood that the second reactor 94 is a thin layer boiling vessel with inbuilt turbulence to aid vapor escape, with reduced rate of descent to enhance residence time in single pass under up to 30 mBar positive gauge pressure. However, there are several substitutes for rapid, turbulent thin layer boiling that may be utilized in the second reactor 94 such as a settling tank with aeration or settling tank with agitation or atomization of viscous sludge in order to remove water.

The second reactor 94 recovers a de-watered, solids-free, salts-free viscous hydrocarbon product 96 thereby separating vapours of water and steam stripped hydrocarbons along line 95. The vapours of water and steam stripped hydrocarbons recovered along line 95 are processed ahead through the chiller based heat exchanger 67B for recovery of condensates of light hydrocarbons with traces of water 70A after passing through the condensate phase separator 69 via line 67C. It is understood here that the hot liquid layer 56A may be alternatively treated through a settling tank or atomizer 94A for recovery of dewatered solids-free salts-free viscous hydrocarbons product 96 thereby separating vapors of water and steam stripped along line 95 as illustrated. The vapors of water and steam stripped along line 95 are sent to a second hot cyclone 95A thereby applying a predefined amount heat thereto.

The second hot cyclone 95A separates liquid hydrocarbons particles with fine droplets of water are separated along line 95B thereby obtaining a vapor layer 95C containing vapors of low boiling hydrocarbons and water. The liquid hydrocarbon particles with fine droplets of water obtained along line 95B are recycled back to the second reactor 94 as shown. The vapor layer 95C is sent to a condenser 95D wherein the vapor layer 95C is condensed to obtain liquid condensates along line 95E and vapours along line 95F, if any. It is understood here that the condenser 95D is an Ambient Air based condenser in this one particular embodiment. The traces of vapours obtained along line 95F are fed to the chiller based heat exchanger 67B and processed ahead as illustrated. The liquid condensates obtained along line 95E are fed to condensate phase separator 69 and processed ahead as illustrated.

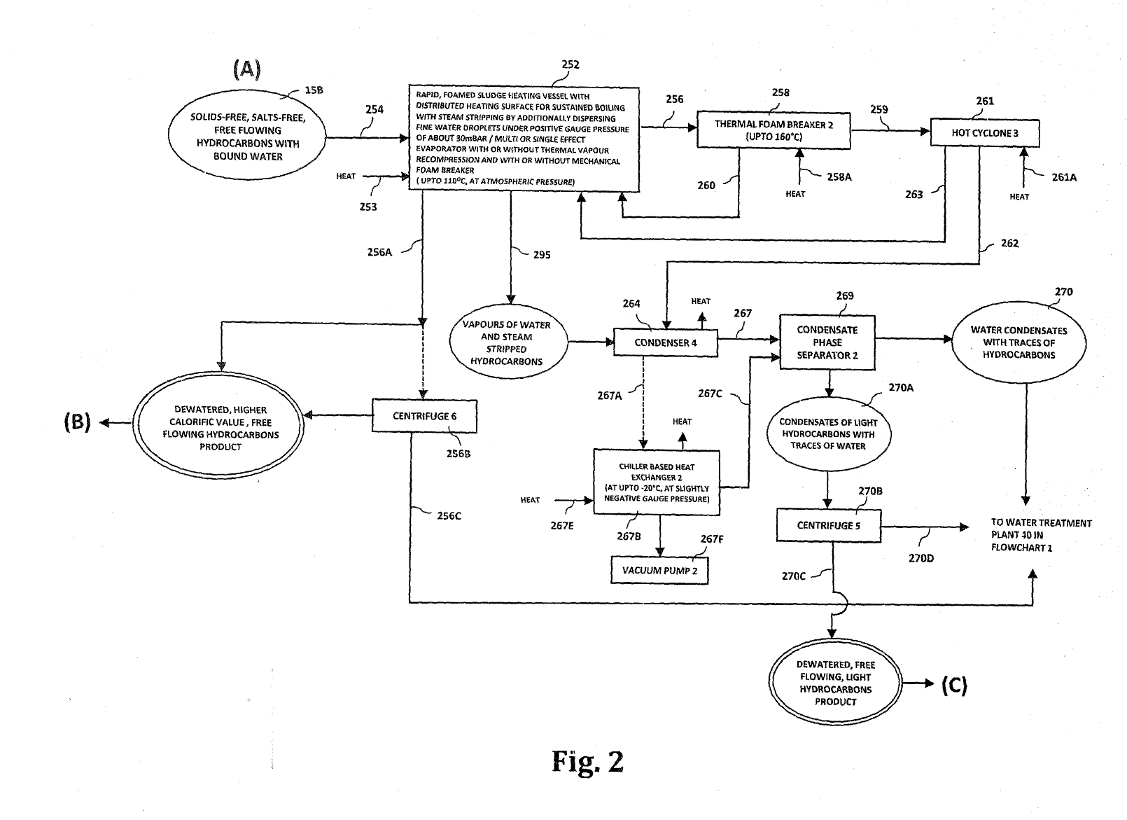

Referring to FIG. 2, a process for rapidly boiling out bound water from non-viscous hydrocarbon sludges, emulsions at least temperature is shown. In said process, the solids-free, salts-free, free flowing hydrocarbons with bound water 15B obtained in earlier step of said process is charged as an input material along line-A to a third reactor 252 along line 254. It is understood here that the solids-free, salts-free, free flowing hydrocarbons with bound water being processed along line-A may have small proportion of viscous layer as well. In such case, the solids-free, salts-free, free flowing hydrocarbons with bound water obtained along line-A is again treated through first reactor 52 as that the solids-free, salts-free viscous hydrocarbons layer 50 (refer FIG. 1). However, if the solids-free, salts-free, free flowing hydrocarbons with bound water, being processed along line-A, does not contain small proportion of viscous layer then it is directly processed through the third reactor 252 as described hereinafter.

A predefined heat source is supplied to the third reactor 252 along line 253. In the context of the present invention, the third reactor 252 is a rapid, foamed sludge heating vessel with distributed heating surface for sustained boiling with steam stripping by additionally dispersing fine water droplets under positive gauge pressure of about 30 mBar. It is understood here that keeping this positive gauge pressure in the third reactor 252 depends on the cost-effectiveness and it may vary in other alternative embodiments of the present invention. However, the third reactor 252 may be a single/multi-effect evaporator with/without thermal vapor recompression, with or without mechanical foam breaker. The thermal vapor recompression in the third reactor 252 avoids thermal cracking of the product hydrocarbon stream. The mechanical foam breaker in the third reactor 252 avoids entrainment of hydrocarbons. The third reactor 252 operates at a predefined pressure. In this one particular embodiment, the predefined pressure is an atmospheric pressure. The third reactor 252 operates at a predefined temperature. In this one particular embodiment, the third reactor 252 is designed attain a maximum temperature up to 110° C. However, the third reactor 252 may work below 100° C. in other alternative embodiments of the present invention because collection temperature changes depending on different types of sludges being treated in said third reactor 252. The third reactor 252 has a specific feature incorporated therein to sustain the time based, foam based boiling to further enhance quantum of steam stripped light hydrocarbons from viscous hydrocarbons. The third reactor 252 is configured to boil out water with the sludge in foamed state in accordance with the present invention.

The third reactor 252 boils out the reaction mixture thereby generating a foamed layer 256, a liquid layer 256A and vapours of steam stripped hydrocarbons 295. The foamed layer 256 is subjected to a second thermal foam breaker 258 that is supplied with a heat source 258A. The second thermal foam breaker 258 operates at a predefined pressure and a predefined temperature. The predefined pressure is an atmospheric pressure in the context of the present invention. The second foam breaker 258 is designed to attain to a maximum temperature up to 160° C. The second foam breaker 258 breaks the foamed layer 256 into a vapour layer 259 and a liquid layer 260. The vapor layer 259 contains vapours of water, steam-stripped hydrocarbons and entrained hydrocarbons. The liquid layer 260 contains liquid hydrocarbons with fine dispersed water droplets from foam skin. The liquid layer 260 is recycled back to the third reactor 252 as shown. The vapour layer 259 is subjected to a third hot cyclone 261 that is supplied with a heat source 261A. The third hot cyclone 261 is adapted in said process to avoid condensation and in order to keep the viscosity at a low level. The third hot cyclone 261 separates liquid hydrocarbons particles with fine droplets of water along line 263 thereby obtaining a vapor layer 262 containing vapors of water. The liquid hydrocarbon particles with fine droplets of water obtained along line 263 are recycled back to the third reactor 252 as shown. The vapor layer 262 is sent to a condenser 264 wherein the vapor layer 262 is condensed to obtain water condensates along line 267 thereby obtaining traces of vapours along line 267A, if any. It is understood here that the condenser 264 is an Ambient Air based condenser in this one particular embodiment. The traces of vapours obtained along line 267A are fed to a chiller based heat exchanger 267B that operates at a predefined temperature and a predefined pressure. The chiller based heat exchanger 267B is designed to attain a maximum temperature up to −20° C. The chiller based heat exchanger 67B recovers water with steam stripped hydrocarbons along line 267C thereby applying a vacuum using vacuum pump 267F. It is understood here that the vacuum pump 267F may be replaced with induced draft fans in other alternative embodiments of the present invention to provide cost-effectiveness in said process. The predefined pressure of the chiller based heat exchanger 267B is at a slightly negative gauge pressure. The chiller based heat exchanger 267B recovers water with steam stripped hydrocarbons along line 267C. A heat source 267E is applied to the chiller based heat exchanger 267B to fluidize the ice formed in said chiller based heat exchanger 267B. The chiller based heat exchanger 267B ensures that vapors containing hydrocarbons are not let out to atmosphere. The chiller based heat exchanger 267B is supplied with heat source to fluidize ice which may form at a very low temperature maintained in said heat exchanger 267B. The heat source is adapted only to fluidize formation of ice.

The water with steam stripped hydrocarbons recovered along line 267C are added to a condensate phase separator 269 along with liquid condensates obtained along line 267 such that water condensates with traces of hydrocarbons are obtained along line 270 and condensates of light hydrocarbons with traces of water are obtained along line 270A. The light hydrocarbons with traces of water obtained along line 270A are sent to a centrifuge 270B in order to obtain dewatered, free flowing light hydrocarbons product-C obtained along line 270C thereby separating traces of water along line 270D. The traces of water obtained along line 270D and water condensates with traces of hydrocarbons obtained along line 270, water separated along line 256C, if any, are mixed and sent to water treatment plant 40 (as shown in FIG. 1) for recovery of usable water 41.

The liquid layer 256A is a higher calorific value free flowing hydrocarbons product that is obtained from third reactor 252 only after the foamed layer 256 subsides from said process. Accordingly, the liquid layer 256A is optionally centrifuged through a centrifuge 256B for removal of water content present, if any, along line 256C as shown. The higher calorific value free flowing hydrocarbons product obtained along line 270C is mixed the higher calorific value free flowing hydrocarbons product 256A thereby obtaining dewatered, higher calorific value, free flowing hydrocarbons product-B in accordance with the present invention. The vapours of water and steam stripped hydrocarbons 295 are sent to the condenser 264 for being processed ahead for recovery of water condensates with traces of hydrocarbons 270 and condensates of light hydrocarbons with traces of water 270A as illustrated.

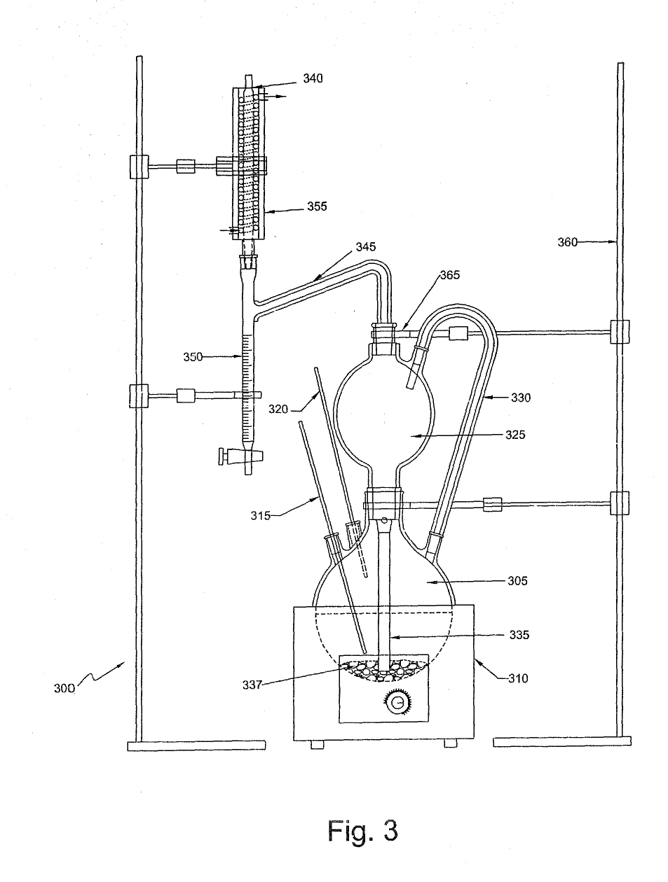

Referring to FIG. 3, a laboratory scale apparatus setup 300 for boiling of viscous sludge is shown. The apparatus setup 300 includes a four-neck round bottom (RB, hereinafter) flask 305 that holds weighed amount of sludge material to be dewatered. The RB flask 305 rests on an electric mantle heater 310 that supplies heat flux to the sludge in RB flask. The electric mantle heater 310 includes a heating element such that said heating element supplies distributed heating to a lower hemisphere of the RB flask 305 as shown, except for a small portion at the bottom. A pair of temperature sensor probes 315, 320 is fitted on two side necks of the RB flask 305 to monitor liquid and vapour temperature throughout the process. The electric mantle heater 310 provides a constant heat flux in order to boil the sludge. The boiling of the sludge causes water vapours formed during said boiling to rise through a center neck of the RB flask 305 thereby entering into an additional flask 325 through an inverted tube 330. Any liquid entrained in outgoing vapour hits walls of the inverted tube 330 and flows either into the additional flask 325 or back into the RB flask 305. The additional flask 325 has a distended volume that reduces velocity of evolving liquid thereby allowing remainder of entrained liquid to separate from vapour such that the liquid deposited in the additional flask 325 travels through a straight tube 335 back into the RB flask 305. The straight tube 335 is designed such that an opening of the straight tube 335 is below the level of liquid into the RB flask 305 in order to prevent escape of the vapor through the RB flask 305 through the centre neck thereof. Additionally, the RB flask 305 contains a plurality of glass beads 337 around the opening of the tube 335. The vapours gathered in the additional flask 325 are devoid of liquid which go to a condenser 340 through a Dean and Stark apparatus 345. The condenser 340 is cooled by circulation of water at a temperature of about 5-6° C. to completely condense the liquid thereby preventing any vapour to escape therefrom. The condensed liquid is collected in a receiver 350 of Dean and Stark apparatus 345. It is understood here that exposed surfaces of the RB flask 305, additional flask 325, inverted tube 330, Dean and Stark apparatus 345 and condenser 340 have an insulation layer 355, preferably with cotton material, in order to prevent condensation of vapours anywhere other than condenser 340 thereby preventing excessive heat loss in said apparatus setup 300. Entire apparatus setup 300 is kept upright with the help of a retort stand 360 and a plurality of spring loaded clamps 365. The heating arrangement for apparatus 300 is inefficient. It is understood here that part of the heating element always remains above the liquid level, thus unnecessarily heating vapors above the liquid in the RB flask 305. It is understood here that if quantity of liquid is increased to accommodate the entire heating surface below the liquid phase then explosive discharge of vapour towards end of the process is very high that apparatus 300 is unable to handle the same.

The apparatus setup 300 is ideally used for boiling viscous sludge with low to moderate heat flux passing through the sludge. In said apparatus setup 300, liquid overflows from top of condenser 340 as the capacity of the condenser to condense water vapour is limited for high heat flux.

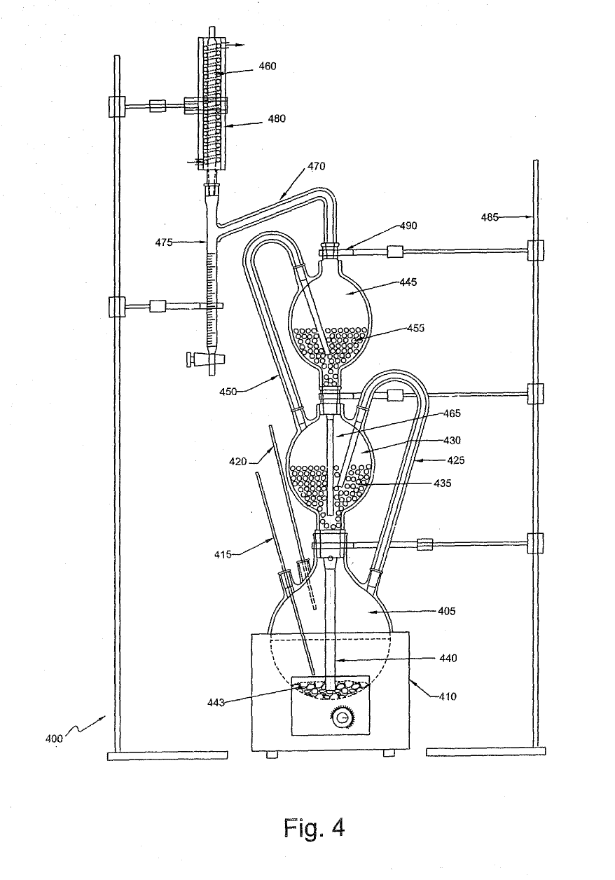

Referring to FIG. 4, a laboratory scale setup of an apparatus 400 for boiling of intense foaming sludge is illustrated. The apparatus setup 400 includes a four-neck RB flask 405 that holds weighed amount of sludge material to be dewatered. The RB flask 405 rests on an electric mantle heater 410 that supplies heat flux to the sludge in RB flask. A pair of temperature sensor probes 415, 420 is fitted on two side necks of the RB flask 405 to monitor liquid and vapour temperature throughout the process. The RB flask 405 facilitates boiling of the sludge such that foam is formed in the sludge due to water vapour trapped or due to air bubbles present in the sludge on account of surfactants in sludge. The foam formed in the RB flask 405 travels through a first inverted tube 425 into a first additional flask 430 positioned on top of the RB flask 405. The foam entering into the first additional flask 430 is partly or entirely broken by a plurality of glass beads 435 positioned in the first additional flask 430. The glass beads 435 are preferably positioned in the first additional flask 430 thereby using a perforated disk. The perforated disk prevents the glass beads 435 to fall into the RB flask 405 during the process. The glass beads 435 preferably have rough surface configuration. The glass beads 435 are preferably positioned within a constricted space in the first additional flask 430. The combination of the rough surface and the constriction of space closely pack the glass beads 435 within the first additional flask 430 in order to break the foam. In addition, the glass beads 435 reduce at least a fraction of liquid entrained in vapours during explosive discharge thereby increasing the sporadic pressure in the chamber. This causes the foam to release the liquid which travels back into the RB flask 405 through a first extended tube 440 which is positioned through a centre neck of the RB flask 405 below the liquid level thereof. The first extended tube 440 discharges the liquid recovered from the foam preferably below a level of liquid inside the RB flask 405. Additionally, the RB flask 405 contains a plurality of glass beads 443 around the opening of extended tube 440 as shown. The first extended tube prevents the foam from entering through the centre neck thereby providing separate routes for vapour/foam to leave the RB flask 405 and liquid separated from the foam film to re-enter the RB flask 405. Subsequently, the vapours separated from the foam move from the top of the first additional flask 430 to a second additional flask 445 through a second inverted tube 450. The change in direction of vapours through the second inverted tube 450 ensures that any liquid entrained in evolving vapour will be deposited in second additional flask 445. The second additional flask 445 is positioned with a plurality of glass beads 455 to handle the foam, if any, entering into the second additional flask 445. The glass beads 455 further break that foam before entering into a condenser 460. The second additional flask 445 includes a second extended tube 465 that transfers entrained liquid from the second additional flask 445 into the first additional flask 430 and eventually into the RB flask 405. The second additional flask 445 recovers water vapours that are free from liquid that move to the condenser 460 through a Dean and Stark apparatus 470. The condenser 460 is cooled by circulation of water at a temperature of about 5-6° C. that condenses the water vapours in order to obtain condensed liquid which is collected into a receiver 475 of the Dean and Stark apparatus 470. It is understood here that all the exposed surfaces of the RB flask 405, first additional flask 430, second additional flask 445, first inverted tube 425, second inverted tube 450, Dean and Stark apparatus 470 and condenser 460 are insulated with an insulation layer 480, preferably with insulation material such as cotton, in order to prevent condensation of vapours anywhere in the apparatus 400 other than condenser 460 thereby additionally preventing heat loss. Entire setup 400 is kept upright with the help of a retort stand 485 and a plurality of spring loaded clamps 490. The apparatus 400 is equipped to treat non-viscous intensely foaming sludges as mechanical foam breakers are incompetent to break highly stable foam instantaneously formed due to presence of surfactants and emulsifier that provide added stability to said foams. Hence, high rate of heating is not viable in present apparatus 400 without spilling over of the foam into the receiver and condenser 460.

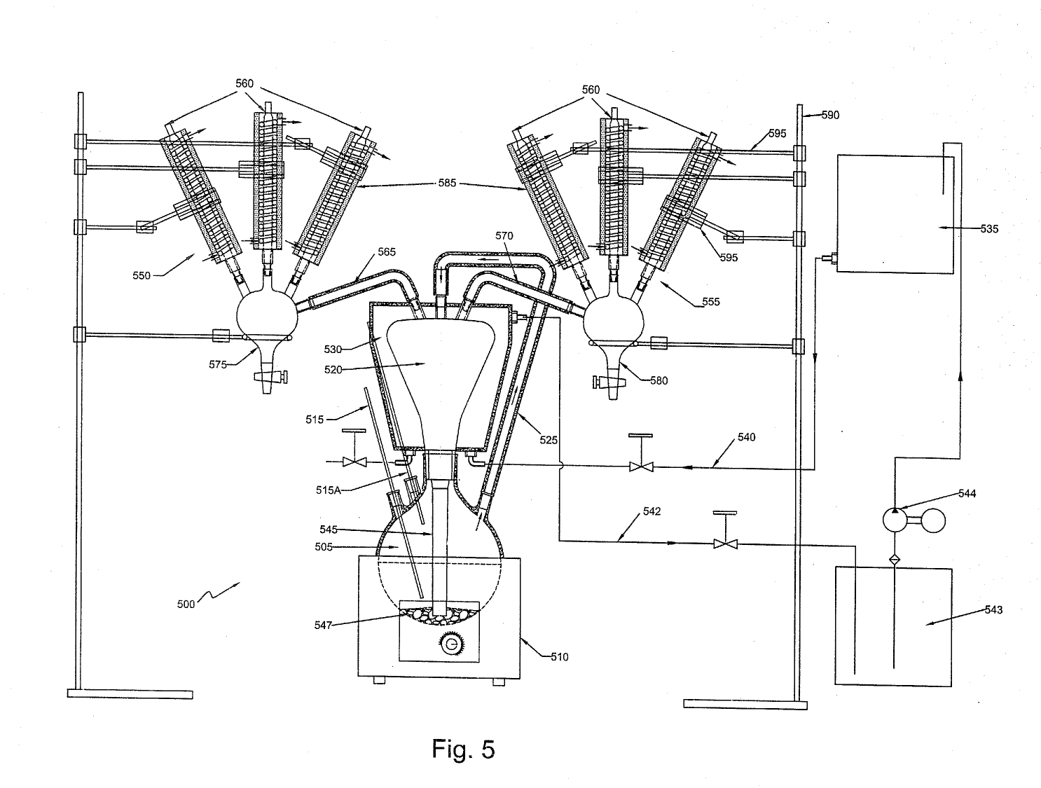

Referring to FIG. 5, an anti-blasting apparatus setup 500 for boiling of highly viscous sludge is illustrated. The apparatus setup 500 is ideally used for boiling viscous sludge with extremely high heat flux passing through the sludge. The apparatus setup 500 includes a three-neck RB flask 505 that holds weighed amount of sludge material to be dewatered. The RB flask 505 rests on an electric mantle heater 510 that supplies heat flux to the sludge in the RB flask 505. The electric mantle heater 510 includes a heating element that supplies distributed heating to a lower hemisphere of the RB flask 505, except for small portion at the bottom thereof. A temperature sensor probe 515 and 515A are fitted the side necks of RB flask 505 to monitor liquid and vapour temperature throughout the process. A constant heat flux is supplied by the heating mantle 510 for boiling of the sludge in the RB flask 505 such that water vapours formed during boiling of sludge rise through the side neck of the RB flask 505 and enter into a liquid-vapour separator 520 through a first inverted tube 525. The liquid-vapour separator 520 is positioned within an enclosure 530 that is heated by circulating a thermic fluid through said enclosure. The thermic fluid is circulated from a thermic fluid inlet tank 535 along an inlet line 540. The thermic fluid is recovered along an outlet line 542 and stored in a thermic fluid storage tank 543. The thermic fluid stored in the thermic fluid storage tank 543 is sent to the thermic fluid inlet tank 535 for recirculation using a thermic fluid pump 544. Optionally, the enclosure 530 includes an insulation material. The thermic fluid is circulated to break any foam that enters liquid vapour separator as due to rapid rate of heating more water will vaporized at the same time generating lots of foam. The enclosure 530 heats the walls of the liquid-vapour separator 520 such that the foam is thermally broken by expanding the vapour trapped in the foam and rupturing the liquid film around it. Additionally, walls of the heated liquid-vapour separator 520 prevent any condensation to occur in said separator 520. Any liquid entrained in outgoing vapour hits the walls of the first inverted tube 525 and either flow into the liquid-vapour separator 520 or back into the RB flask 505. The liquid vapour separator 520 has a distended volume that reduces the velocity of evolving liquid thereby allowing remainder of entrained liquid to separate from vapour. The liquid deposited in the liquid vapour separator 520 travels back into the RB flask 505 through an extended tube 545 such that an opening of the extended tube 545 is below the level of liquid in the RB flask 505 in order to prevent escape of the vapours through a center neck of the RB flask 505. Additionally, the RB flask 505 contains a plurality of glass beads 547 around the opening of extended tube 545 as shown. Accordingly, the vapours in the liquid-vapour separator 520, completely devoid of any entrained liquid, are diverted into a first condenser arrangement 550 and a second condenser arrangement 555. The first condenser arrangement 550 and second condenser arrangement 555 respectively has at least three condensers 560 positioned therein. The first condenser arrangement 550 includes a Dean and Stark apparatus 565 that is connected to the liquid-vapour separator 520 as shown. The second condenser arrangement 550 includes a Dean and Stark apparatus 570 that connects to the liquid-vapour separator 520 as shown. The first condenser arrangement 550 and second condenser arrangement 555 accommodate enhanced rate of water vapour evolving from the sludge by redirecting the substantial vapour released into multiple condensers 560 positioned therein. The condensed liquid is collected in respective receivers 575, 580. All exposed surfaces of the RB flask 505, liquid vapour separator 520, inverted tube 525, Dean and Stark apparatuses 565, 570 and condensers 560 include an insulation layer 585, preferably made of cotton material, in order to prevent condensation of vapour anywhere in the apparatus 500 other than condensers 560 to prevent heat loss. Entire apparatus setup 500 is kept upright with the help of a retort stand 590 and a plurality spring loaded clamps 595. The apparatus setup 500 allows for rapid heating of viscous sludge without any damage to glassware. The multiple condenser arrangement 550, 555 prevent any vapour to escape the apparatus set up 500.

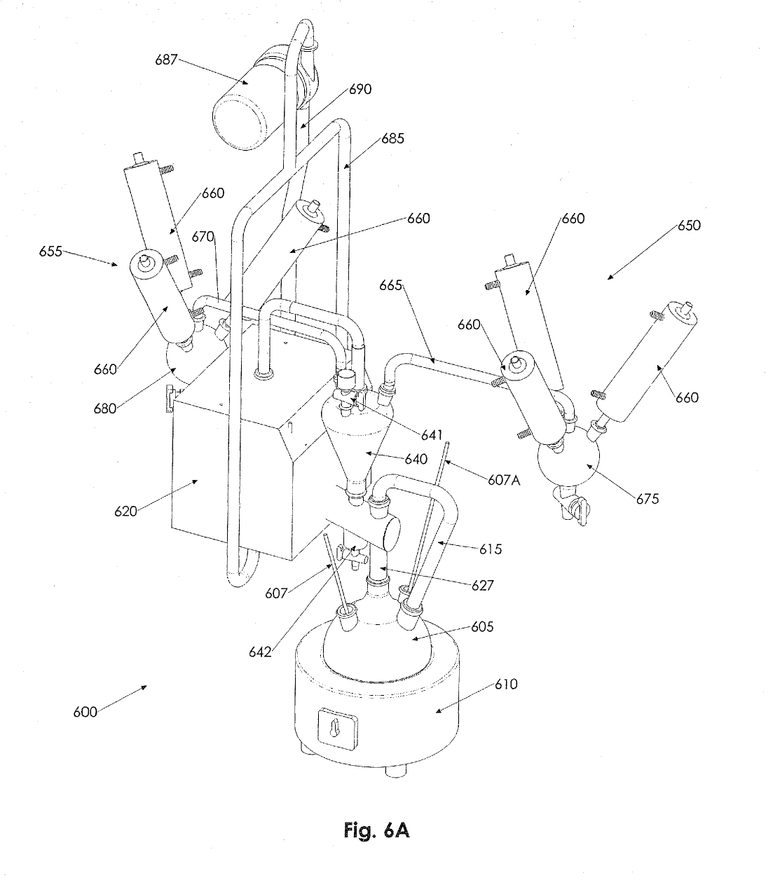

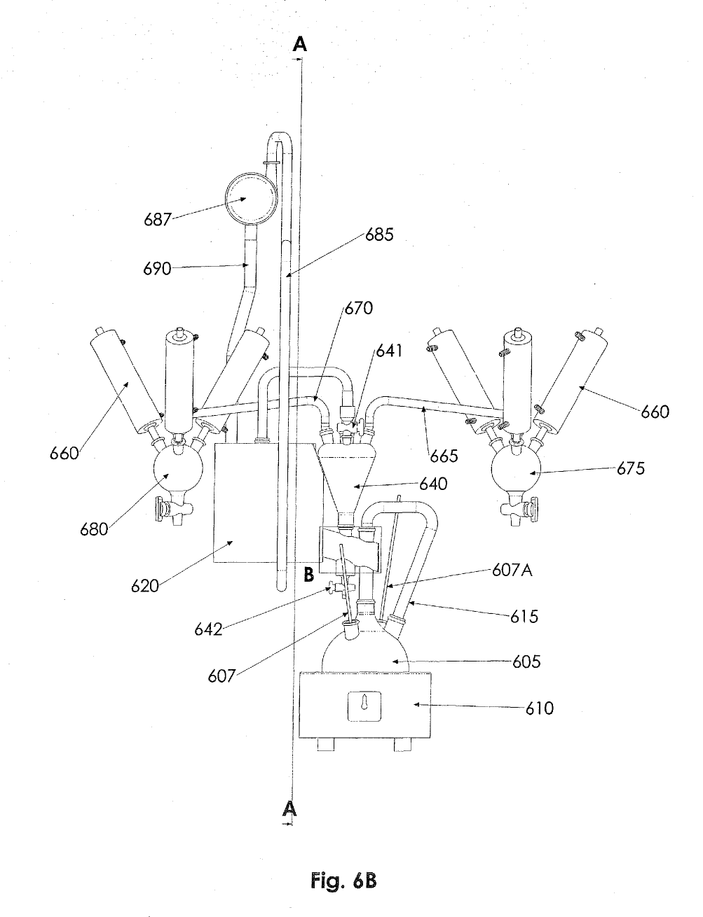

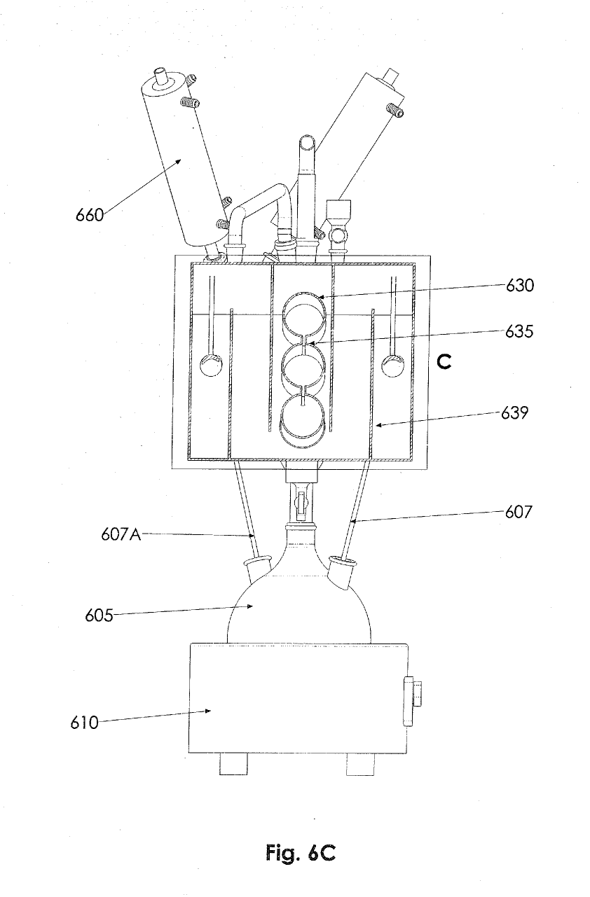

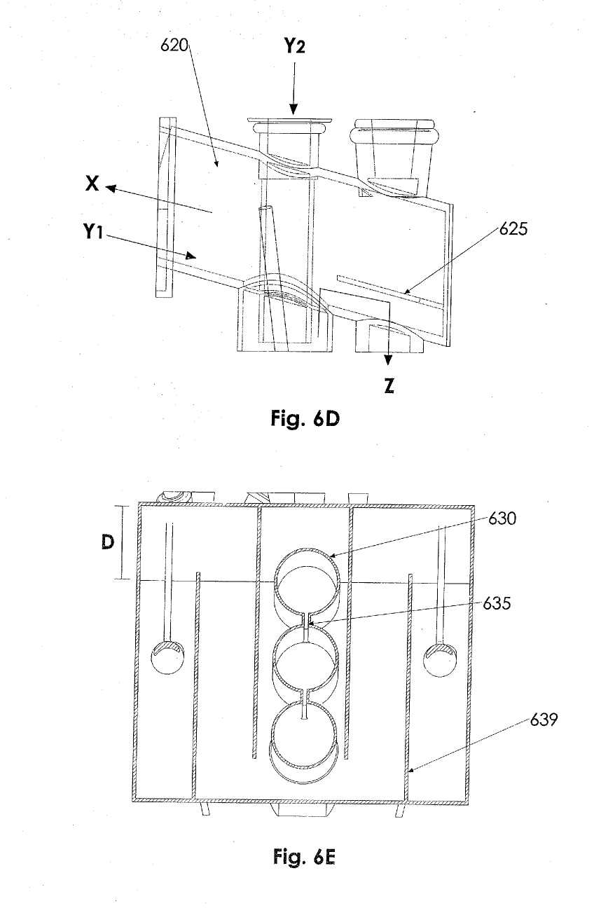

Referring to FIGS. 6A, 6B, 6C, 6D and 6E, a thermal foam breaking apparatus for boiling of sludge with intense foaming is shown wherein foams are broken by means of thermal foam breakers with provision for explosive vapour discharge accommodation. The apparatus setup 600 includes a triple neck RB flask 605 that holds weighed amount of sludge material to be dewatered. The RB flask 605 rests on an electric mantle heater 610 that supplies heat flux to the RB flask 605 for boiling the sludge. A pair of temperature sensor probe 607, 607A is positioned in the RB flask 605 such that the sensor probe 607 measures liquid temperature and 607A measures vapour temperature. During boiling in the RB flask 605, the foam is formed due water vapour trapped in sludge or due to air bubbles present in sludge on account of surfactants in sludge. The foam in the RB flask 605 travels through an inverted tube 615 provided on a side neck of the RB flask 605 towards a thermal foam breaker 620. As shown in FIG. 6D, the foam breaker 620 includes an impingement plate 625 that redirects the foam entering to the thermal foam breaker 620 via inverted tube 615 along arrow-X and accordingly separating liquid coming out from said foam breaker 620 along arrow-Y1.

The foam breaker 620 includes a series of heated tubes 630 (refer FIG. 6E) positioned at a predefined angle of about 2° to 12° in order to slope down the liquid to the RB flask 605. Each of heated tubes 630 has a narrow slit sections 635 defined longitudinally across each of the tubes 630 as illustrated in FIG. 6C and FIG. 6E. Each of the slits 630 has a thickness of about 5 mm. The heated tubes 630 are interconnected through narrow slit sections 635. The heated tubes 630 and narrow slit sections 635 have a length to height ratio from about 1:1 to about 1:3. The narrow slit sections 635 are about ⅕^{th} to 1/20^{th} the diameter of the heated tubes 630. The narrow slits 635 facilitate passage of liquid from upper heated tube 630 to subsequent lower heated tube 630. The narrow slits 635 and heated tubes 630 allow heating of foam such that the vapour within the foam expands and rupture the thin film of liquid surrounding it thereby separating vapour and liquid in said thermal breaker 620. The thermal breaker 620 includes a plurality of plates 639 alternatively positioned at a predefined distance ‘D’ from inner wall of the thermal breaker 620 as shown in FIG. 6E. The plates 639 facilitate steady flow of heated thermic fluid within the thermal breaker 620. The heated tubes 630 have dissented volume that effectively reduce the velocity of foam allowing easy separation of vapour and foam therein such that foam being heavier slows down and collects in the heated tubes 630 thereby allowing the vapours to escape. The liquid separated in said heated tubes 630 collects at the bottom thereof and flows back to bottom of RB flask 605 through a tube whose opening is below the level of sludge, such that no foam rises through said opening. Further, vapours pass through a liquid droplet collector 640 where entrained liquid droplets are separated by inverting the direction of flow of vapour.

The liquid collected by liquid droplet collector 640 flows into the foam breaker 620 as indicated by an arrow Y2 (refer FIG. 6D) and back into the RB flask 605 along the path indicated by the arrow Z (refer FIG. 6D), through an exit point in the foam breaker 620. An opening of liquid droplet collector 640 entering into foam breaker 620 is kept under shallow pool of liquid such that foams present in foam breaker 620 do not enter liquid droplet collector 640 thereby allowing the liquid to flow only in the RB flask 605 as indicated by arrow-Z (refer FIG. 6D). A tap 641 is provided on top of the liquid droplet collector 640 to fill said shallow pool of liquid before process begins and another tap 642 is provided below said shallow liquid pool to drain the liquid out at the end of process. Vapours that are completely devoid of any entrained liquids is diverted into a first condenser arrangement 650 and a second condenser arrangement 655 having at least three condensers 660. The first condenser arrangement 650 and a second condenser arrangement 655 are connected through respective Dean and Stark apparatuses 665, 670 to accommodate the enhanced rate of water vapour evolving from sludge by redirecting the substantial vapour released into multiple condensers. The condensers 660 are cooled by water at 5-6° C. to completely condense the liquid and not allow any vapour to escape. Preferably, cold water enters the outer shell of condensers 660 from the bottom filling it completely and overflowing out from top thereof. The condensers 660 are cooled by water at 5-6° C. to completely condense the liquid and not allow any vapour to escape. The condensed liquid is collected in respective receivers 675, 680. All exposed surfaces of the RB flask 605, liquid droplet collector 640, inverted tube 615, Dean and Stark apparatuses 665, 670 and condensers 660 include an insulation layer, preferably made of cotton material, in order to prevent condensation of vapour anywhere in the apparatus 600 other than condensers 660 to prevent heat loss. Insulation on condenser 660 prevents water condensation on outer wall which leads to erroneous collection results. Thermic fluid is continuously circulated around the foam breaker 620 wherein arrangement is such that the thermic fluid enters from an inlet line 685 and exits from an outlet line 690 thereby having recirculation using a thermic fluid pump 687. The thermic fluid enters foam breaker 620 from the bottom and rises up to the heating element where it is uniformly heated and thereafter it overflows along the plates 639 and rises uniformly across the surface of foam breaker 620 such that temperature is uniform along a horizontal plane. The thermic fluid flows over another section plate 639 from where it flows towards the thermic fluid pump 687. The apparatus setup 600 is capable of treating both viscous and non-viscous sludges as well as sludge containing emulsifiers that can form stable foam at a high rate of heating with facility of more water being removed at a lower temperature.

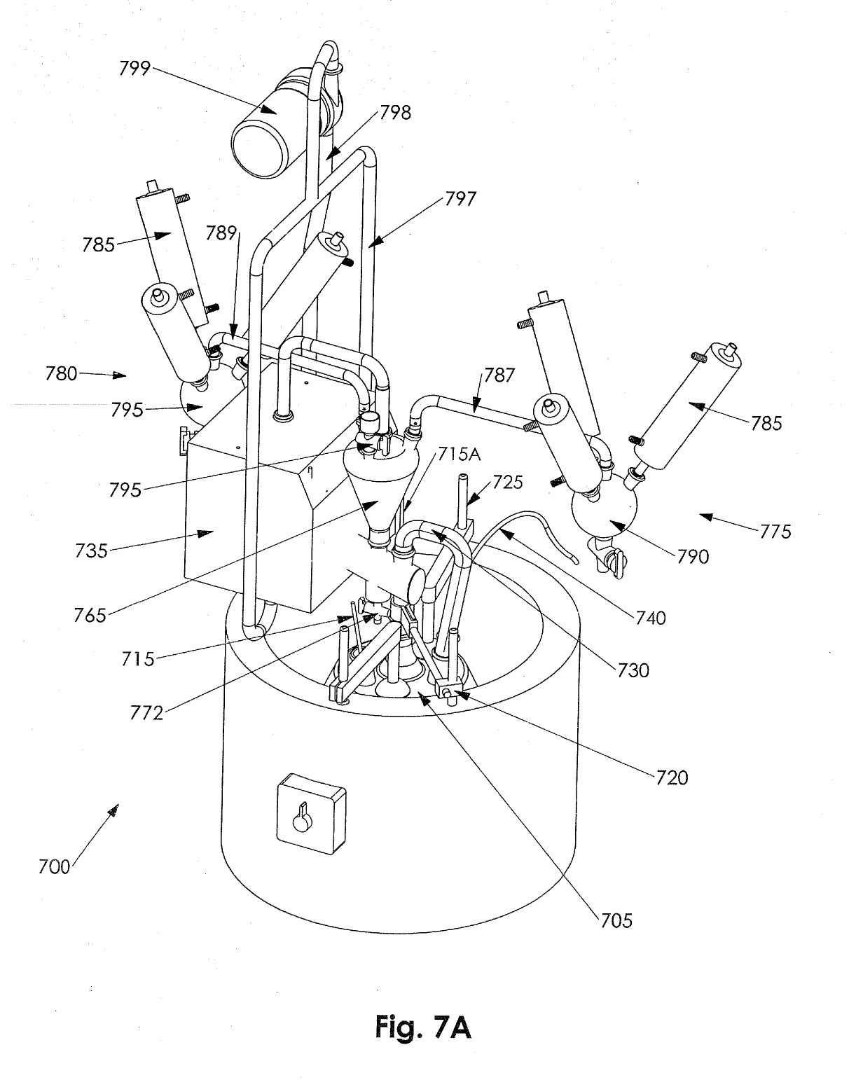

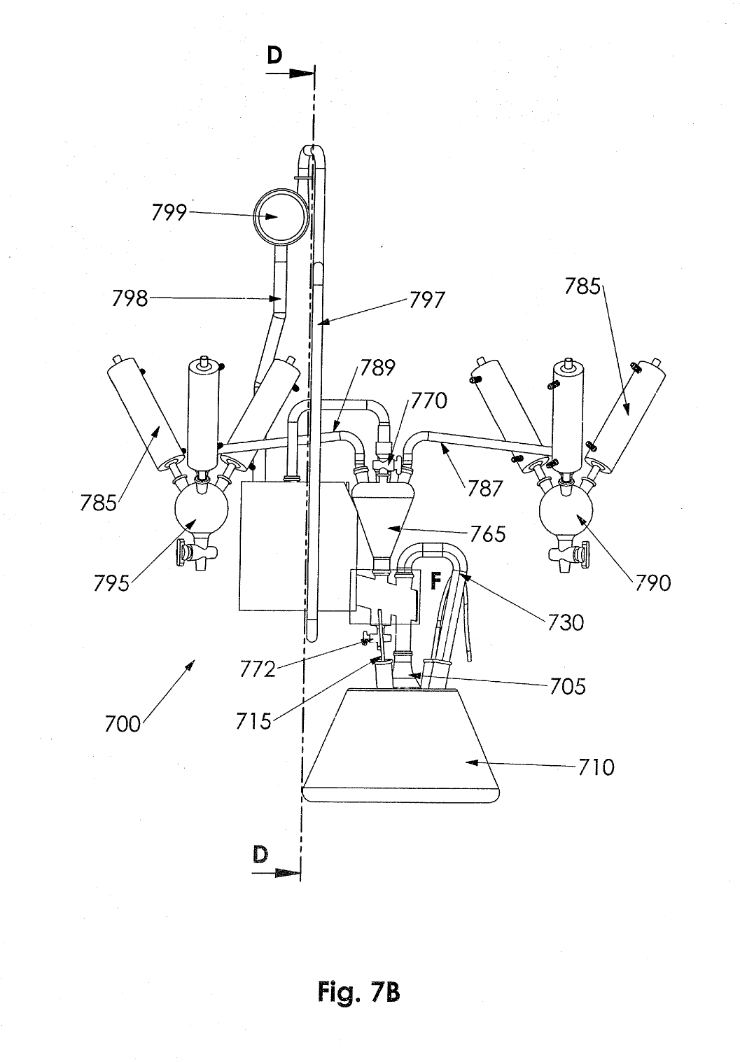

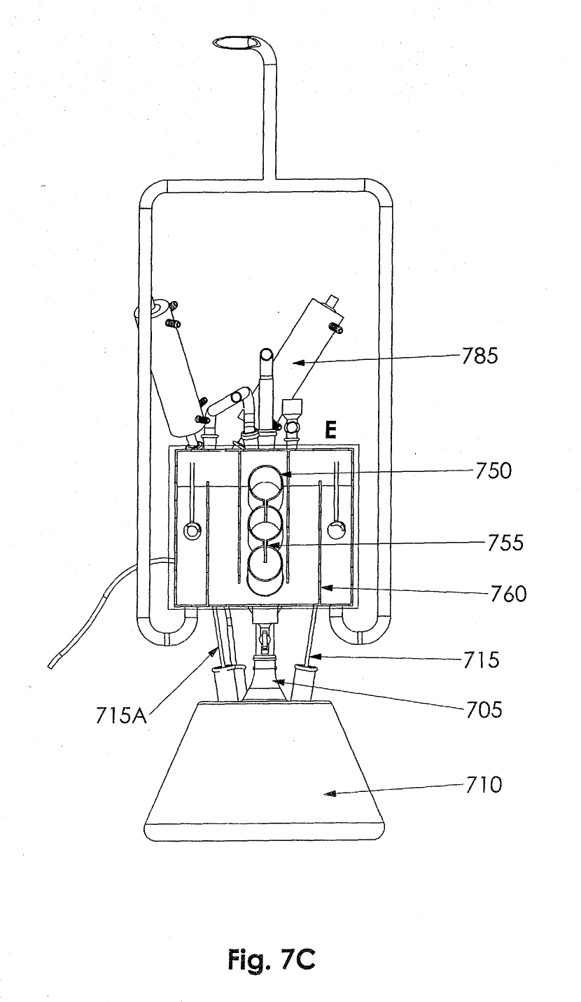

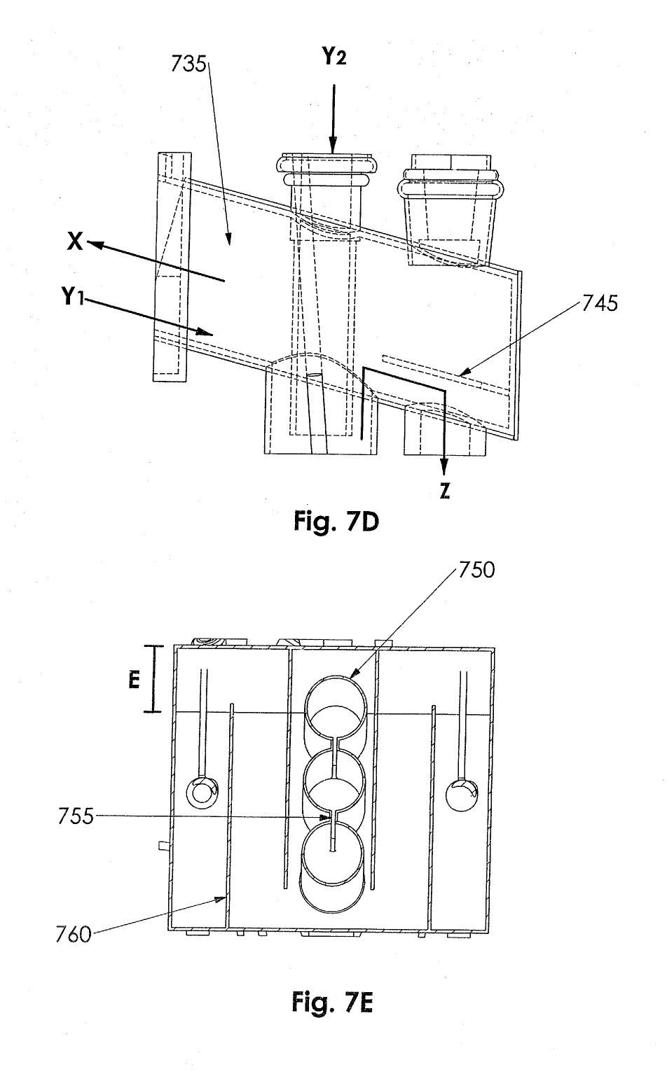

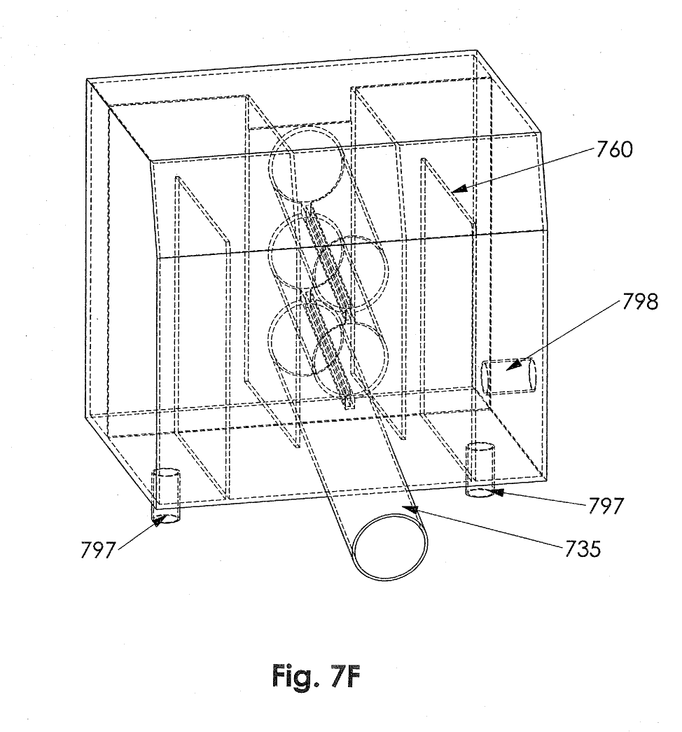

Referring to FIGS. 7A, 7B, 7C, 7D and 7E, a laboratory scale apparatus setup 700 for boiling of highly viscous sludge is illustrated. The apparatus setup 700 is ideally designed for boiling all varieties of sludges with extremely high heat flux passing through the sludge. The apparatus setup 700 includes a conical frustum shaped heating vessel 705 (conical flask 705, hereinafter) placed within an insulated, continuously stirred, high temperature, electrically heated oil bath 710 (oil bath 710, hereinafter). The oil bath 710 includes polyethylene glycol or any other suitable oil with high flash point. The conical flask 705 is provided with a temperature set control including a plurality of temperature sensor probes 715, 715A. The temperature sensor probe 715 measures temperature of liquid and the temperature sensor probe 715A measures temperature of vapour.

The oil bath 710 is such that the bottom of conical flask 705 is positioned therein by maintaining a predefined gap. In this one embodiment, the predefined gap is at least 1 cm. The predefined gap is such that an enough space is maintained for oil to circulate below the conical flask 705 as well. The conical flask 705 is shaped such that the entire flask 705 is completely submerged under oil. The conical flask 705 is held by a spring loaded clamp 720 to be positioned in the centre of the oil bath 710 and an additional pair of clamps 725 to hold the conical flask 705 below the level of oil bath 710. The conical flask 705 has at least five necks such that temperature sensor probes 715 are fitted in at least two necks thereof to monitor the liquid and vapour temperatures in the conical flask 705. The oil bath 710 provides more control on the heat flux applied to the sludge. It is understood here that entire conical flask 705 positioned inside the oil bath 710 uniformly distributes heat flux that is applied throughout the sludge. It is further understood here that heat transfer area is present at the bottom of the conical flask 705 for providing a massive heat flux leading to intense foaming and rapid circulation throughout the sludge body. Foams thus formed are sustained for a longer time without much rise in temperature in the conical flask 705. The foam formed in the conical flask 705 travels through an inverted tube 730 provided on the side neck of conical flask 705 towards a thermal foam breaker 735. Towards the end of the middle phase of process, as foam generation slows down additional water is dispersed through a high pressure water sprayer 740 placed at the bottom of the conical flask 705 in form of fine water droplets spread radially to sustain foam generation for a longer period. The sprayer 740 enters the conical flask 705 through one of the side necks thereof. The spray 740 steam strips low boiling hydrocarbons from the sludge leading to more collection of higher calorific value hydrocarbons along with water at a temperature substantially below the boiling point of said hydrocarbons. Water added by sprayer 740 is preferably heated and addition of water is coupled with increase in heat flux to sustain the vaporization of additional water without cooling down the sludge. As shown in FIG. 7D, the foam breaker 735 includes an impingement plate 745 that redirects the foam entering to the thermal foam breaker 735, via inverted tube 730, along arrow-X and accordingly separating liquid coming out from said foam breaker 735 along arrow-Y1.

The foam breaker 735 includes a series of heated tubes 750 (as shown in FIG. 7E) positioned at a predefined angle of about 2° to 12° in order to slope down the liquid to the conical flask 705. Each of heated tubes 750 has a narrow slit section 755 (as shown in FIG. 7E) defined longitudinally across the tubes 750 as illustrated. Each of the slit section 755 has a thickness of about 5 mm. The heated tubes 750 are interconnected through the narrow slit sections 775. The heated tubes 750 and narrow slit sections 755 have a length to height ratio from about 1:1 to about 1:3. The narrow slit sections 755 are about ⅕^{th} to 1/20^{th} the diameter of the heated tubes 750. The narrow slits 755 facilitate passage of liquid from upper heated tube 750 to subsequent lower heated tube 750. The narrow slits 755 and heated tubes 750 allow heating of foam such that the vapour within the foam expands and rupture the thin film of liquid surrounding it thereby separating vapour and liquid in said thermal breaker 735. The thermal breaker 735 includes a plurality of plates 760 (as shown in FIGS. 7C and 7E) that are alternatively positioned at a predefined distance ‘E’ from inner wall of the thermal breaker 735 as shown. The plates 760 facilitate steady flow of heated thermic fluid within the thermal breaker 735. The heated tubes 750 have dissented volume that effectively reduce the velocity of foam allowing easy separation of vapour and foam therein such that foam being heavier slows down and collects in the heated tubes 750 thereby allowing the vapours to escape. The liquid separated in said heated tubes 750 collects at the bottom thereof and flows back to bottom of the conical flask 705 through a tube whose opening is below the level of sludge, such that no foam rises through said opening.

Further, vapours pass through a liquid droplet collector 765 where entrained liquid droplets are separated by inverting the direction of flow of vapour. The liquid is collected by a liquid droplet collector 765 that flows into the foam breaker 735 as indicated by an arrow Y2 (refer FIG. 7D) and back into the conical flask 705 along the path indicated by the arrow Z (refer FIG. 7D), through an exit point in the foam breaker 735. An opening of liquid droplet collector 765 entering into foam breaker 735 is kept under shallow pool of liquid such that foams present in foam breaker 735 do not enter liquid droplet collector 765 thereby allowing the liquid to flow only in the conical flask 705 as indicated by arrow-Z (refer FIG. 7D). A tap 770 is provided on top of the liquid droplet collector 765 to fill said shallow pool of liquid before process begins and another tap 772 is provided below said shallow liquid pool to drain the liquid out at the end of process and back into the conical flask 705 through the exit of foam breaker 735. Vapours that are completely devoid of any entrained liquids is diverted into a first condenser arrangement 775 and a second condenser arrangement 780 having at least three condensers 785 connected through Dean and Stark apparatuses 787, 789. The first condenser arrangement 775 and a second condenser arrangement 780 accommodate the enhanced rate of water vapour evolving from sludge by redirecting the substantial vapour released into multiple condensers. The condensers 785 are cooled by water at 5-6° C. to completely condense the liquid and not allow any vapour to escape. Preferably, cold water enters the outer shell of condensers 785 from the bottom filling it completely and overflowing out from top thereof. The condensers 785 are cooled by water at 5-6° C. to completely condense the liquid and not allow any vapour to escape. The condensed liquid is collected in respective receivers 790, 795. All exposed surfaces of the conical flask 705, Dean and Stark apparatuses 787, 789, liquid droplet collector 765, inverted tube 730, and condensers 785 include an insulation layer, preferably made of cotton material, in order to prevent condensation of vapour anywhere in the apparatus 700 other than condensers 785 to prevent heat loss. Insulation on condenser 785 prevents water condensation on outer wall which leads to erroneous collection results.

As shown in FIG. 7F, the thermic fluid is continuously circulated around the foam breaker 735 wherein arrangement is such that the thermic fluid enters from an inlet line 797 and exits from an outlet line 798 thereby having recirculation using a thermic fluid pump 799. The thermic fluid enters foam breaker 735 from the bottom and rises up to a heating element where it is uniformly heated and thereafter it uniformly overflows along the plates 760 and rises uniformly across the surface of foam breaker 735 such that temperature is uniform along a horizontal plane. The thermic fluid flows over the plate 760 from where it flows towards the thermic fluid pump 799. The apparatus setup 700 is capable of treating both viscous and non-viscous sludges as well as sludge containing emulsifiers that can form stable foam at a high rate of heating with facility of more water being removed at a lower temperature.

The foam breaker 735 is surrounded by a layered heating oil heating system wherein cooler heating oil enters into said oil heating system at two oppositely located outermost chambers from underneath thereby getting heated by an electrical heater positioned uniformly across its entire cross section. In the foam breaker 735, the heated oil rises till the edge of the weir and overflows into adjacent inner chamber such that said hot oil emerges at the bottom of the thermal foam breaker and rises along its surface to overflow out into adjacent side chamber for being collected from the bottom of said chamber by a circulating pump followed by sending back into the heating chamber to uniformly heat the thermal foam breaker 735 along its entire surface.

Referring back to FIGS. 7A-7F, the apparatus 700 provides highest possible heat flux for viscous sludge as well as for non-viscous sludge containing emulsifiers. In apparatus 700, mechanism of heat transfer for oil bath 710 removes any discrepancies present in mantle heater. In apparatus 700, the configuration of heat transfer surface along with the uniform distribution of heat flux promotes intense foaming and the associated turbulence and circulation. In apparatus 700, degree of superheat required for vapour escape from liquid pool by expansion is less therefore the final vapour temperature obtained is lower. In apparatus 700, explosive splattering is massive and continuous throughout the boiling process. In apparatus 700, conical flask also helps containing entrainment from splattering.

In an embodiment, the apparatus 700 may include distributed multi layered heat transfer surfaces to aid rapid boiling of the sludge that causes circulation of mass of the sludge without mechanical agitation, thereby aiding heat sink rate through expedited boiling by aiding droplets to reach heat transfer surfaces faster. During boiling in the apparatus 700, plumes of foam with reduced density drive the material to circulate rapidly and sustain quick generation of boiling/foaming. It is understood here that physical percolation of water droplets does not occur though heating reduces viscosity of the sludge.

In operation, there is a high temperature difference between the oil bath 710 and liquid sludge contained in the conical flask 705 as well as the greater heat transfer area provided by the conical flask 705 helps water to be released at a high rate thereby preventing the temperature of the sludge from rising as long as water is vaporized thus eventually providing the heat sink required to maintain a low temperature by absorbing the required latent heat of vaporization. However, as the rate of water removal diminishes, there is no heat sink and temperature of hydrocarbons starts to rise in said apparatus 700. In such case, a lower temperature difference and greater surface area for a given volume of sludge helps the process in said apparatus 700. It is understood here it is possible to recover entire water from sludge at a significantly low temperature close to boiling point of water droplets as the thin layer of sludge remaining in the apparatus 700 does not require much superheat to evolve from the sludge through expansion.

In operation, the compressed hot water sprayer 740 utilized in said apparatus 700 dispenses fine droplets of water to sustain foaming for a longer time to collect more low boiling hydrocarbons from viscous hydrocarbons as a separate product to enhance the overall commercial value of recovered hydrocarbons. In operation, the apparatus 700 help assists in stripping out low boiling hydrocarbons from viscous sludge in addition to boiling out about 70% to 90% of bound water present in the sludge under foamed condition at a low temperature up to 102° C., certainly below 110° C. These low boiling hydrocarbons are distilled out along with bound water at a temperature lower than the boiling point of said hydrocarbons wherein said temperature is certainly below the bubble point of hydrocarbon composite. It is understood however that extent of low boiling hydrocarbons recovered depends on time over which foaming is sustained and temperature up to which foam boiling is carried out.

Referring to FIGS. 1-7E, the batch of the sludge may be rapidly heated until it reaches boiling point of water without homogenizing temperature by mechanical agitation. By heating rapidly without homogenization, localized zones of heated sludge are formed where temperature is close to the boiling point of water due to which it is easier for water to vaporize and egress. The vapours evolving at a fast rate heat up the sludge in its path as well as the void created by these vapours close to the heating surface will be occupied by surrounding colder sludge. Hence, convective currents are established in the sludge homogenizing the temperature throughout and reducing the overall viscosity of sludge.

In the context of the present invention, the boiling process is characterized by formation of minuscule vapour bubbles resulting in higher rate of mass transfer due to convective currents. Boiling in sludge is not akin to pure boiling. In pure boiling, abundance of water close to boiling point at the heating surface results in formation of bigger and bigger vapour bubbles as boiling progresses during said boiling process. However, this is not the case in boiling of sludge. In sludge, water droplets are isolated from each other by a layer of viscous hydrocarbons between them. This absence of water required for bubble growth limits the size of vapour bubbles. Vapour bubbles egressing from a heat transferring surface also carry with them some amount of liquid. This upwards movement of liquid further increases drag experienced by water droplets. However, void created by this upward movement is filled by water rich part of sludge, basically inducing eddy currents in the heating vessels used in said process. The translational push thus resulting from eddy currents is responsible for transfer of water rich sludge towards heat transfer surface. It is understood here that smaller water droplets also have higher boiling point and therefore require more heat to vaporize in said process. However, proximity of water droplets towards heat transfer surfaces being rate limiting in case of boiling of bound water, enhanced fluidization becomes essential for water removal.

It is understood here that presence of surfactants or emulsifiers also influences boiling mechanism in said process. For example, Asphaltenes present in sludge act as emulsifiers and may elevate boiling point of bound water. Moreover, surfactants like SLS reduce viscosity of sludge, but it facilitates removal of final fraction of water even more difficult due to increased attraction between water and hydrocarbons.

It is understood further that foaming caused due to surfactants is due to incorporation of air into liquid without any effect on improving the rate of percolation of water droplets due to the large size of bubbles formed during the boiling process. It is further understood here that the reactors or heating vessel used in conjunction with the present invention may have multi-layered heating surfaces thereby having a thermic fluid or a pressurized hot water circulated therethrough. The heating vessel includes the multi layered heat transfer surfaces such that rate of heat flux transferred to the heating vessel are controlled by temperature of thermic fluid and the flow rate of thermic fluid used in the heating vessel.

In the context of the present invention, during boiling of a material, rapid rate of heating enables the entire mass of material to undergo circulation throughout the flask 705, and aids to quickly transfer the water rich sludge in contact with the heating surface thereof. This in turn results in rapid boiling of water from the sludge in the flask 705. In order to further regulate the temperature the material and extra water is added, resulting in sustained circulation of material and boiling at lower temperature.

In the context of the present invention, rapid rate of heating is important in the cases where the convective currents in the material are not easily generated due to high viscosity or such similar conditions. However, distributed heating media rather than localized heating media generates better convective currents through the material and aids boiling.

In the context of the present invention rate of heat flux applied, rate of foam breaking and the maximum rate of condensation possible must be optimized since the each of these conditions have a different effect on the rate of water removal. In attempt to convert entire mass of sludge into foamed mass, dramatic expansion of vapor occurs. In such expansion, the coarser water droplets are evaporated and are covered by thin film of hydrocarbon while foaming. The finer droplets of water reside in the hydrocarbon foam film. Accordingly, the high boiling finer water droplets must be boiled while the foam that expands must be controlled by thermally breaking the foam to enhance water removal.

In the context of the present invention, to separate maximum amount of water from sludge, at lower temperature and highest heating rate foaming should be applied. Based on the strength of sludge, after removing 70% to 90% of water droplets under foamed conditions, it is extremely difficult to remove remaining water due to one or more of the following reasons.

It the context of the present invention, it is difficult to transfer such small heat flux through the remaining viscous hydrocarbons without necessary convective currents of material or other heat transfer mechanisms although the quantity of heat required to vaporize rest of the water is small. Further, the inability to transfer heat through insulating media thermally hinders the process. Furthermore, even if the tiny dispersed droplets of water are vaporized at high boiling point, they would have to be superheated to expand in volume and escape from the viscous hydrocarbons. Enough amount of vapor is not present in the material towards the end of the process, to coalesce and expand. Even if we manage to ensure escape to the superheated vapor from the viscous hydrocarbons, they are released as shockwave, dispersing the energy given.

The size of the foam is dictated by size of the dispersed water droplet size in the thin film of the foam in accordance with the present invention. In accordance with the present invention, the foam based boiling is driven by thermally induced vigorous circulation of material. The thin film boiling according to present invention is driven by agitation caused by vapor induced spluttering of material. Therefore need for mechanical stirrer in either case is obviated.

The low boiling range free flowing hydrocarbons removed via steam stripping according to the present invention have much higher Hydrogen to Carbon ratio as well as higher Calorific value as compared to parent viscous hydrocarbons. Hence it is ideally suited for converting to higher value transport grade fuel. In addition, extent of steam stripping is dictated by time of steam stripping as well as temperature at which it is carried out. In accordance with the present invention, the thermally induced circulation is necessary in sludge as heating of sludge lacks the convective current based heating, and to a large extent lack physical separation and percolation of free water towards heating surfaces.

In the context of the present invention, the sludges with different strengths as well as different size of dispersed water droplets have distinctly varying boiling points. These characteristics can be exploited by charging sludges with varying strengths in different evaporating chambers of a multiple effect evaporator such that vapours evolving from the strongest sludge are used to boil out water from a less stringer sludge and so on.

### EXAMPLES

The following examples and comparative examples are provided to demonstrate particular embodiments of the present invention. It should be appreciated by those skill in the art that the methods disclosed in the examples and comparative examples that follow merely represent exemplary embodiments of the present invention. Those of skill in the art should, in light of the present disclosure, appreciate that many changes can be made in the specific embodiments described and still obtain a like or similar result without departing from the spirit and scope of the present invention. The following examples and comparative examples include the temperatures mentioned therein which are the temperatures at an atmospheric pressure of about 940 mBar.

### Example 1

### Pre-Treatment of Lagoon Sludges with Centrifuge

Experiments were conducted to determine the extent of bound water present in lagoon sludges procured from ONGC, Oil and Natural Gas Corporation. Consequently, the unbound water in sludge was removed as slop oil, thus reducing the quantum of sludge and also value added, saleable hydrocarbons were recovered.

Accordingly, the sludge was homogenized and evaluated for water content using BTX process, for Calorific Value using Bomb calorimeter, and for Ash content using Muffle Furnace. Further, the sludge was centrifuged in a Heavy Duty Non-Refrigerated Batch Type Centrifuge operated for a residence time of 10 minutes at 4500 RCF.

Consequently, after centrifuge, the ONGC sludge was separated into 3 or 4 fractions, namely Free flowing Hydrocarbons as top fraction, Medium viscous hydrocarbons as the middle portion and Slop oil as bottom portion. A Viscous hydrocarbon layer was also separated as a bottom fraction in ONGC Lagoon Sludge #2. All these fractions were evaluated for water content, ash content, sediment content and the separated water was evaluated for turbidity. Consequently, ONGC lagoon Sludge#2 fractions were further treated in centrifuge at 4500 RCF and 21893 RCF and the residual Hydrocarbon was evaluated for water content.

TABLE 1.1
CENTRIFUGING DETAILS

| | | | | TEST 3 |
|---|---|---|---|---|
| Sl. | | TEST 1 | TEST 2 | Lagoon |
| No. | PARTICULARS | Lagoon Sludge 1 | | Sludge 2 |
| 1 | Wt. of Sludge taken for treatment (g) | 700.91 | 2,115.91 | 701.77 |
| 2 | Wt. % Water in above Sludge as determined | 39.97 | 40.95 | 46.23 |
| | by BTX | | | |
| 3 | Wt. % Ash Content in above Hydrocarbons | 3.68 | 3.70 | — |
| 4 | Calorific Value of above Sludge (kcal/kg) | 6,038 | 5,945 | 5,243 |
| 5 | Time taken to Reach Max. Relative | 2.75 | 2.67 | 3.69 |
| | Centrifugal Force (min) | | | |
| 6 | Max. Relative Centrifugal Force at which the | 4,500 | 21,893 | 4,500 |
| | Centrifuge was operated (RCF) | | | |
| 7 | Holding Time at Max. Relative Centrifugal | 10.00 | 10.00 | 10.00 |
| | Force (min) | | | |
| 8 | Time taken to come back to zero Relative | 16.65 | 2.17 | 16.70 |
| | Centrifugal Force (min) | | | |
| 9 | Total Residence Time inside Centrifuge (min) | 29.45 | 14.83 | 30.39 |

TABLE 1.2
PRE-TREATMENT OF ONGC SLUDGE IN CENTRIFUGE

| Sl. | | | | |
|---|---|---|---|---|
| No. | PARTICULARS | TEST 1 | TEST 2 | TEST 3 |
| 1 | Wt. % Free flowing Hydrocarbons that | 40.99 | 42.60 | 26.72 |
| | separated out from above sludge | | | |
| 2 | Wt. % Water in above Hydrocarbons as | 0.39 | 0.15 | 8.70 |
| | determined by BTX. | | | |
| 3 | Wt. % Ash/Sediment Content in above Sludge | 0.88 | 0.73 | 1.14 |
| 4 | Calorific Value of above Hydrocarbons | 10,633 | 10,681 | 9,808 |
| | (kcal/kg) | | | |
| 5 | Wt. % Medium Viscous Hydrocarbons that | 31.67 | 20.85 | 32.66 |
| | Separated Out from above Sludge | | | |
| 6 | Wt. % Water in above Medium Viscous | 42.21 | 30.26 | 43.54 |
| | Hydrocarbons as determined by BTX. | | | |
| 7 | Calorific Value of Medium Viscous | 5,212 | 6,635 | 5,415 |
| | Hydrocarbons (kcal/kg) | | | |
| 8 | Wt. % Ash/Sediment* Content in above | 8.61 | 7.23 | 8.83* |
| | Hydrocarbons | | | |
| 9 | Wt. % Slop Oil that Separated Out from | 26.46 | 35.91 | 15.67 |
| | above Sludge | | | |
| 10 | Hydrocarbons Content in Slop Oil (ppm) | 0 | 0 | 0 |
| 11 | Turbidity of Slop Oil (NTU) | 398 | 1,132 | 682 |
| 12 | Wt. % Ash Content in above Slop Oil | 2.04 | 5.18 | — |
| 13 | Wt. % Viscous Hydrocarbons that separated | — | — | 23.62 |
| | out from above sludge | | | |
| 14 | Wt. % Water in above Hydrocarbons as | — | — | 59.32 |
| | determined by BTX. | | | |
| 15 | Wt. % Sediment Content in above Sludge | — | — | 16.09 |
| 16 | Calorific Value of above Hydrocarbons | — | — | 3,003 |
| | (kcal/kg) | | | |
| 17 | Wt. % Hydrocarbons + Ash lost through | 0.37 | 0.12 | 1.12 |
| | adhering to various surfaces | | | |
| 18 | Wt. % Water lost through Evaporation and | 0.52 | 0.54 | 0.21 |
| | Wetting of Surfaces | | | |

TABLE 1.3
FURTHER TREATMENT OF ONGC LAGOON SLUDGE #2
FRACTIONS AFTER INITIAL CENTRIFUGE

| | | Free | Medium | |
|---|---|---|---|---|
| Sl. | | Flowing | Viscous | Viscous |
| No. | PARTICULARS | Hydrocarbons | Hydrocarbons | Hydrocarbons |
| 1 | Wt. of Material taken for further treatment (g) | 187.51 | 140.40 | 165.76 |
| 2 | Wt. % Residual Hydrocarbons separated | 65.63 | — | — |
| | after centrifuging with 4500 RCF | | | |
| 3 | Wt. % Water in above Residual Hydrocarbons | 5 | — | — |
| 4 | Wt. % Residual Sludge separated after | 32.06 | — | 52.45 |
| | centrifuging with 4500 RCF | | | |
| 5 | Wt. % Water in above Residual Sludge | 16.02 | — | 37.38 |
| 6 | Calorific Value of above Residual Sludge | — | — | 4,233 |
| | (kcal/kg) | | | |
| 7 | Wt. % Sediment Content in above Sludge | — | — | 24.25 |
| 8 | Wt. % Slop Oil separated after centrifuging | — | — | 46.21 |
| | with 4500 RCF | | | |
| 9 | Wt. % Material lost as adhering to surfaces | 2.18 | — | 1.10 |
| 10 | Wt. % Material lost as evaporation losses, etc. | 0.13 | — | 0.23 |
| 11 | Wt. of above Residual | 119.31 | 140.40 | 70.11* |
| | Hydrocarbons/Sludge* for further centrifuge | | | |
| | at 21893 RCF (g) | | | |
| 12 | Wt. % Remaining Hydrocarbons separated | 56.42 | 26.50 | 19.31 |
| | after centrifuging above residual | | | |
| | Hydrocarbons/sludge at 21893 RCF | | | |
| 13 | Wt. % Water in above Remaining | 0.1 | 0.03 | 1.39 |
| | Hydrocarbons | | | |
| 14 | Calorific Value of above Remaining | 10,787 | 10,762 | 10,380 |
| | Hydrocarbons (kcal/kg) | | | |
| 15 | Wt. % Remaining Sludge separated after | 41.21 | 44.45 | 63.42 |
| | centrifuging above residual Hydrocarbons/ | | | |
| | sludge at 21893 RCF | | | |
| 16 | Wt. % Water in above Remaining Sludge | 11.27 | 36.89 | 33.93 |
| 17 | Calorific Value of above Remaining Sludge | 9,394 | 5,977 | 3,437 |
| | (kcal/kg) | | | |
| 18 | Wt. % Sediment Content in above Sludge | 0.57 | 10.33 | 34.03 |
| 19 | Wt. % Slop Oil separated after centrifuging | — | 28.43 | 16.87 |
| | above residual Hydrocarbons/Sludge at | | | |
| | 21893 RCF | | | |
| 20 | Wt. % Material lost as adhering to surfaces | 2.32 | 0.55 | 0.3 |
| 21 | Wt. % Material lost as evaporation losses, etc. | 0.05 | 0.06 | 0.1 |

It was observed that pre-treatment with centrifuge had varying results for different ONGC Sludges as seen from Table 1.1 and 1.2. It was observed from Test 1 that about 41 wt. % of saleable, free flowing hydrocarbons with calorific value of about 10,633 kcal/kg were obtained. However, for Test 3, the free flowing hydrocarbons separated had high water percentage and said free flowing hydrocarbons were further separated to give solids residual fraction, finally giving only 9.89% saleable free flowing hydrocarbons with calorific value of about 10,787 kcal/kg.

Further, it was observed that nature of sludge had an effect with the type of fractions separated after centrifuge. For ONGC Lagoon Sludge #2, a fourth medium viscous hydrocarbon fraction was separated above the free water layer. It was observed that this layer had lower saleable value as the water content was higher, and calorific value almost similar to that of parent Lagoon Sludge #2.

Besides, it was also observed that the amount of sludge given for further treatment was reduced by about two third in its amount. It was also observed that pre-treatment of the sludge helped in reducing salt and ash content in hydrocarbons. Further it was confirmed that only centrifuge cannot remove entire water from the sludge. It was observed that the centrifuge enhanced acceleration due to gravity by enormously speeding up the naturally occurring separation of two different immiscible liquids due to density difference. However, the centrifuge was helping when the mean free path between tiny droplets of the particular liquid was small followed by consolidating them into much larger droplets with reduced drag, which then helped them to move even faster. It was observed that Lagoon Sludge #2 was more recalcitrant than to Lagoon Sludge #1 for the pre-treatment with centrifuge. Accordingly, further treatment of sludge was intentionally modified as a consequence of pre-treatment by centrifuge. It was established that the viscous sludge could be subjected to thin layer boiling as natural foaming tendency of the sludge could be poor, while the free-flowing sludge does not demand thin layer boiling, as it can naturally foam and which in itself could be a form of thin layer boiling.

Further, it was observed in Test 3 that separation of water was possible in spite of the fact that viscous layer of hydrocarbons separated before the water layer and then after the water layer. From Test 1 and Test 2, it was observed that by increasing the RCF, more amount of free water was separated and consequently less water content was observed in the Free flowing Hydrocarbons and Viscous hydrocarbons. For ONGC Lagoon sludge #2 fractions, total water in free flowing hydrocarbons was observed to be bound water. It was observed that out of the 43.54% water in medium viscous hydrocarbons, 34.71% was bound water, and remaining 65.29% water was separated as unbound water. In addition, out of the 59.32% water in viscous hydrocarbons, 7.19% was bound water while the remaining 92.81% water was separated as unbound water.

After further pre-treatment of ONGC Lagoon sludge #2 fractions, it was observed that residual free flowing fraction, even though with the high water content failed to separate any water, and gave less than half of its amount as saleable free-flowing hydrocarbons. The medium viscous hydrocarbons after centrifuge at 21893 RCF gave merely 26.50% of saleable hydrocarbons, although separated another 28.43% fraction as water. A large amount of water was separated from the viscous hydrocarbons through treatment with centrifuge, although not entire water.

Further, it was observed that only fraction of viscous hydrocarbons were recovered as saleable hydrocarbons. It was acknowledged that by increasing the RCF more amount of free water can be separated. Lastly, it was established that constituents of lagoon sludge do not naturally separate out with time even after decades, wherein quantum of bonds broken depends on the operative RCF of centrifuge and residence time of the sludge within the centrifuge.

### Example 2

### Removal of Bound Water from Varying Amount of Furnace Oil Sludge by Boiling with and without Preheating the Sludge

Experiments were conducted to evaluate the efficacy of boiling in removal of bound water from Furnace oil sludge with 50 wt. % bound water in it and comparing the efficacy of the process with different amounts of sludge, and with presence of pre-heating.

Accordingly, for the experiments where no preheating was carried out, predetermined amount of Furnace oil sludge was taken in an RB flask of a Dean and Stark Apparatus followed by continuous heating thereof in the mantle heater, while continuously monitoring temperature of the material in the RB flask with a digital thermometer. The rate of heating was kept rapid till the boiling point of material, thereafter the rate of heating was controlled to give a lower condensation rate, and also such that the rate was just enough to avoid vapour entrapment in the condenser. The vapours of bound water and hydrocarbons were collected in the receiver after condensing them with circulating cold water at 5-6° C. in an insulated condenser. The condensates were taken out and collected in separating flask using a stop cork at the bottom of the receiver. After phase separation was achieved in the separating flask, the hydrocarbons and water were individually weighed each time. The procedure was followed till the temperature of material reached 205° C., after which the mantle heater was switched off.

Accordingly, for the experiments where preheating was carried, predetermined amounts of Furnace oil sludge were taken in an RB flask for preheating step, before boiling the sludge sample. Accordingly, to quickly establish uniform temperature within the mass of sludge taken, the mantle heater was heated over short spans of times, while in between these heating cycles, the RB flask was removed from mantle heater and sludge inside was thoroughly mixed by vigorously shaking the RB flask from outside. The lid of RB Flask was periodically opened to release pressure build-up because of water vapour release from the sludge on account of vigorous shaking of the RB flask. This was repeated till temperature of sludge reaches about 80° C.

Thereafter, the RB flask was transferred to a Dean and Stark Apparatus followed by continuous heating thereof in the mantle heater, while continuously monitoring the temperature of the material in the RB flask with a digital thermometer. The rate of heating was kept rapid till the material temperature rose to 90° C., thereafter the rate of heating was controlled to give a lower condensation rate and also such that the rate was just enough to avoid vapour entrapment in the condenser. The vapours of bound water and hydrocarbons were collected in the receiver after condensing them with circulating cold water at 5-6° C. in an insulated condenser. The condensates were taken out and collected in a separating flask using a stop cork at the bottom of the receiver. After phase separation was achieved in the separating flask, hydrocarbons and water were individually weighed each time. This procedure was followed till the temperature of material reached 205° C., after which the mantle heater was switched off.

Finally, the retrieved water and hydrocarbon samples were analysed quantitatively using mass balance study. Here, the different amounts of Furnace oil sludge taken were 300 g, 600 g and 900 g.

TABLE 2.1
REMOVAL OF BOUND WATER BY BOILING OF FURNACE OIL SLUDGE IN
DEAN AND STARK APPARATUS FOR DIFFERNT AMOUNT OF SLUDGES WITH AND
WITHOUT PREHEATING THE SLUDGE

| Sl. No. | PARTICULARS | TEST 1 | TEST 2 | TEST 2B | TEST 3 | TEST 4 |
|---|---|---|---|---|---|---|
| 1 | Amount of Sludge (g) | 301.23 | 900.66 | 900.56 | 300.88 | 900.37 |
| 2 | Wt. % of Water Present in Sludge | 49.6205 | 49.7495 | 50.2441 | 49.554 | 49.554 |
| 3 | Preheating | No | No | No | Yes | Yes |
| 4 | Low Temperature I (° C.) | 107.50 | 107.00 | 107.10 | 105.28 | 107.63 |
| 5 | Wt. % Water Collected up to above | 66.22 | 69.93 | 84.96 | 4.13 | 22.85 |
| | Temperature | | | | | |
| 6 | Wt. % Hydrocarbons Collected up to | 3.10 | 3.54 | 2.98 | 0.74 | 1.69 |
| | above Temperature | | | | | |
| 7 | Rate of Water Collection up to above | 1.14 | 1.84 | 4.76 | 0.63 | 1.49 |
| | Temperature (g/min) | | | | | |
| 8 | Low Temperature II (° C.) | 112.40 | 112.00 | — | 110.18 | 112.44 |
| 9 | Wt. % of Water Collected up to above | 69.10 | 76.03 | — | 11.76 | 40.78 |
| | Temperature | | | | | |
| 10 | Wt. % of Hydrocarbons Collected up to | 3.17 | 3.77 | — | 1.24 | 3.48 |
| | above Temperature | | | | | |
| 11 | Rate of Water Collection up to above | 1.13 | 1.81 | — | 0.94 | 1.46 |
| | Temperature (g/min) | | | | | |
| 12 | Low temperature III (° C.) | 123.20 | 122.00 | — | 123.92 | 123.72 |
| 13 | Wt. % Water collected up to above | 70.94 | 87.03 | — | 67.29 | 87.82 |
| | temp. | | | | | |
| 14 | Wt. % Hydrocarbons collected up to | 3.41 | 4.16 | — | 4.63 | 4.68 |
| | above temperature. | | | | | |
| 15 | Rate of Water Collection (g/min) | 1.08 | 1.78 | — | 1.10 | 1.40 |
| 16 | High Temperature I (° C.) | 177.10 | 177.00 | — | 173.66 | 173.86 |
| 17 | Wt. % of Water Collected up to above | 84.48 | 97.13 | — | 90.54 | 97.16 |
| | Temperature | | | | | |
| 18 | Wt. % of Hydrocarbons Collected up to | 4.26 | 4.93 | — | 6.09 | 5.11 |
| | above Temperature | | | | | |
| 19 | Rate of Water Collection up to above | 0.88 | 1.41 | — | 0.98 | 1.24 |
| | Temperature (g/min) | | | | | |
| 20 | Total Wt. % of Water Collected | 86.71 | 97.52 | — | 91.09 | 97.90 |
| 21 | Total Wt. % of Hydrocarbons | 4.45 | 4.93 | — | 6.13 | 5.11 |
| | Collected | | | | | |
| 22 | Average Rate of Water Collection | 0.90 | 2.42 | — | 0.94 | 1.25 |
| | (g/min) | | | | | |
| 23 | Average Rate of Hydrocarbons | 0.05 | 0.12 | — | 0.06 | 0.07 |
| | Collection (g/min) | | | | | |
| 24 | Wt. % Loss due to adherings to various | 5.92 | 0.92 | — | 4.37 | 1.12 |
| | surfaces | | | | | |
| 25 | Wt. % Loss of material due to | 1.28 | 1.01 | — | 0.74 | 1.11 |
| | Evaporation, Spillages etc. | | | | | |
| 26 | Total Time taken for the Process (Hrs.) | 3.81 | 5.24 | — | 3.33 | 8.17 |
| 27 | Residual Water present in left over | 320 | 551 | — | 1211 | 91 |
| | Hydrocarbons determined by BTX | | | | | |
| | Test (PPM) | | | | | |

It was observed that at low temperature of about 107° C., the collection of water was considerably high for boiling without preheating with 66.22% and 69.93% water collected for 300 g and 900 g sludge respectively, while collection of water was mere 4.13% at 105.28° C. and 22.85% at 107.63° C. for 300 g and 900 g for experiments without preheating. This trend was further carried for another 15° C., till approximately 122° C. liquid temperature, after which the % collection in the experiment with preheating was substantially increased and produced comparable values as with experiments without preheating. It was observed that the mantle heater peculiarly had the heating element distributed across the lower hemisphere of the RB flask except for the bottom part. Without preheating, boiling of water in sludge began at the sides of RB flask with heating element. Plumes of vapour rose through the sludge foaming it in the process. The reduced density and viscosity on account of foaming provided the liquid circulation fundamental to rapid vapour formation at low temperature. Finer water droplets present within the liquid film surrounding vapour bubbles in foam were removed more easily as vapour escape route was readily available for such water droplets, which would otherwise have to be superheated and removed from bulk of sludge through explosive discharge. This established the fact that boiling without preheating could be more efficient process to remove water from sludge at faster rate, at a lower temperature.

Further, it was observed that the rate of water removal was comparable for 300 g sludge with and without preheating experiments at 0.94 g/min and 0.90 g/min respectively. Thus, it seemed that preheating was not having much effect with less amount of sludge, as rate of water collection with preheating was observed to be almost equivalent to rapid heating. While for 900 g, the rate of water removal was higher when no preheating was carried out at 2.42 g/min, while comparing to when preheating was carried out at 1.25 g/min.

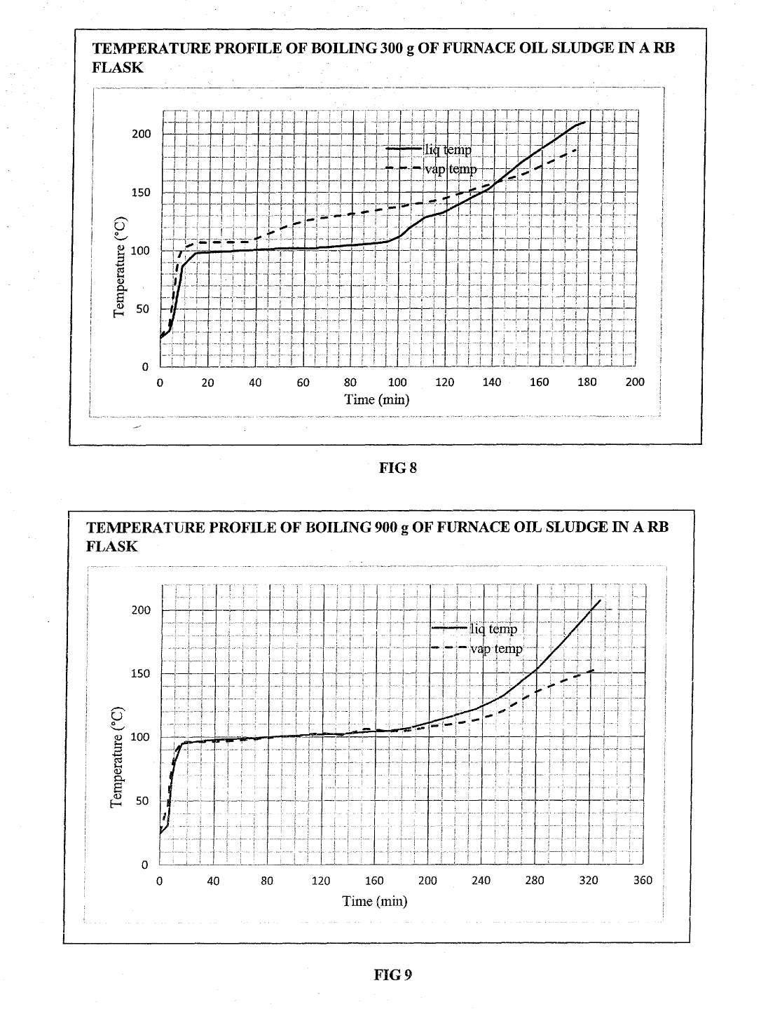

As seen from FIG. 8 and FIG. 9, it was observed that in 300 g sludge, vapor temperature was always higher than liquid temperature up to about 150° C. The heat flux from mantle heater was observed to pass directly to the vapor through the heated glass. However, in 900 g sludge, the heating elements were below the liquid level and vapors were not heated directly through the glass, hence vapor temperature was almost equal to liquid temperature at boiling point and less than liquid temperature for the rest of the process. Liquid temperature started to rise above certain temperature after a point, once rate of water removal diminished. Without vaporization of water, there was nothing to peg down the temperature allowing the rest of hydrocarbons to be heated up to a higher temperature. For 900 g sludge, temperature of vapor phase rose very slowly up to 153° C. and some level of superheat was required for water vapor trapped within sludge to expand and escape said sludge through explosive discharge. However, vapor expansion required in 900 g sludge was more than 300 g sludge, since vapor itself was directly exposed to a heating surface. Accordingly, it was observed that vapor temperature was higher for 300 g sludge than 900 g sludge.

While vapor in 300 g sludge got heated by a lot more surface of RB flask because of the position of heating elements present in mantle, this amounted to transferring the input heat at the wrong place thereby slowing entire process of water removal. This was observed to happen when larger fraction of heating elements was above the level of material. Consequently, there was seemingly no difference in rate of water collection, for 300 g sludge with and without preheating. On the other hand, heating loss could not be mitigated by adding more sludge to cover the bottom half of the RB flask, as explosive discharge of water was found to become too severe.

While quantity of sludge went up from 300 g to 900 g, boiling of water from sludge under foamed conditions got a huge boost, partly because foam based reduction in overall viscosity of sludge persisted over longer period and vapor bubbles density across a horizontal cross section increased enormously with accumulation of these bubbles coming from lot more sites underneath the liquid level. This not only enabled faster and more efficient collection of water but also allowed more water to be collected from sludge at temperature below 110° C. Towards the fag end of process, it was observed that sludge temperature increased a lot, in spite of enhancement in heat transfer surface to the emerging vapor from heated surface of RB flask during that stage. At that stage, rate of heat transfer could not be adequately reduced for the liquid sludge to match the required rate needed to boil out water, partly because heat transfer to vapor was more inefficient and sluggish on account of liquid level falling below level of heating elements and thereby necessitating heat transfer to occur through a longer distance within glass walls of RB flask. Secondly, the induced physical movement of liquid bulk during that stage was vastly reduced because of lack of bubbles generated.

It was also observed that during explosive discharge of vapor, more so in the middle phase of the process, liquid temperature momentarily fell down below vapor temperature because of such explosive discharge. This explosive discharge was not occurring on heat transfer surface rather it was occurring in the bulk of liquid and extracting latent heat required for vaporization from liquid thereby cooling the liquid down with a lagging effect. Additionally, it was believed that as superheating was required to expand vapor and facilitate its escape from liquid hydrocarbons, the vapor temperature was always lower than material temperature.

In case of 300 g, the vapor temperature was observed to be lot higher than 900 g in spite of degree of super heat required by vapor droplets to expand to facilitate its release from viscous bulk, was a lot lower. This was believed to be because of the fact that with 300 g of sludge, final pool of hydrocarbons dipped so low below the heating elements that heat transfer to liquid pool slowed down dramatically. This in turn ended up in excessively overheating glass walls of the RB flask. It was observed that vapor temperature increased in such cases due to heat pick up from overheated surface of RB flask.

As long as sludge was boiling under foamed conditions with expansion of volume because of foams, the liquid adequately pegged down the temperature of the RB flask surface by being able to provide a heat sink. This was believed to be happening over a longer period when quantity of sludge was more. Moreover, foaming circulated the liquid in contact with the RB flask which also prevented the temperature to rise for a longer period of time. Further, it was observed from Test 2B that lot more water could be collected by rapidly heating the sludge provided that the condenser could be able to withstand the increase in demand.

### Example 3

### Removal of Water from Furnace Oil Sludges Containing 50 Wt. % Water with Varying Mixing Time, Entire Water being Bound Water, by Boiling in Dean and Stark Apparatus

Experiments were conducted to evaluate the efficacy of boiling for removal of water from Furnace oil sludge containing 50 wt. % bound water and the sludges prepared with varying mixing time were compared. Accordingly, predefined proportions of Furnace oil and water were mixed in a high shear mixer by varying the time of mixing as 2 minutes, 5 minutes and 8 minutes, anticipating change in sludge properties.

Accordingly, predetermined amounts of Furnace oil sludge was taken in an RB flask of a Dean and Stark Apparatus followed by continuous heating thereof in a mantle heater, while continuously monitoring the temperature of material in the RB flask with a digital thermometer. The rate of heating was kept rapid till the boiling point of material, thereafter the rate of heating was reduced to a desired level. The vapors of water and hydrocarbons, after condensing them with circulating cold water at 5-6° C. in an insulated condenser, were collected in the receiver. The condensates were taken out and collected in separating flask using a stop cork at the bottom of the receiver, at set values of temperature. After phase separation was achieved in the separating flask, hydrocarbons and water were individually weighed each time. The procedure was followed till the temperature of material reached 205° C., after which the mantle heater was switched off.

TABLE 3.1
REMOVAL OF WATER FROM 900 g OF FURNACE OIL
SLUDGE BY BOILING IN DEAN AND STARK APPARATUS

| Sl. | | | | |
|---|---|---|---|---|
| No. | PARTICULARS | TEST 1 | TEST 2 | TEST 3 |
| 1 | Mixing Time during Sludge Preparation (min) | 2 | 5 | 8 |
| 2 | Wt. of Sludge taken (g) | 901.20 | 900.60 | 903.38 |
| 3 | Wt. % Water Present in above Sludge | 49.9561 | 49.7495 | 49.5661 |
| 4 | Average Rate of Water Collection (g/min) | 1.33 | 1.41 | 1.52 |
| 5 | Temperature (° C.) | 107.0 | 107.0 | 99.0 |
| 6 | Wt. % Water Collected upto above Temperature | 55.23 | 69.94 | 67.63 |
| 7 | Rate of Water Collection (g/min) | 1.81 | 1.84 | 2.05 |
| 8 | Temperature (° C.) | 112.00 | 112.00 | 112.00 |
| 9 | Wt. % Water Collected upto above Temperature | 63.62 | 76.04 | 81.33 |
| 10 | Rate of Water Collection (g/min) | 1.78 | 1.81 | 1.97 |
| 11 | Temperature (° C.) | 117.00 | 117.00 | 117.00 |
| 12 | Wt. % Water Collected upto above Temperature | 86.32 | 81.82 | 82.90 |
| 13 | Rate of Water Collection (g/min) | 1.76 | 1.79 | 1.95 |
| 14 | Temperature (° C.) | 205 | 205.3 | 205 |
| 15 | Wt. % Water Collected upto above Temperature | 98.91 | 97.50 | 97.65 |
| 16 | Rate of Water Collection (g/min) | 1.41 | 1.41 | 1.54 |
| 17 | Wt. % of Water Collected | 98.97 | 97.53 | 97.66 |
| 18 | Wt. % of Hydrocarbons Collected | 4.32 | 4.93 | 3.95 |
| 19 | Time taken for entire experiment (Hrs.) | 5.60 | 5.18 | 4.79 |
| 20 | Residual Water Present in left over Hydrocarbons as | 459 | 551 | 547 |
| | determined by BTX Test (PPM) | | | |

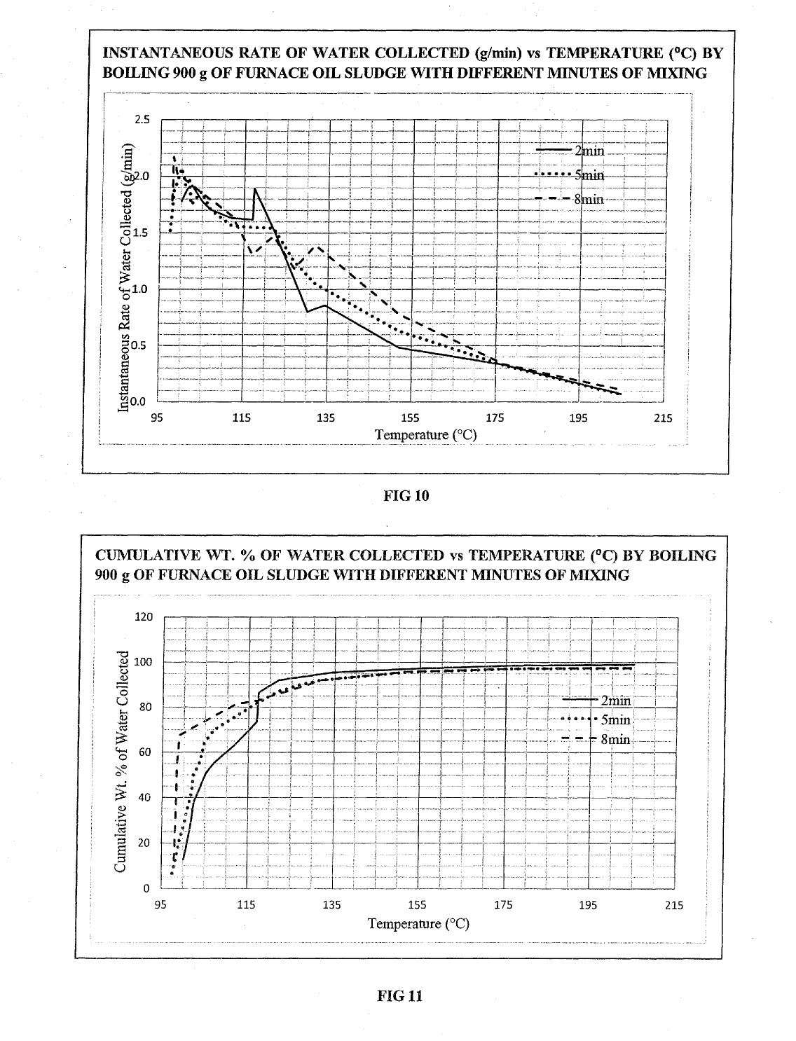

Referring to graphs shown in FIG. 10 and FIG. 11, it was observed that more amount of water was collected for 8 minute mixing than for 5 minute mixing at lower temperature. However by 117° C., wt. % water collected was similar for all three types of sludges at approximately 82%. Initial rate of water collection was fastest for 8 min sludge with water being collected at a rate of 2 g/min till 107° C. Comparatively rate of water collection was 1.81 and 1.84 g/min by 107° C. for 2 min sludge and 5 min sludge respectively. As it was observed from the graphs that the rate of water collection decreased sharply after 117° C. as amount of water leftover in sludge was significantly diminished from that point onwards with only 20% or less of initial water content still remaining in the sludge.

It was observed that different mixing time created a varying average droplet size as well as varying droplet size distribution. Rate of water collected and wt. % water collected at different temperatures highlighted these differences. Sludge prepared by 8 min mixing was having smaller average droplet size and uniform droplet size distribution. When such sludge was boiled, the size of vapor bubble formed was observed to be less and a larger fraction of sludge started boiling at the same time. More vapors with smaller bubbles were believed to cause intense foaming with stable foam structure. Finer water droplets present in the liquid film surrounding vapor bubbles were boiled more easily through the film rather than the bulk of liquid as escape route for vapor was more readily available facilitating release of fine bubbles without superheating and explosive discharge. While for 2 minute mixing, the larger droplets were pooled at the bottom due to uneven distribution and thus required higher temperature to burst out from the thick, viscous hydrocarbons above it. Also, it could be explained as since the heating element in the mantle was present at the sides and not at the bottom, the entire sludge above the pool of water need to be heated before the water gets heated. This could have extended the boiling temperature of the material and as a result extended water collection to higher temperature. Hence, it was established that sludge with more dispersed water phase gives higher energy efficiency for removal of bound water through boiling.

### Example 4

### Removal of Water from Furnace Oil Sludge Containing Varying Wt. % Water by Boiling

Experiments were carried out to evaluate the process of boiling for removal of water from Furnace oil sludge. Different proportions of Furnace oil and Water were mixed in High Shear Mixer with water content varying as 2, 10, 35, 50 and 65 wt. %.

Predetermined amount of Furnace oil sludge was taken in an RB flask of a Dean & Stark Apparatus followed by continuous heating thereof in the mantle heater, while continuously monitoring the temperature of the material in the RB flask with a digital thermometer. The rate of heating was kept rapid till boiling point of the material, thereafter the rate of heating was reduced to a desired level. The vapours of Water and Hydrocarbons were collected in the receiver after condensing them with circulating cold water at 5-6° C. in an insulated condenser. The condensates were collected in a separating flask using a stop cork at the bottom of the receiver, at predefined temperatures. After phase separation was achieved in the separating flask, hydrocarbons and water were individually weighed each time. The procedure was followed till the temperature of material reached 205° C., after which the mantle heater was switched off. Finally, the water and hydrocarbon samples retrieved were analysed quantitatively using mass balance study.

TABLE 4.1
REMOVAL OF WATER FROM FURNACE OIL SLUDGE WITH DIFFERENT
WATER CONTENT VARYING FROM 2 WT. %-65 WT. %

| Sl. No. | PARTICULARS | TEST 1 | TEST 2 | TEST 3 | TEST 4 | TEST 5 |
|---|---|---|---|---|---|---|
| 1 | Wt. of Sludge taken (g) | 901.37 | 900.36 | 901.88 | 900.66 | 903.13 |
| 2 | Wt. % Water in Sludge as determined by | 2.03 | 9.81 | 34.80 | 49.75 | 65.63 |
| | BTX | | | | | |
| 3 | Boiling point (° C.) (as observed from fumes | 139.2 | 99.8 | 96.4 | 94.8 | 88.8 |
| | in the receiver) | | | | | |
| 4 | Temperature (° C.) | | 107.0 | 107.2 | 107.0 | 106.9 |
| 5 | Wt. % Water Collected upto above | — | 6.16 | 72.37 | 69.93 | 42.37 |
| | Temperature | | | | | |
| 6 | Wt. of Hydrocarbons Collected upto above | — | 4.84 | — | 16.02 | 11.54 |
| | Temperature (g) | | | | | |
| 7 | Rate of Water Collected upto above | — | 2.94 | 2.17 | 1.84 | 1.05 |
| | Temperature (g/min) | | | | | |
| 8 | Temperature (° C.) | | 112 | 112 | 112 | 111.4 |
| 9 | Wt. % Water Collected upto above | — | 44.34 | 74.42 | 76.03 | 52.82 |
| | Temperature | | | | | |
| 10 | Wt. of Hydrocarbons Collected upto above | — | 5.46 | 12.61 | 17.04 | 13.85 |
| | Temperature (g) | | | | | |
| 11 | Rate of Water Collected upto above | — | 1.52 | 2.12 | 1.81 | 1.03 |
| | Temperature (g/min) | | | | | |
| 12 | Temperature (° C.) | | 126 | 127 | 126.9 | 126.1 |
| 13 | Wt. % Water Collected upto above | — | 51.09 | 88.49 | 89.94 | 89.53 |
| | Temperature | | | | | |
| 14 | Wt. of Hydrocarbons Collected upto above | — | 6.53 | 15.62 | 19.57 | 19.76 |
| | Temperature (g) | | | | | |
| 15 | Rate of Water Collected upto above | — | 1.11 | 1.98 | 1.75 | 0.96 |
| | Temperature (g/min) | | | | | |
| 16 | Temperature (° C.) | 160 | 152.1 | 152.3 | 152.1 | 152 |
| 17 | Wt. % Water Collected upto above | 34.80 | 80.02 | 93.49 | 95.53 | 91.07 |
| | Temperature | | | | | |
| 18 | Wt. of Hydrocarbons Collected upto above | 3.7 | 11.28 | 17.17 | 21.09 | 20.07 |
| | Temperature (g) | | | | | |
| 19 | Rate of Water Collected upto above | 0.30 | 0.83 | 1.78 | 1.62 | 0.91 |
| | Temperature (g/min) | | | | | |
| 20 | Temperature (° C.) | 205.1 | 205 | 206.5 | 205.3 | |
| 21 | Wt. % Water Collected upto above | 69.59 | 89.69 | 96.26 | 97.50 | — |
| | Temperature | | | | | |
| 22 | Rate of Water Collected upto above | 0.11 | 0.46 | 1.43 | 1.41 | — |
| | Temperature (g/min) | | | | | |
| 23 | Wt. of Hydrocarbons Collected upto | 6.95 | 13.72 | 18.87 | 22.31 | 20.18 |
| | above Temperature (g) | | | | | |
| 24 | Total Wt. % of Water Collected | 72.54 | 89.74 | 96.73 | 97.52 | 91.69 |
| 25 | Total Wt. % of Water Recovered | 72.54 | 89.74 | 96.73 | 98.28 | 100.39 |
| | (inclusive water adherings) | | | | | |
| 26 | Total Wt. % of Hydrocarbons Collected | 0.80 | 1.69 | 3.21 | 4.93 | 6.50 |
| 27 | Overall Rate of Water Collection (g/min) | 0.19 | 1.15 | 1.92 | 1.69 | 0.97 |
| 28 | Wt. % Loss due to Evaporation | 0.19 | 0.16 | 0.20 | 1.01 | 0.43 |
| 29 | Residual Water Present in left over | 348 | 333 | 347 | 551 | 653 |
| | Hydrocarbons as determined by BTX | | | | | |
| | (PPM) | | | | | |

It was observed that though the time taken to reach boiling point was more or less the same, the boiling point of the material increased from 88° C. to 139.2° C. with decrease in water content from 65 wt. % to 2 wt. %. Particularly, for lower water percentage the water collection was started at higher temperature.

The overall rate of water collection peaked for 35% sludge when comparing with other sludges. The percentage water removal at 107° C. temperature peaks for 35% water sludge, and thereafter for temperature peaks for 50% water was noted. Although, at temperature of 126° C., the water collection % was around 89% for 35%, 50%, 65% Sludge. When comparing individual collection, initially at 107° C., the rate of water collection was highest for 10% sludge and falls down with higher water %. As the water percentage decreased in sludge, the rate of water removal peaked for the initial 35% water content sludge. At around 10% water percentage in sludge the rate of water collection was observed to be highest. This was seen at 107° C. for 10% sludge, and at 112° C. for 35% sludge, which had overall around 10% water left in the material at that instance.

Total water collected was increased from 72.71 wt. % to 97.52% with increase in bound water from 2 wt. % to 50 wt. %, expect for the case of 65 wt. % bound water, where the total wt. % of water collected was 91.69%. Although after adding the water collected as sticking to additional flask, the percentage recovery of water was found out to be 100.39%. This could be probably due to the reason that since 65% was not a stable emulsion and the water was not homogeneous in the sludge resulting in extra water being poured into the material taken for experiment. Also due to additional free or unbound water in the sludge, the water while boiling formed larger droplets in the sludge and observed to pool together at the bottom of the RB flask. Since heat was not appropriated uniformly for the mixture, the water found the only root of escape and bumped along with the viscous furnace oil above it, which resulted in heavy adherings to the additional flask.

Further, the amount of hydrocarbons collected was found to be increased with increase in water content in sludge from 2 wt. % to 50 wt. %. This was because, as more amount of water was boiling out, more of light hydrocarbons got stripped. But the final amount of hydrocarbons collected was slightly less for 65 wt. % than that of 50 wt. % because, 50 wt. % sludge had uniformly distributed water droplets and so the hydrocarbons collected was also increasing maintaining the trend. However, for 65 wt. % sludge, the escape root for water vapours was found to be changed because of pool formation in the bottom of the RB, by bumping viscous hydrocarbon layer over that in turn reduced the stream stripping effect. The amount of hydrocarbons collected was dependent on uniform dispersion and also on holding time at a temperature. It was established that, if holding time is more, more of light hydrocarbons could be collected at lower temperatures only. The recovery in 2% sludge was less although the remaining water percentage evaluated by BTX was same as other cases, due to lower overall amount of water present in the material.

### Example 5

### Removal of Water from Different Types of Sludges and Emulsions Through Application of Heat Alone, with View to Retrieve Hydrocarbons Present Therein

Experiments were conducted to evaluate the efficacy of boiling in removal of bound and unbound water from various sludges, particularly Furnace oil sludge with and without Sodium Chloride (SALT)/Sodium Lauryl Sulphate (SLS), Diesel sludge and ONGC Sludge and fractions of sludge extracted after pre-treatment in centrifuge, with differing amount of bound water present within.

Accordingly, predetermined amounts of sludge was taken in an RB flask of a Dean and Stark Apparatus followed by continuous heating thereof in the mantle heater, while continuously monitoring the temperature of material in RB flask with a digital thermometer. The rate of heating was kept rapid till boiling point of material, thereafter the rate of heating was controlled to give a lower condensation rate and also such that the rate was just enough to avoid vapour entrapment in the condenser. The vapours of bound water and hydrocarbons were collected in the receiver after condensing them with circulating cold water at 5-6° C. in an insulated condenser. The condensates were taken out and collected in separating flask using a stop cork at the bottom of the receiver. After phase separation was achieved in the separating flask, hydrocarbons and water were individually weighed each time. The procedure was followed till the temperature of material reached 205/240° C., after which the mantle heater was switched off. In an alternate experimental setup, a foam breaker was installed as described in FIG. 6 for boiling of Furnace oil Sludge with SLS at higher heating rate. Finally, the retrieved hydrocarbons were analysed qualitatively for calorific value by Bomb Calorimeter.

TABLE 5.1
BOILING OF DIFFERENT SLUDGES

| | | Test 1 | Test 2A | Test 2B | Test 3 | |
|---|---|---|---|---|---|---|
| | | FURNACE OIL SLUDGE | | | | |
| | | | | With SLS | | Test 4 |
| Sl. | | | With | & foam | With | Diesel |
| No. | PARTICULARS | — | SLS | breaker | Salt | Sludge |
| 1 | Wt. of Sludge taken (g) | 900.6 | 901.57 | 901.52 | 900.95 | 901.11 |
| 2 | Wt. % Water Present in Sludge | 49.7495 | 46.4764 | 46.4564 | 49.8968 | 48.3400 |
| 3 | Wt. % of Sodium Laurel | — | 2.50 | 2.50 | 1.96* | 2.44* |
| | Sulphate/Sodium Chloride* Present | | | | | |
| | in above Sludge | | | | | |
| 4 | Preheating | No | No | No | No | No |
| 5 | Boiling Temperature of material (as | 94.8 | 96.2 | 96.2 | 95.6 | 96.9 |
| | observed from fumes in the | | | | | |
| | receiver) (° C.) | | | | | |
| 6 | Temperature at First Collection | 97.5 | 96.6 | 96.5 | 100.1 | 96.8 |
| | (~30 g) (° C.) | | | | | |
| 7 | Low Temperature I (° C.) | 107 | 102.1 | 107 | 107 | 107 |
| 8 | Wt. % Water Collected upto above | 69.94 | 87.73 | 93.85 | 35.45 | 73.30 |
| | Temperature | | | | | |
| 9 | Wt. % Hydrocarbons Collected | 3.54 | 2.71 | 4.07 | 2.06 | 17.30 |
| | upto above Temperature | | | | | |
| 10 | Rate of Water Collection upto | 1.84 | 1.55 | 4.44 | 1.21 | 1.52 |
| | above Temperature (g/min) | | | | | |
| 11 | Low Temperature II (° C.) | 112 | 112 | 112 | 112 | 112 |
| 12 | Wt. % Water Collected upto above | 76.04 | 90.08 | 94.96 | 68.97 | 76.31 |
| | Temperature (g/min) | | | | | |
| 13 | Wt. % Hydrocarbons Collected | 3.77 | 2.84 | 4.21 | 3.23 | 18.00 |
| | upto above Temperature | | | | | |
| 14 | Rate of Water Collection upto | 1.81 | 1.53 | 4.34 | 1.27 | 1.50 |
| | above Temperature (g/min) | | | | | |
| 15 | High Temperature I (° C.) | 152 | 159.7 | 152.3 | 153.1 | 152 |
| 16 | Wt. % Water Collected upto above | 95.53 | 95.18 | 98.72 | 96.44 | 95.49 |
| | Temperature (g/min) | | | | | |
| 17 | Wt. % Hydrocarbons Collected | 4.65 | 3.13 | 4.73 | 4.48 | 22.12 |
| | upto above Temperature (g/min) | | | | | |
| 18 | Rate of Water Collection upto | 1.62 | 1.34 | 3.68 | 1.15 | 1.38 |
| | above Temperature (g/min) | | | | | |
| 19 | High Temperature II (° C.) | 177 | — | 177 | 177.7 | 172 |
| 20 | Wt. % Water Collected upto above | 97.13 | — | 99.09 | 96.81 | 97.84 |
| | Temperature (g/min) | | | | | |
| 21 | Wt. % Hydrocarbons Collected | 4.84 | — | 4.79 | 4.50 | 24.49 |
| | upto above Temperature (g/min) | | | | | |
| 22 | Rate of Water Collection above | 1.52 | — | 3.50 | 1.08 | 1.31 |
| | Temperature (g/min) | | | | | |
| 23 | High Temperature III (° C.) | 205 | — | — | 205.2 | 205 |
| 24 | Wt. % Water Collected upto above | 97.50 | — | — | 97.16 | — |
| | Temperature | | | | | |
| 25 | Wt. % Hydrocarbons Collected | 4.93 | — | — | 4.51 | — |
| | upto above Temperature | | | | | |
| 26 | Rate of Water Collection upto | 1.41 | — | — | 0.98 | — |
| | above Temperature (g/min) | | | | | |
| 27 | Total Wt. % of Water Collected | 97.53 | 95.18 | 99.09 | 97.16 | 97.84 |
| 28 | Average Rate of Water Collection | 1.41 | 1.34 | 3.50 | 0.98 | 1.30 |
| | (g/min) | | | | | |
| 29 | Total Wt. % of Hydrocarbons | 4.93 | 3.13 | 4.79 | 4.51 | 24.49 |
| | Collected | | | | | |
| 31 | Residual Water Present in left | 551 | 1412 | 253 | 649 | 547 |
| | over Hydrocarbons as determined | | | | | |
| | by BTX Test (PPM) | | | | | |
| 32 | Calorific Value of Sludge taken | 4,891 | 4,891 | 4,891 | 4,891 | 10,826 |
| | (kcal/kg) | | | | | |
| 33 | Calorific Value of condensate | 10,612 | 10,662 | — | 10,611 | 10,787 |
| | Hydrocarbons (kcal/kg) | | | | | |

TABLE 5.2
REMOVAL OF BOUND AND UNBOUND WATER FROM ONGC SLUDGES AND
VARIOUS FRACTIONS OBTAINED AFTER CENTRIFUGE OF ONGC SLUDGE

| | | | Test 6 | |
|---|---|---|---|---|
| | | | Medium | Test 7 |
| | | Test 5 | Viscous | Viscous |
| Sl. | | ONGC | Hydro | Hydro |
| No. | PARTICULARS | Sludge | carbons | carbons |
| 1 | Wt. of Sludge taken (g) | 901.85 | 900.79 | 901.82 |
| 2 | Wt. % Water present in Sludge as | 45.7909 | 42.3074 | 37.3838 |
| | determined by BTX | | | |
| 3 | Preheating | No | No | No |
| 4 | Boiling Temperature of material (° C.) (as | 95.2 | 83.6 | 97.2 |
| | observed from fumes in the receiver) | | | |
| 5 | Low Temperature I (° C.) | 107 | 107 | 107 |
| 6 | Wt. % Water Collected upto above | 58.60 | 60.37 | 60.15 |
| | Temperature | | | |
| 7 | Wt. % Hydrocarbons Collected upto above | 5.26 | 5.33 | 3.32 |
| | Temperature | | | |
| 8 | Rate of Water Collection upto above | 2.01 | 1.13 | 1.36 |
| | Temperature (g/min) | | | |
| 9 | Low Temperature II (° C.) | 112 | 112 | 112 |
| 10 | Wt. % Water Collected upto above | 72.16 | 82.73 | 68.09 |
| | Temperature | | | |
| 11 | Wt. % Hydrocarbons Collected upto above | 5.82 | 6.15 | 3.62 |
| | Temperature | | | |
| 12 | Rate of Water Collection upto above | 2.01 | 1.10 | 1.33 |
| | Temperature (g/min) | | | |
| 13 | High Temperature I (° C.) | 177 | 177 | 177 |
| 14 | Wt. % Water Collected upto above | 97.41 | 97.33 | 94.06 |
| | Temperature | | | |
| 15 | Wt. % Hydrocarbons Collected upto above | 7.40 | 6.98 | 5.07 |
| | Temperature | | | |
| 16 | Rate of Water Collection upto above | 1.65 | 0.88 | 0.94 |
| | Temperature (g/min) | | | |
| 17 | High Temperature II (° C.) | 205 | 205 | 205 |
| 18 | Wt. % Water Collected upto above | 97.79 | — | 95.64 |
| | Temperature | | | |
| 19 | Wt. % Hydrocarbons Collected upto above | 7.46 | — | 5.20 |
| | Temperature | | | |
| 20 | Rate of Water Collection upto above | 1.52 | — | 0.90 |
| | Temperature (g/min) | | | |
| 21 | High Temperature III (° C.) | — | — | 240 |
| 22 | Wt. % Water Collected upto above | — | — | 97.74 |
| | Temperature | | | |
| 23 | Wt. % Hydrocarbons Collected upto above | — | — | 5.42 |
| | Temperature | | | |
| 24 | Rate of Water Collection upto above | — | — | 0.77 |
| | Temperature (g/min) | | | |
| 25 | Total Wt. % of Water Collected | 97.79 | 97.33 | 97.74 |
| 26 | Average Rate of Water Collection (g/min) | 1.52 | 0.88 | 0.77 |
| 27 | Wt. % of Hydrocarbons Collected | 7.46 | 6.98 | 5.27 |
| 28 | Average Rate of Hydrocarbons Collection | 0.14 | 0.09 | 0.07 |
| | (g/min) | | | |
| 29 | Residual Water Present in left over | 568 | 791 | 555 |
| | Furnace Oil as determined by BTX Test | | | |
| | (PPM) | | | |
| 30 | Calorific Value of Sludge (kcal/kg) | 5,243 | 5,415 | 3,003 |
| 31 | Calorific Value of condensate | — | 10,958 | 10,970 |
| | Hydrocarbons (kcal/kg) | | | |
| 32 | Calorific Value of Residual | — | 9,817 | 5,513 |
| | Hydrocarbons (kcal/kg) | | | |

It was observed, when comparing boiling characteristics of Furnace oil sludge with and without salts, the first collection of water (about 30 g) was achieved at 97.5° C. for Furnace oil sludge, while higher boiling temperature was observed for Furnace oil sludge with salt (Sodium Chloride) giving 1st collection at 100.1° C. Similarly the % water collection at low temperature of 107° C. was 69.9% of for Furnace Oil Sludge and mere 35.5% for Furnace Oil with Salt. This was probably caused due to elevation of boiling point caused with dissolved salt in Furnace oil sludge. Further, it was observed that at higher temperature the % water collection was comparable for furnace oil sludge with salt with the case where no salt was present and observed to be about 97% for both cases. As the boiling progressed, less and less amount of water was left in the sludge, resulting in super saturation and finally precipitation of salt at bottom. This was observed to obviate the elevation of boiling point effect caused by salt giving similar boiling points when compared to furnace oil sludge.

For furnace oil with SLS collection, a low temperature 102° C. was observed to be 87.7%. It was observed that it was due to presence of high foaming in Furnace oil Sludge with SLS that amount of water collected at a lower temperature was higher. Foams provided an efficient heating surface for droplets of water dispersed as bound water in the hydrocarbons. These fine droplets found it easier to vaporize and escape through the foamy layer of hydrocarbons, where escape root are easily available. Therefore more water was collected at lower temperature, without the need to superheat or over pressurize the sludge.

While for the case of Furnace oil sludge with SLS, the rate for collection of water drastically slowed down at around 122° C. and the collection was stopped by 159° C. It was observed that as the temperature increased the foaming halted probably due to lower heating rate given. Consequently, water collection also stopped leading to premature termination of experiment.

Further, it was observed when the experiment in Test 2 was repeated with foam breaker and at higher heat rate in Test 2b, even more amount material was collected at lower temperature. It was observed that at low temperature the 93.85% water was recovered, and by maximum temperature of 179.2° C. due continuation of foaming more than 99% of water was recovered. As a result of higher heating rate, total time required for the experiment was nearly halved. More volume of foaming meant more heating surface area for the water to evaporate and escape, thus high rate of water collection was maintained and while presence of foam breaker avoided the condition of excessive foaming, that resulted in adulteration of water collected with oil.

Further, it was observed that for Diesel sludge, the 1^{st} collection of water was 96.9° C., and at low temperature of 107° C., 73.30% of water had been removed. Although, due to diesel being comparatively of lower boiling range than Furnace oil, 17.30% of diesel was also collected at the same temperature. After about 132° C. most of the water (95.1%) from diesel was separated and the maximum temperature for boiling was observed to be 172° C. at which the total % water removed from sludge was 97.84%. Also due to lower boiling point range of diesel, 24.49% of oil was removed from the sludge compared to about 4% separation in all the furnace oil cases.

Further, it was observed for ONGC sludge and, Medium Viscous oil that the total water separated was comparable with Furnace oil sludge at about 97% while for Viscous Hydrocarbons, which is more recalcitrant and viscous than any other sludge, the total water removed was 97.74%. The initial water removed at a low temperature 107° C. for all three ONGC sludges was in the range of 58-60%, although at next low temperature of 112° C. the differences became apparent as the rate of water collection slowed down for Viscous Hydrocarbons. No water collection for Medium Viscous Oil was observed after 177° C., and for ONGC sludge after 205° C., but the collection continued for Viscous Hydrocarbons up-to 240° C., probably due to very high viscosity of viscous hydrocarbons, which kept water trapped and harder to separate at lower temperatures.

### Example 6

### Effect of Rate of Heating on Bound Water Removal from Furnace Oil Sludge 50 Wt. % Bound Water by Varying Heat Rates Before and after Boiling Point

Experiments were conducted to better understand the effect of rate of heating on bound water removal from furnace oil sludge with 50 wt. % bound water. Accordingly, the predetermined weights of furnace oil sludge was taken in an RB flask of a Dean & Stark Apparatus subjecting it to varied heating rates in a mantle heater and continuously monitoring the temperature of the material in the RB flask. In one set of experiments, initial rate of heating was rapid, where the mantle heating position was set to 80% until boiling point was reached and as soon as boiling was observed, rate of heating was reduced by changing mantle heating positions to 18.5% and 30%.

In another experiment, initial heat rates were varied, while the sludge was homogenized by manually shaking till temperature of the material reached 80° C. after which gradually heat rate was increased to 18% in mantle. In another Experiment, the apparatus discussed in FIG. 5 was used, and the maximum heating rate was given from the beginning. The vapors of bound water and Hydrocarbons were collected in the receiver after condensing them with circulating cold water at 5-6° C. in an insulated condenser. The condensates were taken out and collected in separating flask using a stop cork at the bottom of the receiver. After phase separation was achieved in the separating flask the Hydrocarbons and water were individually weighed each time. The procedure was followed till the temperature of material reached 205° C., after which the mantle heater was switched off.

TABLE 6.1
REMOVAL OF BOUND WATER FROM FURNACE OIL
SLUDGE BY BOILING WITH DIFFFERENT RATE OF HEATING

| Sl. | | | | | |
|---|---|---|---|---|---|
| No. | PARTICULARS | TEST 1 | TEST 2 | TEST 3 | TEST 4 |
| 1 | Mantle Heater set Point | 80 & 18.5 | 80 & 30 | (5, 10, 15) & | 100 & 100 |
| | | | | 18.5 | |
| 2 | Wt. of Sludge taken (g) | 900.60 | 902.85 | 900.37 | 901.33 |
| 3 | Wt. % Water Present in Sludge | 49.7495 | 49.6205 | 49.5540 | 49.7495 |
| 4 | Wt. of Water Present in the Sludge (g) | 448.04 | 448.00 | 446.17 | 448.41 |
| 5 | Wt. of Oil Present in Sludge (g) | 452.56 | 454.85 | 454.20 | 452.92 |
| 6 | Preheating | No | No | Yes | No |
| 7 | Initial set Point of Mantle Heater | 80.00 | 80.00 | 5, 10, 15 | 100 |
| 8 | During Boiling set Point of Mantle Heater | 18.50 | 30.00 | 18.50 | 100 |
| 9 | Observed Boiling Point (° C.) (as seen from | 94.80 | 77.20 | 101.70 | 71.2 |
| | fumes in the receiver) | | | | |
| 10 | Vapor Temperature (° C.) | 96.0 | 95.1 | — | 94.9 |
| 11 | Time taken to Reach Boiling Point (min) | 16.00 | 12.00 | 59.25 | 9.31 |
| 12 | Low Temperature (° C.) | 101 | 101 | 104.9 | 101 |
| 13 | Wt. % of Water collected up to above | 35.16 | 70.30 | 8.69 | 84.93 |
| | Temperature | | | | |
| 14 | Maximum temperature | 205.30 | 207.60 | 201.10 | 205.5 |
| 15 | Total Wt. % of Water Collected | 97.53 | 96.15 | 97.93 | 99.45 |
| 16 | Total Wt. % of Oil Collected | 4.93 | 3.86 | 5.11 | 3.73 |
| 17 | Wt. % Loss as adherings to various | 0.92 | 1.82 | 1.12 | 2.65 |
| | surfaces | | | | |
| 18 | Wt. % Loss as Evaporation, spillage etc. | 1.01 | 0.41 | 1.12 | 0.23 |
| 19 | Residual Water Present in left over | 551 | 193 | 95 | 65 |
| | Furnace Oil as determined by BTX Test | | | | |
| | (PPM) | | | | |

TABLE 6.2
RATE OF WATER COLLECTED (g/min) & CUMULATIVE Wt. % OF WATER
CUMULATIVE Wt. % OF WATER COLLECTED WITH TEMPERATURE (° C.)
FOR BOILING OF FURNACE OIL SLUDGE AT DIFFERENT HEAT RATES

| | Test 1 | | Test 2 | | Test 3 | |
|---|---|---|---|---|---|---|
| | | Water | | Water | | Water |
| | Wt. % | Collection | Wt. % | Collection | Wt. % | Collection |
| Temperature | Water | Rate | Water | Rate | Water | Rate |
| (° C.) | Collected | (g/min) | Collected | (g/min) | Collected | (g/min) |
| 107 | 69.94 | 1.84 | 78.35 | 2.53 | 8.63 | 1.32 |
| 112 | 76.04 | 1.56 | 78.82 | 0.82 | 40.78 | 1.54 |
| 117 | 81.82 | 1.55 | 79.38 | 1.02 | 69.92 | 1.39 |
| 122 | 87.03 | 1.54 | 80.45 | 1.50 | 81.42 | 1.36 |
| 126 | 89.94 | 1.25 | 88.05 | 2.36 | 87.82 | 1.10 |
| 132 | 92.15 | 1.05 | 90.25 | 1.50 | 91.93 | 1.11 |
| 152 | 95.53 | 0.63 | 94.16 | 1.14 | 95.70 | 0.66 |
| 172 | 97.13 | 0.32 | 95.26 | 0.45 | 97.16 | 0.35 |
| 205 | 97.50 | 0.07 | 95.55 | 0.09 | 97.72 | 0.24 |

Referring to graph in FIG. 12, more than 97% water was collected during the experiment from 900 g of sludge with 50% water content. The BTX results indicated substantially low values of residual water content for homogenized sludge and sludge subjected to higher rate of heating 95 ppm and 193 ppm respectively. Sludge with moderate rate of heating had slightly residual water close to 551 ppm.

Boiling point observed for Test 2 and Test 4 with rapid heating rate 77° C. and 71° C., with slow heating it was 94° C., while for preheating it was 101.7° C. The lower observed boiling point could be because of temperature equilibration in the material. But vapour temperature in all the cases was almost same. As pre-heating and homogenization was not undertaken, the temperature of the sludge was not uniform. Although, it was further observed that the once boiling commenced, the time taken for initial collection of condensate was equivalent. It was observed that as water rich sludge overheated near the heating surfaces, it started to foam and induced convective currents throughout the material, subsequently homogenizing the temperature.

Initial rate of water collection was expectedly faster for sludge with higher rate of heating. However, after the initial fast rate, rate of collection dropped for higher heat rate between 107° C. to 117° C. Within a few degrees change close to the boiling, huge fraction of water was collected. This collection was accompanied by foam buildup which removed even more water. Foam based expansion lasted for a shorter temperature range, which meant finer droplets with slightly raised boiling point had to blast their way out of the sludge. It was observed that after 117° C., the frequency of explosive discharge was increased sharply and a lot of water was again collected without much rise in temperature. Rate of water collection rose to 1.50 g/min and 2.36 g/min at 122° C. and 126° C. respectively. Rate of collection remained similar for all three experiments from 126° C. It was observed from test 4 that lot more water can be collected by rapidly heating the sludge provided the condenser has a capacity to withstand the increase in demand.

### Example 7

### Removal of Bound Water Through Boiling Using Rotary Evaporator and Comparing its Efficacy with Dean and Stark Apparatus

Experiments were conducted to evaluate the efficacy of boiling in removal of bound water from Furnace Oil Sludge containing 50 wt. % water using Rotavapor as an apparatus and comparing the efficiency and feasibility with a Dean and Stark Apparatus, preferably as a stationary heater.

Accordingly, predetermined amount of furnace oil sludge was taken in an evaporating flask of Rotary Evaporator followed by continuous heating in an oil bath accompanied by continuous rotation at a fixed RPM, while monitoring the temperature of the material and vapors with a digital thermometer. The oil bath was set to a desired maximum temperature. The vapors of water and Hydrocarbons were collected in the collecting flask after condensing them in an insulated condenser by circulating cold water at 5-6° C. The process was continued till maximum desired temperature was reached and the liquid collection had halted. After the experiment, the condensate collected in the collecting flask was allowed to cool down and transferred to a separating flask. After phase separation was achieved in the separating flask, oil and water were individually weighed. Finally, the water and hydrocarbon samples retrieved were analyzed quantitatively using mass balance study.

Accordingly, for the experiments in Dean and Stark apparatus, where no preheating was carried, predetermined amount of Furnace Oil Sludge was taken in an RB flask of a Dean and Stark Apparatus followed by continuous heating thereof in the mantle heater, while continuously monitoring the temperature of the material in the RB flask with a digital thermometer. The rate of heating was kept rapid till the boiling point of material, thereafter the rate of heating was controlled to give a lower condensation rate such that the rate was sufficient enough to avoid vapour entrapment in the condenser. The vapours of bound water and hydrocarbons were collected in the receiver after condensing them in an insulated condenser with circulating cold water at 5-6° C. The condensates were taken out and collected in separating funnel using a stop cork at the bottom of the receiver. After phase separation was achieved in the separating flask, hydrocarbons and water were individually weighed each time. The procedure was followed till the temperature of material reached 205° C., after which the mantle heater was switched off. Finally, the water and hydrocarbon samples retrieved were analyzed quantitatively using mass balance study.

Accordingly, for the experiments in Dean and Stark apparatus wherein preheating was carried, predetermined amount of Furnace oil sludge was taken in an RB flask for preheating step before boiling the sludge sample. Accordingly, the mantle heater was heated over short spans of time to quickly establish uniform temperature within the mass of sludge taken, while in between these heating cycles, the RB flask was removed from mantle heater and sludge inside was thoroughly mixed by vigorously shaking the RB flask from outside. The lid was periodically opened to release pressure built up because of water vapour release from the sludge on account of vigorous shaking of the RB flask. This was repeated till temperature of sludge reached above 80° C.

Thereafter, the RB flask was transferred to a Dean and Stark Apparatus followed by continuous heating thereof in the mantle heater, while continuously monitoring the temperature of the material in the RB flask with a digital thermometer. The rate of heating was kept rapid till the material temperature rose to 90° C., thereafter the rate of heating was controlled to give a lower condensation rate such that the rate was just enough to avoid vapour entrapment in the condenser. The vapours of bound water and oil were collected in the receiver after condensing them in an insulated condenser with circulation of cold water at 5-6° C. The condensates were taken out and collected in a separating flask using a stop cork at the bottom of the receiver. After phase separation was achieved in the separating flask, oil and water were individually weighed each time. The procedure was followed till the temperature of material reached 205° C., after which the mantle heater was switched off. Finally, the water and hydrocarbon samples retrieved were analysed quantitatively using mass balance study.

TABLE 7.1
REMOVAL OF BOUND WATER BY BOILING IN ROTAVAPOUR

| Sl. No. | PARTICULARS | TEST 1 | TEST 2 | TEST 3 | TEST 4 | TEST 5 |
|---|---|---|---|---|---|---|
| 1 | Wt. of Furnace Oil Sludge taken (g) | 601.52 | 401.73 | 603.1 | 601.26 | 600.44 |
| 2 | Wt. % of Water present in above Sludge | 49.9850 | 49.8276 | 49.8276 | 49.8276 | 49.8276 |
| 3 | Capacity of Evaporating flask (L) | 2.00 | 1.00 | 2.00 | 2.00 | 2.00 |
| 4 | Set Temperature of Heating Oil Bath (° C.) | 107 | 107 | 117 | 127 | 127 |
| 5 | Rotation Speed (RPM) | 150 | 150 | 150 | 150 | 95 |
| 6 | Minimum Liquid Temperature at which | 99.20 | 99.50 | 98.30 | 97.70 | 98.10 |
| | Condensation Observed (° C.) | | | | | |
| 7 | Maximum Liquid Temperature during | 105.20 | 103.50 | 116.30 | 125.70 | 124.60 |
| | Boiling (° C.) | | | | | |
| 8 | Wt. % of Water Collected | 92.88 | 80.21 | 94.48 | 96.73 | 89.76 |
| 9 | Wt. % of Hydrocarbons Collected | 3.50 | 3.41 | 3.35 | 3.45 | 3.05 |
| 10 | Wt. % Loss due to Evaporation | 0.54 | 1.67 | 1.38 | 0.62 | 0.18 |
| 11 | Time taken to reach Boiling point from | 11.57 | 51.93 | 6.7 | 4.1 | 3.28 |
| | the start of Experiment (min) | | | | | |
| 12 | Wt. % of Water left over in the Residual | 4.56 | 13.99 | 2.68 | 1.33 | 8.48 |
| | Matter of Evaporating flask determined | | | | | |
| | by BTX | | | | | |

TABLE 7.2
REMOVAL OF BOUND WATER BY BOILING
IN DEAN AND STARK APPARATUS

| Sl. No. | PARTICULARS | TEST 1 | TEST 2 |
|---|---|---|---|
| 1 | Wt. of Sludge taken (g) | 602.60 | 601.88 |
| 2 | Wt. % Water Present in above Sludge | 49.9389 | 49.554 |
| 3 | Preheating | No | Yes |
| 4 | Boiling Point (° C.) (as observed from fumes in the | 78.69 | 104.39 |
| | receiver) | | |
| 5 | Low Temperature I (° C.) | 105.08 | 105.27 |
| 6 | Wt. % Water Collected upto above Temperature | 88.45 | 0.58 |
| 7 | Wt. % Hydrocarbons Collected upto above Temperature | 2.74 | 0.26 |
| 8 | Rate of Water Collection upto above Temperature | 1.46 | 0.41 |
| | (g/min) | | |
| 9 | Low Temperature II (° C.) | 116.17 | 114.99 |
| 10 | Wt. % Water Collected upto above Temperature | 92.33 | 26.13 |
| 11 | Wt. % Hydrocarbons Collected upto above Temperature | 2.81 | 2.15 |
| 12 | Rate of Water Collection upto above Temperature | 1.49 | 1.11 |
| | (g/min) | | |
| 13 | High Temperature I (° C.) | 123.72 | 123.62 |
| 14 | Wt. % Water Collected upto above Temperature | 93.43 | 76.87 |
| 15 | Wt. % Hydrocarbons Collected upto above Temperature | 2.83 | 4.21 |
| 16 | Rate of Water Collection upto above Temperature | 1.46 | 1.10 |
| | (g/min) | | |
| 17 | Total Wt. % of Water Collected | 97.96 | 93.21 |
| 18 | Total Wt. % of Hydrocarbons Collected | 3.11 | 4.91 |
| 19 | Wt. % Loss due to Evaporation | 0.55 | 0.59 |
| 20 | Total Time taken for the Process (Hrs.) | 5.05 | 6.82 |
| 21 | Residual Water Present in left over Furnace Oil as | 787 | 245 |
| | determined by BTX Test (PPM) | | |

It was observed that boiling the sludge in Rotary evaporator was efficient in the sense that more amount of water collection was possible at a lower temperature when compared to Dean and Stark Apparatus. From Table 7.1, it was observed that most of the water in the sludge, for example about 92.88% water was removed by 105.20° C., whereas further increase in temperature to 116.30° C. gave water removal of only 94.48% and still further 10° C. rise to 125.70° C. gave water removal of 96.73%.

Further, it was observed that decreasing the RPM from 150 RPM to 95 RPM at around 125° C. reduced the efficacy, giving only 89.76% water removal. It was also observed that by changing and reducing the vessel size to a smaller vessel the water collection dropped down from 92.88% to 80.21%. This was believed to be probably because of lower surface area for heating available in 1 L evaporating flask than in 2 L evaporating flask. It was further observed that the time taken to reach boiling of liquid was rapid with Rotary evaporator and increased sharply with higher temperature difference (AT) and higher rotation of flask.

Further, it was observed from Table 7.2 that at temperature of about 105° C., the wt. % water removal was 88.45% for experiment in Dean and Stark without preheating and 0.58% with preheating as compared to 92.88% of rotary evaporator at similar temperature. Similarly at temperatures of about 115° C. and 124° C. the wt. % water removal was 92.33% and 93.43% respectively for experiment in Dean and Stark without preheating as compared to 94.48% and 96.73% respectively for experiment with preheating. For the instance of Rotavapor, it was observed that due to continuous rotation of evaporating flask the sludge formed a thin layer on the sides of the flask. This presented an easier path for the dispersed water droplets to escape, than from evaporation from bulk of sludge in RB flask. Thus more water was separated at lower temperature using Rotavapor boiling. Further, it was established that lower the RPM, lower may be the efficiency, as higher rotation enabled more uniform heat distribution in the sludge.

The downside of using a rotary evaporator was that the cost factors attached with operation and maintenance of rotary evaporator were higher than that of a stationary heater. Also rotational heaters were found difficult to handle and maintain than stationary heaters.

### Example 8

### Removal of Bound Water from Furnace Oil Sludge with 50 Wt. % Bound Water Using Different Heating Surfaces Such as Conical Flask & Round Bottom Flask in an Oil Bath

Experiments were carried out to evaluate the process of boiling in removal of bound water with different heating surfaces, particularly in a flat bottom conical flask and a round bottom flask. Accordingly, predefined amount of furnace oil sludge were weighed and taken in a RB flask or a Conical flask of a modified Dean and Stark apparatus. The flasks were immersed in oil bath such that in either flask, equal surface area of flask was in contact with the heating oil media. The material was heated continuously in the oil bath initially with bath temperature 130° C., followed by 150° C. and 170° C., ensuring that these changes were made at the same temperature intervals in all tests, while the temperature of oil bath and material were monitored continuously.

The vapors of bound water and hydrocarbon were collected in the receiver after condensing them with circulating cold water at 5-6° C. in the insulated condenser. The condensates were taken out and collected in separating funnel using a stop cork at the bottom of the receiver. After phase separation was achieved in the separating flask, hydrocarbons and water were individually weighed each time. This procedure was followed till the temperature of material reached 140/150° C., after which the oil bath was switched off.

TABLE 8.1
BOILING OF DIFFERENT AMOUNTS OF FURNACE
OIL SLUDGE USING CONICAL FLASK IN AN OIL BATH

| Sl. No. | PARTICULARS | TEST1 | TEST 2 | TEST3 |
|---|---|---|---|---|
| 1 | Wt. of Sludge taken (g) | 300.80 | 501.35 | 701.36 |
| 2 | Wt. % of Water present in Sludge | 49.62 | 49.62 | 49.62 |
| 3 | Wt. of Water present in the Sludge (g) | 149.26 | 248.77 | 348.02 |
| 4 | Wt. of Hydrocarbons present in Sludge (g) | 151.54 | 252.58 | 353.34 |
| 5 | Wt. % of Water Collected | 88.12 | 91.50 | 85.49 |
| 6 | Average Rate of Water Collection (g/min) | 2.05 | 2.74 | 3.45 |
| 7 | Wt. % Water Present in left over Furnace Oil as | 3.03 | 2.76 | 1.86 |
| | determined by BTX Test | | | |

TABLE 8.2
BOILING OF DIFFERENT AMOUNTS OF FURNACE OIL
SLUDGE USING ROUND BOTTOM FLASK IN AN OIL BATH

| Sl. No. | PARTICULARS | TEST 1 | TEST 2 | TEST 3 |
|---|---|---|---|---|
| 1 | Wt. of Sludge taken (g) | 301.52 | 500.14 | 700.42 |
| 2 | Wt. % Water Present in Sludge | 49.62 | 49.62 | 49.62 |
| 3 | Wt. of water Present in the Sludge (g) | 149.62 | 248.17 | 347.55 |
| 4 | Wt. of Oil Present in Sludge (g) | 151.90 | 251.97 | 352.87 |
| 5 | Wt. % of Water Collected | 72.95 | 85.10 | 88.11 |
| 6 | Average Rate of Water Collection (g/min) | 0.43 | 1.08 | 1.13 |
| 7 | Wt. % Residual Water Present in left over Furnace | 6.41 | 3.88 | 4.78 |
| | Oil as determined by BTX Test | | | |

TABLE 8.3
BOUND WATER REMOVAL IN CONICAL FLASK AND RB FLASK FOR 300 g OF
FURNACE OIL SLUDGE

| | 300 g | | | | | |
|---|---|---|---|---|---|---|
| | Conical flask | | | RB flask | | |
| | | Rate of | | | Rate of | |
| | | Water | Wt. % | | Water | Wt. % |
| | Temperature | Collection | Water | Temperature | Collection | Water |
| Sl. No. | (° C.) | (g/min) | Collected | (° C.) | (g/min) | Collected |
| 1 | 97.8 | 3.76 | 59.51 | 98.8 | 1.16 | 19.537 |
| 2 | 107.6 | 1.64 | 75.10 | 100.2 | 0.85 | 28.881 |
| 3 | 117.4 | 0.46 | 76.18 | 102.8 | 0.66 | 38.345 |
| 4 | 122 | 0.31 | 76.96 | 119.8 | 0.18 | 47.749 |
| 5 | 127 | 0.60 | 79.09 | 122.7 | 1.12 | 57.895 |
| 6 | 140.2 | 1.07 | 84.95 | 127.5 | 0.70 | 67.48 |
| 7 | 142.2 | 0.31 | 85.75 | 142.5 | 0.16 | 72.913 |

TABLE 8.4
BOUND WATER REMOVAL IN CONICAL FLASK AND RB FLASK FOR 500 g OF
FURNACE OIL SLUDGE

| | 500 g | | | | | |
|---|---|---|---|---|---|---|
| | Conical flask | | | RB flask | | |
| | | Rate of | | | Rate of | |
| | | Water | Wt. % | | Water | Wt. % |
| | Temperature | Collection | Water | Temperature | Collection | Water |
| Sl. No. | (° C.) | (g/min) | Collected | (° C.) | (g/min) | Collected |
| 1 | 102.4 | 3.67 | 57.52 | 97.90 | 2.35 | 12.51 |
| 2 | 107.1 | 2.21 | 63.43 | 98.10 | 2.02 | 24.66 |
| 3 | 112.5 | 1.48 | 66.41 | 98.50 | 1.74 | 36.17 |
| 4 | 117.3 | 1.26 | 67.93 | 101.50 | 1.39 | 48.27 |
| 5 | 122.8 | 1.25 | 69.69 | 117.00 | 0.46 | 54.54 |
| 6 | 128.2 | 1.89 | 71.38 | 122.00 | 0.78 | 61.28 |
| 7 | 132.1 | 3.09 | 72.87 | 126.00 | 1.21 | 73.85 |
| 8 | 136.5 | 2.28 | 84.51 | 132.00 | 0.76 | 81.28 |
| 9 | 153.5 | 1.74 | 91.08 | 152.00 | 0.39 | 85.03 |

TABLE 8.5
BOUND WATER REMOVAL IN CONICAL FLASK AND RB FLASK FOR 700 g OF
FURNACE OIL SLUDGE

| | 700 g | | | | | |
|---|---|---|---|---|---|---|
| | Conical flask | | | RB flask | | |
| | | Rate of | | | Rate of | |
| | | Water | Wt. % | | Water | Wt. % |
| | Temperature | Collection | Water | Temperature | Collection | Water |
| Sl. No. | (° C.) | (g/min) | Collected | (° C.) | (g/min) | Collected |
| 1 | 98 | 4.19 | 65.70 | 107 | 0.44 | 51.86 |
| 2 | 117 | 1.39 | 68.86 | 112 | 0.14 | 52.21 |
| 3 | 122.2 | 4.39 | 71.64 | 118.7 | 0.75 | 58.67 |
| 4 | 127.4 | 2.05 | 75.19 | 123 | 1.40 | 74.58 |
| 5 | 132 | 2.20 | 77.23 | 127 | 0.89 | 79.32 |
| 6 | 150.6 | 2.05 | 83.56 | 132 | 0.52 | 81.59 |
| 7 | | | | 150 | 0.52 | 87.63 |

It was seen that the oil bath provided uniform heat flux through the entire surface of conical flask in contact with oil, which removed the discrepancies in heat transfer associated with the heating mantle. Flat surface allowed for rapid heat transfer causing forced convection of liquid, and instantaneous foaming was aided as long as sludge volume was contained within the vessel. Shape of conical flask was found to allow for more heat transfer from surface of glass for a given increase in percent volume.

Total surface area of material in contact with oil bath for a conical flask was much greater than that for RB flask for the same amount of sludge taken. Moreover, height of sludge in conical flask was smaller than that for RB flask. It was explored that more heat flux was passing through conical flask than through RB flask and vapor bubbles formed during boiling had a smaller mean free path to travel through to escape sludge. It was observed that the rate of water collection was closely related to the rate of heat flux transmitted through sludge. Accordingly, it was established that more the difference in temperature between oil bath and sludge, more is the rate of water collected. Since minimum temperature difference of 10° C. was maintained between the oil bath temperature and sludge temperature, oil bath temperature was increased in steps from 130° C. to 150° C. and 150° C. to 170° C. Accordingly, the rate of water collection was observed to be increased whenever oil bath temperature was shifted.

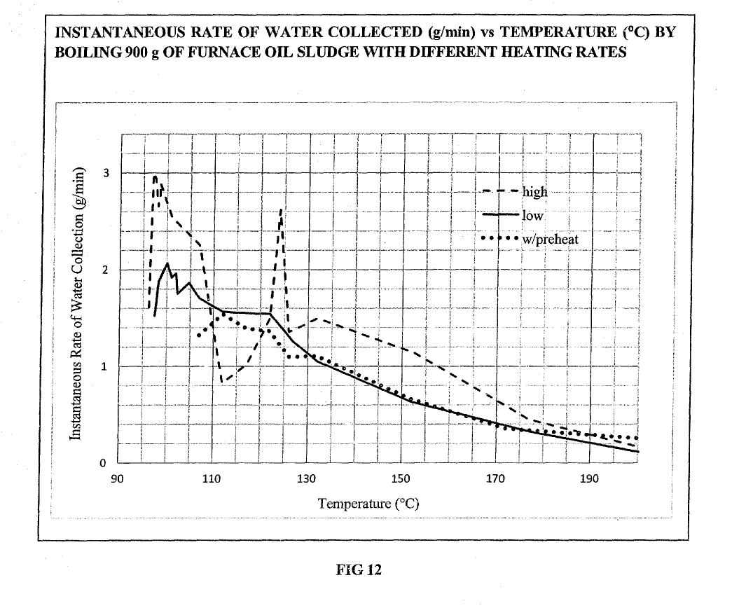

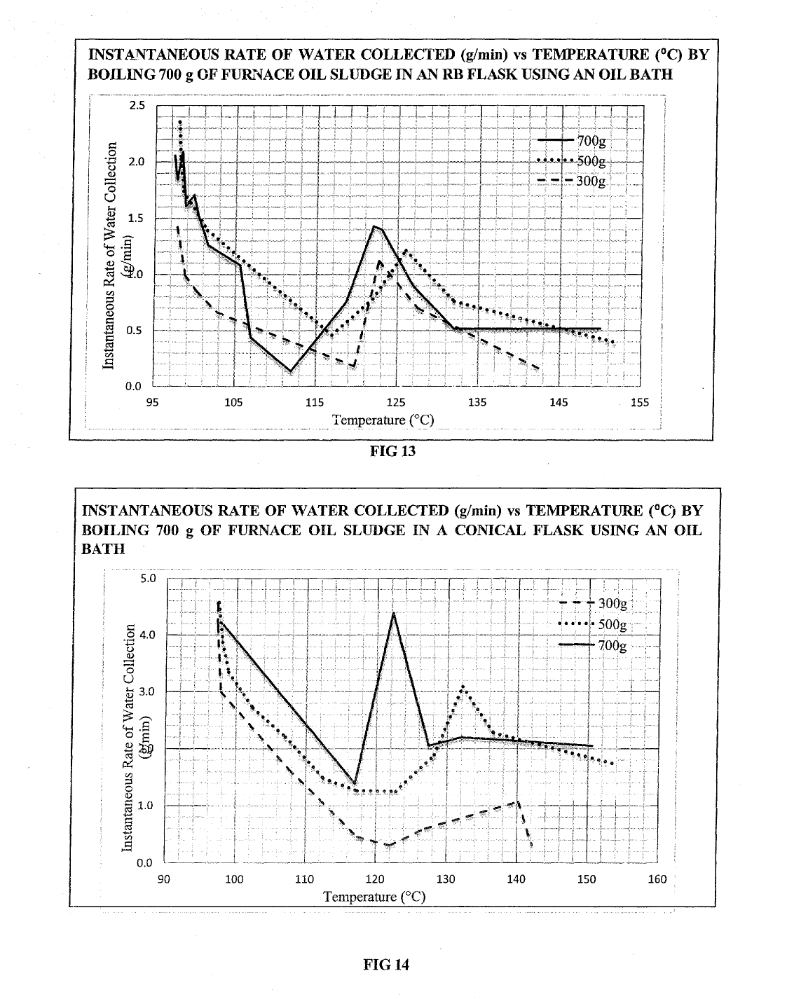

Referring to graphs shown in FIGS. 13 and 14, initial rate of water removal was similar for all quantities of sludges in the conical flask and fell down as temperature was increased. It was seen that the rate dropped down more for 300 g sludge than for others. This was believed to be because more wt. % water was collected at a lower temperature in case of 300 g than for 500 g and 700 g sludge. By 107° C., 75% water was collected for 300 g sludge, whereas 63% and approximately 65% water was collected for 500 g and 700 g respectively sludge by 107° C.

There was observed to be significantly less variation in rate of water collection at a given temperature in RB flask for different quantities of sludges. Rate of collection was comparable for 500 g and 700 g sludge but rates were slightly lower for 300 g sludge. It was seen that 48%, 54% and 58% water was collected by 117° C. for 300 g, 500 g and 700 g sludges respectively. This trend was opposite to what was observed for the conical flask. This could be because of the shape of RB flask. The curved surface of bottom of the RB flask provided more heat flux towards the sides of flask rather than the bottom. Accordingly, it was determined that greater height of 700 g sludge could have caused convective currents in the sludge which allowed more water to be removed at a lower temperature.

### Example 9

### Study of Volume Expansion Due to Boiling

In order to evaluate the process of boiling to remove bound water from sludge, experiments were conducted using furnace oil sludge with and without Sodium Lauryl Sulphate (SLS). Accordingly predefined portions of sludge were taken in an RB flask followed by continuous heating in a mantle heater, while continuously monitoring temperature of the material using a digital thermometer. A measuring rod was inserted into RB flask to mark the initial level of liquid. The level of foam was measured at periodic intervals once the heating started and then the volume of material during boiling was calculated each time. Volume of material at different temperatures was compared to study foam characteristics.

TABLE 9.1
COMPARISON OF BOILING OF FURNACE OIL SLUDGE
WITH & WITHOUT SLS AT VARIOUS TEMPERATURES

| 300 g Furnace Oil Sludge | | | | 300 g Furnace Oil | | | |
|---|---|---|---|---|---|---|---|
| with SLS in 2 (L) RB flask | | | | Sludge in 2 (L) RB flask | | | |
| | Tem- | | | | Temper- | | |
| Sl. | perature | Time | Volume | Sl. | ature | Time | Volume |
| No. | (° C.) | (min) | (ml) | No. | (° C.) | (min) | (ml) |
| 1 | 26.0 | 0.00 | 500.68 | 1 | 80.2 | 0.00 | 336.80 |
| 2 | 30.5 | 5.50 | 445.45 | 2 | 86.4 | 27.85 | 344.96 |
| 3 | 55.0 | 15.08 | 394.01 | 3 | 91.6 | 36.90 | 361.50 |
| 4 | 69.1 | 23.00 | 394.01 | 4 | 95.3 | 46.62 | 385.43 |
| 5 | 95.7 | 34.67 | 928.71 | 5 | 99.3 | 55.33 | 537.11 |
| 6 | 97.5 | 36.18 | 2460.67 | 6 | 100.0 | 60.20 | 463.60 |
| 7 | 97.3 | 36.88 | 2570.00 | 7 | 99.6 | 65.92 | 344.96 |
| 8 | 97.6 | 38.00 | 2570.00 | 8 | 100.5 | 70.82 | 385.43 |
| 9 | 98.0 | 41.42 | 1173.48 | 9 | 101.2 | 81.10 | 537.11 |
| 10 | 97.4 | 45.73 | 1264.03 | 10 | 102.4 | 89.73 | 411.39 |
| 11 | 97.5 | 48.58 | 1303.87 | 11 | 102.5 | 95.15 | 576.02 |
| 12 | 98.0 | 53.68 | 1150.43 | 12 | 102.7 | 103.17 | 454.49 |
| 13 | 98.0 | 64.17 | 1289.59 | 13 | 103.9 | 107.68 | 445.45 |
| 14 | 97.8 | 71.85 | 1264.03 | 14 | 102.9 | 121.32 | 463.60 |
| 15 | 97.9 | 84.00 | 994.28 | 15 | 100.7 | 126.77 | 344.96 |
| 16 | 97.5 | 98.00 | 1291.47 | 16 | 102.6 | 146.05 | 376.92 |
| 17 | 98.2 | 102.25 | 1351.43 | 17 | 103.1 | 154.73 | 394.01 |
| 18 | 98.2 | 106.33 | 1962.42 | 18 | 104.3 | 165.00 | 344.96 |
| 19 | 97.5 | 115.33 | 2570.00 | 19 | 103.7 | 171.83 | 283.14 |
| 20 | 97.3 | 144.17 | 1462.12 | 20 | 106.3 | 181.10 | 304.95 |
| 21 | 97.6 | 152.58 | 928.71 | | | | |
| 22 | 97.4 | 158.58 | 394.01 | | | | |
| 23 | 97.5 | 169.25 | 328.73 | | | | |

Expansion of liquid volume was observed to study the characteristics of foam formed during boiling of sludge. During boiling of furnace oil sludge, volume of sludge expanded to a peak value of 576 ml, which was about twice the volume of initial sludge. This provided a measure of the amount of vapor trapped within sludge after being formed. Accordingly, it was seen that the rate of water collection reached its peak during foaming volume, mainly because of the higher heat flux on account of increased surface area but also because of the easy escape route for vapours through rising bubbles.

There were two significant peak volumes in boiling of furnace oil sludge containing SLS. The first peak occurred just before boiling point of water was reached. This peak was not due to water vapor escaping through the sludge, but rather due to the expansion of air bubbles trapped within the sludge due to its low surface tension. Air bubbles broke when internal pressure of these bubbles exceeded surface tension forces from elevated temperature. However, water vapor bubbles were formed once boiling point was reached and volume of sludge expanded exponentially thereafter. It was observed that more vapours were trapped due to low surface tension of furnace oil sludge. Accordingly, greater surface area and easier escape for further water vapor implied that more water could be removed from sludge containing SLS during peak foaming temperature range. Accordingly, it was seen that foam reached the top of RB flask during peak foaming range, at which point they were broken by the obstruction in path of foam.

### Example 10

### Impact of Rate of Heating, Experimental Setup, and Different Type of Sludges on Entrainment During Boiling for Removal of Bound Water from Different Sludges

In order to better understand the impact of rate of heating, different experimental setup, and different types Sludges, on entrainment, experiments were conducted in traditional/modified Dean and Stark apparatus. Accordingly, predetermined weights of different sludge were taken in an RB flask of a traditional/modified Dean & Stark Apparatus followed by heating at different rates. In one set of experiments Furnace oil sludge was taken and subjected to varied heat rates by controlling the mantle heater, one with slow heat rate till boiling point and other with rapid heat rate till boiling point and then the mantle positions were changed to the required level for comparison.

In other set of experiments, Furnace oil sludge with and without Sodium Laurel Sulfate/Sodium Chloride and Diesel sludge with SLS (Sodium Laurel Sulfate) were taken and subjected to similar heat rate conditions. The vapors of water and hydrocarbons, after condensing them with circulating cold water at 5-6° C. in an insulated condenser were collected in the receiver. The condensates were collected in a separating flask using a stop cork at the bottom of the receiver, at predefined temperatures. Accordingly, hydrocarbons and water were individually weighed each time after phase separation was achieved in the separating flask. The procedure was followed until no water droplets were collected, after which the mantle heater was switched off.

Sodium Content was estimated using Flame Photometry analysis and Calorific value of the fluid was measured using Bomb Calorimeter. In an alternate experimental setup, an inverted tube was added to have an alternative path for vapors and if present any entrainment of liquid. In another alternative setup, a cyclone was added to separate the liquid from vapor and recycled back. Consequently, the effects of these setup alternatives on entrainment were studied with their calorific value determined by Bomb Calorimeter test.

TABLE 10.1
REMOVAL OF BOUND WATER FROM FURNACE OIL SLUDGE AND COMPARISON
OF VARIOUS PROPERTIES TO STUDY THE ENTRAINMENT OF LIQUID IN VAPOR

| | | | | | | Diesel |
|---|---|---|---|---|---|---|
| | | Furnace Oil Sludge | | | | Sludge |
| | | | with | | | with |
| | | | Sodium | with | with | Sodium |
| Sl. | | | Laurel | Sodium | Higher | Laurel |
| No. | PARTICULARS | — | Sulfate | Chloride | Heat rate | Sulfate |
| 1 | Wt. % Hydrocarbons Collected | 4.93 | 3.13 | 4.51 | 3.86 | 24.49 |
| 2 | Wt. of adherings (g) | 8.1 | 9.3 | 2.88 | 16.29 | 9.72 |
| 3 | Calorific Value of hydrocarbons | 9,964 | 9,964 | 9,964 | 9,964 | 10,827 |
| | in sludge (kcal/kg) | | | | | |

EXPERIMENTAL SETUP WITH NO INVERTED TUBE/CYCLONE

| | | | | | | |
|---|---|---|---|---|---|---|
| 4 | Sodium Content in Condensate | — | 3.64 | 6.12 | — | 5.61 |
| | Water (ppm) | | | | | |
| 5 | Calorific Value of Condensed | 10,612 | 10,662 | 10,611 | 10,558 | 10,787/ |
| | Hydrocarbons (kcal/kg) | | | | | 10,924* |

EXPERIMENTAL SETUP WITH INVERTED TUBE

| | | | | | | |
|---|---|---|---|---|---|---|
| 6 | Calorific Value of Condensed | 10,754 | 10,769 | — | 10,760 | — |
| | Hydrocarbons (kcal/kg) | | | | | |

EXPERIMENTAL SETUP WITH CYCLONE

| | | | | | | |
|---|---|---|---|---|---|---|
| 7 | Calorific Value of Condensed | 10,765 | 10,796 | — | 10,766 | — |
| | Hydrocarbons (kcal/kg) | | | | | |

It was observed that, 24.49% of hydrocarbons were collected in case of Diesel boiling. For Furnace oil, wt. % of hydrocarbons collected was nearly the same in all cases. However, weight of material which was adhering to glassware other than RB flask, was highest for Furnace oil with higher rate of heating. It was observed that higher rate of heating resulted in more explosive bumping of Furnace oil, which predicted higher entrainment during boiling. It was explored that higher Diesel collection could be due to stripping of light hydrocarbons as Diesel was having lower boiling range.

It was observed that with the default Dean and Stark setup, where no inverted tube or cyclone was present, the calorific value of condensed hydrocarbons was lower for Furnace Oil sludge with higher heating rate and the calorific value of condensed hydrocarbons was higher and comparable for Furnace Oil Sludges with and without salts. Accordingly, it was established that as Furnace oil sludge with high heating rate had maximum number of explosive discharge of liquid which promoted said entrainment. Consequently, Furnace Oil fractions with higher boiling range were observed to escape to the receiver which has lower calorific value. Moreover, the condensate hydrocarbons collected in higher heating rate boiling appeared dark yellow in color, probably due to contamination by heavier fractions of hydrocarbons.

While foaming was observed during boiling Furnace oil sludge with SLS, it was seen that a slightly rather higher calorific value condensate hydrocarbons were obtained, when compared with condensate hydrocarbons from Furnace oil sludge boiling. Accordingly, it was established that the total amount of hydrocarbons collected for Furnace oil Sludge with SLS could be lower leading to even lighter fraction of hydrocarbons being collected thereby producing higher calorific value. Further it was observed that the hydrocarbons collected appeared turbid, suggesting possibly dissolved water. The fraction of water collected as condensate in case of Furnace Oil Sludge with SLS and Sodium Chloride experiment appeared to be milky white suggesting presence of hydrocarbon traces in condensate water.

Further, it was observed that the calorific value of condensate hydrocarbons after Diesel boiling was actually lower than calorific value of Diesel. This could be probably due to traces of water dissolved in condensate. After separation of water by centrifuge the calorific value of condensate oil was found to be 10,924*kcal/kg.

Further, it was observed that with presence of cyclone the amount of liquid entrapment was minimal in all three Furnace oil experiments and gave a fairly high calorific value of around 10,750 kcal/kg. Further, it was observed that the presence of inverted tube was as efficient in stopping entrainment as cyclone in all three tests with Furnace oil. It was also observed that the entrainment percentage could be reduced if the height of the evaporation column above the RB flask, as vapor entrainment was found to be reduced due to longer path for vapor as well as vapor condensation in the column itself.

### Example 11

### Selectively Distilling Out Value Added Low Boiling Hydrocarbons from Viscous Hydrocarbon Sludges at Temperature Lower than its Boiling Point in Mixture by Boiling with Water

Experiments were conducted to distil low boiling fraction hydrocarbons from different types of viscous hydrocarbon sludges at a lower temperature than their boiling range, by distilling along with free water to eventually recover higher percent of marketable hydrocarbons and partially remove bound water from sludge. Accordingly, predetermined amounts of Furnace oil/ONGC sludge were taken in a conical flat-bottom flask of a modified Dean and Stark Apparatus as described in FIG. 7 followed by continuous heating thereof in an oil bath. While, the temperatures of the material and oil bath were monitored continuously, maintaining sufficient temperature difference for heat transfer. A high pressure water sprayer was attached in the setup such that fine droplets of water could be dispersed by spraying radially to aid continuous foaming. The vapors of bound water and hydrocarbons, after condensing them with circulating cold water at 5-6° C. in an insulated condenser were collected in the receiver. The condensates were taken out and collected in separating flask using a stop cork at the bottom of the receiver. After phase separation was achieved in the separating flask, hydrocarbons and water were individually weighed each time. This procedure was followed till the temperature of material reached maximum of about 122° C., after which the oil bath was switched off. Finally, the hydrocarbon samples retrieved were analyzed qualitatively using calorific value determined by Bomb Calorimeter test.

TABLE 11.1
BOILING OF DIFFERENT SLUDGES WITH CONTINUOUS
SPRINKLED FREE WATER FOR COLLECTION OF
CONSIDERABLE FRACTION OF HYDROCARBONS

| Sl. No | PARTICULARS | TEST 1 | TEST 2 |
|---|---|---|---|
| 1 | Type of Sludge taken | ONGC | Furnace oil |
| | | Sludge | Sludge |
| 2 | Wt. of Sludge taken (g) | 901.56 | 902.66 |
| 3 | Wt. % Water in present in above Sludge | 45.7909 | 49.1522 |
| 4 | Wt. of Water present in Sludge | 412.83 | 443.68 |
| 5 | Wt. of Hydrocarbons present in Sludge | 488.72 | 458.98 |
| 6 | Total Wt. of Free Water added (g) | 400.5 | 400.32 |
| 7 | Temperature (° C.) | 97.4 | 97.6 |
| 8 | Wt. % of Hydrocarbons Collected upto above | 12.40 | 5.04 |
| | Temperature | | |
| 9 | Temperature (° C.) | 101.5 | 101.4 |
| 10 | Wt. % of Hydrocarbons Collected upto above | 15.58 | 7.74 |
| | Temperature | | |
| 11 | Temperature (° C.) | 112 | 112 |
| 12 | Wt. % of Hydrocarbons Collected upto above | 16.15 | 8.25 |
| | Temperature | | |
| 13 | Temperature (° C.) | 122 | 122 |
| 14 | Wt. % of Hydrocarbons Collected upto above | 16.42 | 8.80 |
| | Temperature | | |
| 15 | Calorific Value of Sludge taken (kcal/kg) | 5,243 | 4,891 |
| 16 | Calorific Value of Condensate Hydrocarbons | 10,543 | 10,589 |
| | (kcal/kg) | | |

It was observed that, about 77% water, including free water added was separated in both Test 1 and Test 2 by temperature of 122° C. along with almost twice the amount of Hydrocarbons than what was usually collected. As evaporating bound water was continuously replaced by free water, the ratio of water to hydrocarbons in the sludge was kept steady. The freshly added water soaked up heat, maintaining the temperature and promoted further foaming in the material. Consequently, foaming appropriated heat throughout the material and maintained at a lower temperature. As water vaporized and separated from the sludge, stripping of lighter Furnace oil fraction was observed to separate more Hydrocarbons at a lower temperature than that could be obtained through fractional distillation of oil.

Further, it was observed that the appearance of the condensed Hydrocarbons was transparent, indicating valuable fraction of Hydrocarbons. It was further supported by the calorific value of the condensed Hydrocarbons which was much higher than the initial sludge and comparable to that of motor fuels, signifying the high market value of hydrocarbons. Further, it was observed that the viscosity/pourability of the condensed Hydrocarbons was low and closer to that of water.

### Example 12

### Removal of Bound Water from Furnace Oil Sludge Containing 50 Wt. % Water by Thin Layer Boiling in a Flat Bottom Flask

In order to achieve highest percentage of water removal from Furnace oil sludge containing 50 wt. % water, experiments were designed and conducted to evaluate the efficacy of thin layer boiling in a flat bottom flask with oil bath as heating medium.

Accordingly, predetermined amount of Furnace oil sludge was taken in a flat bottom flask of a modified Dean and Stark Apparatus followed by continuous heating thereof in an oil bath, while continuously monitoring the temperature of material in the flat bottom flask with a digital thermometer. The rate of heating was kept rapid during the entire process. The vapors of bound water and hydrocarbons were collected in the receiver after condensing them in an insulated condenser with circulating cold water at 5-6° C. The condensates were taken out and collected in separating flask using a stop cork at the bottom of the receiver. After phase separation was achieved in the separating flask, hydrocarbons and water were individually weighed each time. The procedure was followed till the entire amount of water was removed, after which the flask was removed from the oil bath to avoid unnecessary heating and condensation of furnace oil. Finally, the water and hydrocarbon samples retrieved were analyzed quantitatively using mass balance study.

TABLE 12.1
REMOVAL OF BOUND WATER FROM FURNACE
OIL SLUDGE BY THIN LAYER BOILING

| Sl. | | | | |
|---|---|---|---|---|
| No. | PARTICULARS | TEST 1 | TEST 2 | TEST 3 |
| 1 | Mixing Time during Sludge Preparation | 2 | 5 | 8 |
| | (min) | | | |
| 2 | Wt. % Bound Water Present in Sludge | 49.6213 | 49.5432 | 49.6754 |
| 3 | Wt. of Sludge taken (g) | 100.13 | 100.20 | 100.07 |
| 4 | Wt. of Water Present in the Sludge (g) | 49.69 | 49.64 | 49.71 |
| 5 | Wt. of Hydrocarbons Present in Sludge (g) | 50.44 | 50.56 | 50.36 |
| 6 | Low Temperature I (° C.) | 100.5 | 99.3 | 98.9 |
| 7 | Wt. % of Water Collected upto above | 58.95 | 67.95 | 79.44 |
| | Temperature | | | |
| 8 | Wt. % of Hydrocarbons Collected upto | 1.56 | 1.59 | 1.68 |
| | above Temperature | | | |
| 9 | Rate of Water Collection upto above | 4.48 | 4.53 | 4.58 |
| | Temperature (g/min) | | | |
| 10 | Low Temperature II (° C.) | 106.1 | 104.3 | 104.1 |
| 11 | Wt. % of Water Collected upto above | 72.56 | 81.44 | 84.23 |
| | Temperature | | | |
| 12 | Wt. % of Hydrocarbons Collected upto | 3.45 | 3.21 | 2.77 |
| | above Temperature | | | |
| 13 | Rate of Water Collection upto above | 2.87 | 3.94 | 4.09 |
| | Temperature (g/min) | | | |
| 14 | High Temperature I (° C.) | 118 | 118 | 118 |
| 15 | Wt. % of Water Collected upto above | 97.96 | 92.63 | 90.63 |
| | Temperature | | | |
| 16 | Wt. % of Hydrocarbons Collected upto | 4.51 | 4.6 | 3.99 |
| | above Temperature | | | |
| 17 | Rate of Water Collection upto above | 1.70 | 2.22 | 3.57 |
| | Temperature (g/min) | | | |
| 18 | High Temperature II (° C.) | — | 125 | 128 |
| 19 | Wt. % of Water Collected upto above | — | 97.56 | 97.67 |
| | Temperature | | | |
| 20 | Wt. % of Hydrocarbons Collected upto | — | 4.43 | 4.69 |
| | above Temperature | | | |
| 21 | Rate of Water Collection upto above | — | 1.94 | 2.06 |
| | Temperature (g/min) | | | |
| 22 | Total Wt. % of Water Collected | 97.96 | 97.56 | 97.67 |
| 23 | Average Rate of Water Collection | 1.70 | 1.95 | 2.06 |
| 24 | Average Rate of Hydrocarbons Collection | 0.08 | 0.09 | 0.10 |
| 25 | Total Wt. % of Hydrocarbons Collected | 4.51 | 4.43 | 4.69 |
| 26 | Wt. % of Loss due to Evaporation, spilling, | 0.93 | 1.21 | 1.26 |
| | etc. | | | |
| 27 | Total Time taken for the Collection | 34.68 | 32.39 | 30.57 |
| | Process (min) | | | |
| 28 | Residual Water Present left over | 207.77 | 207.21 | 209.12 |
| | Hydrocarbons as determined by BTX | | | |
| | Test (PPM) | | | |

It was observed that final residual water percentage in all three tests was around 250 ppm, even though the initial water content in the sludge was 50%. Although the rate of heating (AT) was high, the bumping of material which was observed in previous examples was not observed in this case. This could be probably due to very thin layer of viscous hydrocarbon present which could have enabled easier upwards flow of vapor than other cases.

Further it was observed that it was faster to remove entire water from Furnace oil sludge with 8 min. preparation mixing time, followed by sludge with 5 min. mixing time and finally 2 min. mixing time. It was also observed that the 2 minute mixing achieved completion at a lower temperature followed by 5 minutes and 8 minutes. Although this difference in rates and final temperature was observed, initially at low temperature the rate of water collection was similar for all cases at about 4.5 g/min. The % water collected was higher at 79.44% for Test 3 while lowest for Test 1. Subsequently at higher temperature the rate of water collection was higher for Test 3 and lowest for Test 1 as temperature rose faster for Test 3 along with time.

It was observed that plumes of vapor rose through the sludge foaming it in the process on account of high specific surface area with higher heat flux. The reduced density and viscosity on account of foaming provided rapid vapor formation at low temperature. Finer water droplets present within the liquid film surrounding vapor bubbles in foam were removed more easily as vapor escape route was readily available for such water droplets, which could otherwise have to be superheated and removed from bulk of sludge through explosive discharge. This established that thin layer boiling could be more efficient process to remove water from sludge at faster rate and at a lower temperature.

### Example 13

### Removal of Bound Water from Sludge by Rapid Boiling with Higher Heat Flux

In order to better understand rapid boiling with large heat flux, new apparatus was designed as per requirements as described in FIG. 7. Accordingly, predetermined amount of sludges were taken in a conical frustum shaped vessel and heated in an oil bath, thereby monitoring temperature of material and oil bath continuously. The vapours of water and hydrocarbons were allowed to condense in insulated condensers with cold water circulating at a temperature of 5-6° C. The condensates were allowed to settle in the receiver and collected in a separating flask at definite intervals using a stop cork at the bottom of the receiver. After phase separation was achieved in the separating flask, water and hydrocarbon samples were weighed each time. The procedure was continued till no more condensation of water was observed.

TABLE 13.1
REMOVAL OF BOUND WATER FROM FURNACE OIL
SLUDGE BY RAPID BOILING WITH LARGE HEAT FLUX

| Sl. | | | |
|---|---|---|---|
| No. | PARTICULARS | TEST 1 | TEST2 |
| 1 | Wt. of Sludge taken (g) | 2000.6 | 2002.2 |
| 2 | Wt. % of Water present in Sludge | 49.621 | 49.927 |
| 3 | Wt. of Water present in the Sludge (g) | 992.70 | 999.61 |
| 4 | Wt. of Hydrocarbons present in Sludge (g) | 1007.88 | 1002.55 |
| 5 | Temperature (° C.) | 97.7 | 97.5 |
| 6 | Wt. % water collected upto above temperature | 29.54 | 20.02 |
| 7 | Avg. Rate of Water Collected upto above Temperature (g/min) | 4.41 | 6.07 |
| 8 | Temperature (° C.) | 101.8 | 101.6 |
| 9 | Wt. % water collected upto above temperature | 88.34 | 76.32 |
| 10 | Avg. Rate of Water Collected upto above Temperature (g/min) | 4.8 | 6.09 |
| 11 | Temperature (° C.) | 127 | 127.1 |
| 12 | Wt. % water collected upto above temperature | 99.22 | 98.39 |
| 13 | Avg. Rate of Water Collected upto above Temperature (g/min) | 3.76 | 5.31 |
| 14 | Final Temperature (° C.) | 132 | 133.8 |
| 15 | Wt. % Water collected upto above Temperature | 99.24 | 98.47 |
| 16 | Total Time taken for experiment (min) | 332.4 | 229.8 |
| 17 | Wt. % Water present in left over Hydrocarbons as determined | 62 | 136 |
| | by BTX Test | | |

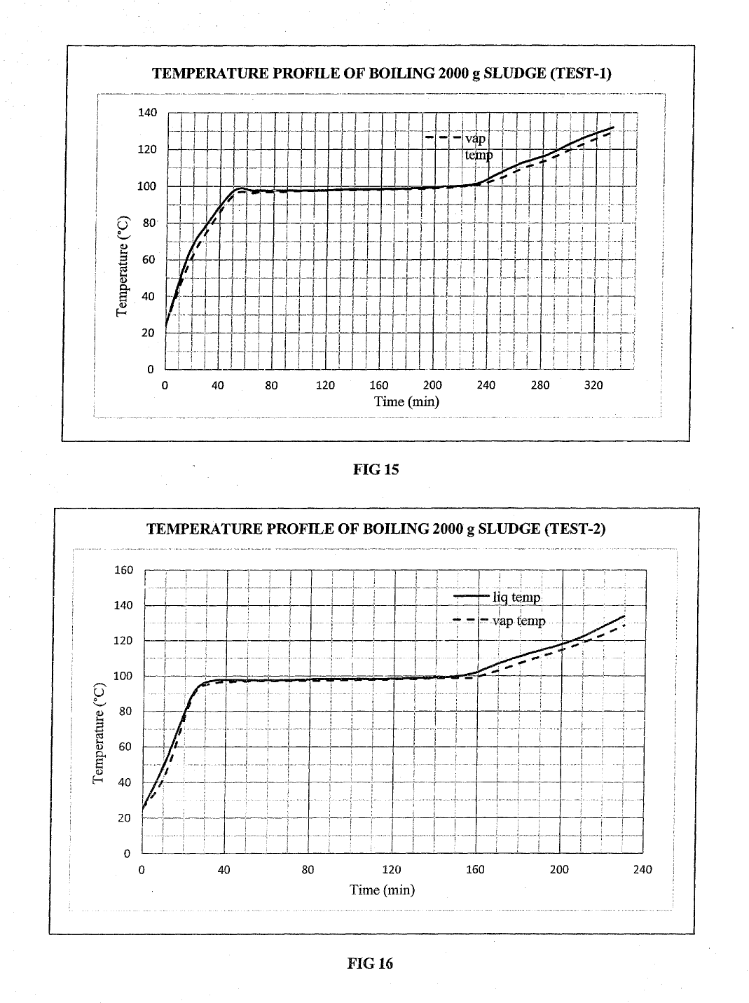

It was observed that about 88 wt. % water was collected by a temperature of 102° C. for Test-1 and lower percentage was for Test-2 at 76 wt. %, although almost all water was collected by a temperature of 132° C. From the graphs shown in FIG. 15 & FIG. 16, it was observed that the holding time at around boiling point was more in case of Test-1 thus water collected was also high at the same temperature.

In case of Test-2, sludge was observed to be comparatively weak, resulting in pooling of water at the bottom of the sludge, for which the only escape route possible would be through explosive discharge, implying higher rate of water collection. As observed in previous examples with heating mantle, the temperature for such explosion was high due to presence of heating element at the sides and consequent need for the entire sludge to be heated to higher temperature, before the pool of water was heated. Although in Test 2, since uniform heating was applied, the temperature for similar explosions was comparatively lower.

Further in case of Test 1, sludge may have more number of smaller size droplets, as a consequence more foaming was observed. It was thus established that almost all water could be collected with higher heat flux irrespective of the variations in sludge properties.

It was observed that the degree of superheat required for vapour to escape from liquid pool by expansion was less. As a result the final vapour temperature was lower at around 124° C. in either case. Likewise higher proportion of liquid was collected by 102° C. due to very rapid heating and the time frame over which vapour was heated more than liquid was insignificant. Increase in volume of liquid was observed to aid sustaining foam based water removal for a longer period under intense conditions thereby allowing a lot more water to be collected at a lower temperature. Further, it was observed that the thermal foam breaker was highly efficient in breaking excess foam generated by higher heating rate.

It was also observed that rate of water collection was more compared to RB flask and even more when compared to heating in mantle heater. Because, Oil bath provided uniform heat flux through the entire surface of conical flask in contact with oil, which removed the discrepancies in heat transfer associated with heating mantle. Specific area for heat transfer surface, for a given volume was observed to be more for conical flask than RB and also, flat surface was observed to allow for rapid heat transfer thereby causing forced convection of liquid. In addition, instantaneous foaming was aided as long as sludge volume was contained within the vessel.

Accordingly, it was established that explosive splattering was massive and continuous throughout the boiling process. It was also anticipated that the conical flask could have helped containing entrainment from splattering. Furthermore, it was observed that the temperature probe for measuring vapour temperature could be positioned such that temperature would not be affected by such splattering.

Finally, it was thus established that more water could be collected at lower temperature because of thin layer boiling and also because of reduced temperature difference between vapour and liquid. It was also established that stationary thin film boiling could be possible for flasks with large flat bottom surfaces and/or triangular shapes that could be utilized with uniform heating medium similar to an oil bath.

The present invention has been described in an illustrative manner, and it is to be understood that the terminology used is intended to be in the nature of description rather than of limitation. It is not intended to be exhaustive or to limit the invention to the precise form disclosed. Many modifications and verifications are possible in light of the above teaching. It is intended that the scope of the invention be limited not by this detailed description, but rather by the claims appended hereto. It is also to be understood that the following claims are intended to cover all of the generic and specific features of the invention described herein.

1. A process for boiling petroleum sludges, emulsions and water bearing hydrocarbons, preferably with determined quantity of water present, said process comprising the steps of:
a) pretreating a sludge mixture for removal of unbound water; salts; solids; water soluble emulsifiers; water-free, free flowing hydrocarbons followed by segregating remaining sludge on account of viscosity using a plurality of separation equipment for recovering a plurality of fractions therefrom;
b) treating the recovered fractions in step a) separately for removal of both bound and unbound water by a rapid foam induced boiling in a heating vessel with heat induced turbulent circulation of liquid through a distributed, multi layered, rapid heat flux leading to rapid generation of a foamed mass consisting of vapors of water and steam-stripped low boiling hydrocarbons, and a film consisting of remaining hydrocarbons and high boiling, smaller sized, dispersed water droplets;
c) adding fine spray of hot water at the end of foam stage, with a view to sustain foaming of the mass over an even longer period to aid steam-stripping of even more of low boiling hydrocarbons from viscous hydrocarbons and also to facilitate further removal of fine water droplets present in thin film through boiling during thermal foam breaking;
d) treating the foamed layer in steps b) and c) with a thermal foam breaker thereby additionally boiling out higher boiling point fine water droplets from thin foam layer followed by separating vapors of water and low boiling hydrocarbons from liquid and aiding their easy release from very low density and low viscosity layer, thus avoiding their subsequent condensation and entrainment in viscous hydrocarbons once foams subside;
e) removing entire fraction of water contained in said viscous hydrocarbons through thin film boiling along with further steam stripping of even higher boiling hydrocarbons with substantially reduced heat flux over an extended time as thin film requires less superheat for vapor to expand for facilitating escape thereof from said viscous hydrocarbons thereby avoiding explosive discharge of said vapor without overheating thereof; and
f) recovering original hydrocarbons in two separate fractions, one a viscous layer as residue and the other a lighter fraction collected through steam-stripping, in marketable forms with highest possible commercial value thereof in addition to recovering bound and unbound water present in said sludge mixture for subsequent, environmentally safe and useful applications thereof.

2. The process for boiling as claimed in claim 1,
wherein the separation equipment is selected from hot centrifuge, cold centrifuge, vibratory flow-table, settling tank with or without aeration and the like,
wherein the heating vessel facilitates boiling under intense foaming by delivering extremely high heat flux for removal of low boiling point water present in the sludge mixture in a range of about 70% to 90 wt % at a temperature below 110° C.,
wherein the heating vessel has a heat supply that is synchronized with the rate of foam breaking in thermal foam breaker and the rate of condensation of water in condenser to prevent overloading of downstream equipment in said process, and
the heating vessel facilitates thermally induced vigorous circulation thereby eliminating the need for mechanical stirrer.

3. The process for boiling as claimed in claim 1,
wherein said pre-treatment of sludge reduces quantum of the sludge mixture being processed thus reducing cost of equipment as well as operating costs in addition to reducing energy consumption in said process, and
wherein said pre-treatment of the sludge mixture removes salts, solids, water soluble emulsifiers, unbound water and free flowing hydrocarbons making subsequent processing easy and enhancing the overall commercial value of retrieved hydrocarbons.

4-6. (canceled)

7. The process for boiling as claimed in claim 1,
wherein said process facilitates rapid boiling through a heating vessel having multi-layered heating surfaces at the bottom portion thereof, and
wherein said process facilitates boiling of sludge to remove entire water present therein in a temperature range of about 100° C. to 130° C. under atmospheric pressure.

8. (canceled)

9. The process for boiling as claimed in claim 1,
wherein said foaming in the heating vessel is sustained in a controllable manner by adding the sludge mixture in batches thereby producing a large mass of significantly water free sludge in a single batch within a given vessel,
wherein said foaming in the heating vessel is further controlled by temperature and flow rate of heating oil as well as by varying the number of heating surfaces utilized in the heating vessel, and
wherein the said foaming in the heating vessel is sustained over a longer time period by dispersing a spray of free water at the bottom portion of said heating vessel that further assists in steam stripping of low boiling hydrocarbons from the sludge mixture and further removal of smaller droplets by way of thin film boiling from foam film in thermal foam breaker.

10. (canceled)

11. The process for boiling as claimed in claim 1,
wherein said heating in the heating vessel is controlled such that all of low boiling water is vaporized in said heating vessel before moving into the foam breaker thereby retaining only higher boiling, smaller water droplets in foam film entering said foam breaker,
wherein the foam based boiling is promoted by accelerating the initial rate of heat flux and/or by reducing the average size of dispersed water droplets in sludge such that heat flux immediately forms foam thereby inducing massive circulation of sludge mass and thereby aiding immediate transport of dispersed water droplets to the heating surface while later method enhances the number of foam bubbles formed in a given pass over heated surface in heating vessel used in said process, and
wherein entire unbound water is removed during foaming stage as vapor without contributing to foaming.

12-13. (canceled)

14. The process for boiling as claimed in claim 1,
wherein the thermal foam breaker is heated by a very high heat flux provided by high temperature heating oil to expand vapor trapped within foam mass thereby rupturing the film surrounding said foams and said foam breaking is further aided by mechanical rupturing foam film by passing through plurality of constricted passages or boiling out small water droplets and low boiling hydrocarbons from foam film,
wherein the thermal foam breaker vaporizes small water droplets residing in foam film due to the high heat flux and easy escape of vapor thus formed from therein without excessively superheating the vapor, and
wherein the thermal foam breaker is slightly inclined in one direction to aid gravity based liquid flow and the liquid separated from foam in thermal foam breaker is recycled back into the heating vessel through the bottom portion of said heating vessel, below the liquid layer without contacting foams.

15-16. (canceled)

17. The process for boiling as claimed in claim 1,
wherein said process utilizes a liquid droplet collector or a cyclone to capture entrained liquids from vapor released through explosive discharge or otherwise from thermal foam breaker to completely separate entrained liquids from vapor before condensation thereof, wherein the cyclone is maintained at a high velocity and in hot condition to obtain clear separation of liquid from vapors such that the liquid separated is heated in order to reduce viscosity for easy transportation thereof to the heating vessel, through the bottom portion of said heating vessel, under the liquid level, without contacting rising foams,
wherein said process utilizes a condenser that accommodates a surge in load due to explosive discharge and condenses light hydrocarbons and water vaporized during water removal,
wherein said process utilizes waste heat obtained from other industrial or commercial process for boiling in a co-generation mode to enhance economic profitability,
wherein said process utilizes a thin film evaporator during final stage for boiling of the sludge in order to recover smaller, higher boiling point droplets of water with substantially reduced heat flux over an extended time, wherein the thin film evaporator converts sporadic explosive discharge of vapor into muted continuous spluttering as a result of lower extent of superheat required for vapor to expand for escape from viscous hydrocarbons thereby also preventing overheating of the said viscous hydrocarbons, wherein residual water content present in hydrocarbons after foam based boiling is alternatively removed by boiling under aeration with fine inert gas bubbles, atomization or spraying viscous water bearing hydrocarbon into an evaporating chamber, thin film boiling in a heated hydrocyclone or flash evaporating small droplets of water from viscous water bearing hydrocarbons under vacuum, wherein the thin film boiling is carried out in very wide based heating vessels with distributed heating surfaces that allow for low depth of liquid during boiling in said heating vessels, and
wherein said process reduces energy requirement by opting for multi effect evaporator, thermal vapor recompression and mechanical vapor recompression.

18-19. (canceled)

20. The process for boiling as claimed in claim 1, wherein said process recovers heat from vapor by preferably dissipating it into a large water body, to save equipment cost of cooling tower as well as need for cooling water,
wherein said process is terminated at an earlier stage in order to obtain product hydrocarbon with desired tightly held water content as an emulsion fuel, and
wherein said process facilitates addition of non-hydrocarbon soluble and hence easily removable surfactants to enhance foaming of the sludge for easy removal of entire water at a lower temperature.

21-30. (canceled)

31. The process for boiling as claimed in claim 1, wherein thin film boiling facilitates vapor escape induced continuous spluttering thus agitating the mass and thereby eliminating the need for mechanical stirrer,
wherein extent of low boiling free flowing hydrocarbons remove by steam stripping is dependent on the length of time and temperature over which steam stripping was carried out,
wherein low boiling, free flowing hydrocarbons removed via steam stripping has much higher hydrogen to carbon molar ratio as well as calorific value as compared to parent viscous hydrocarbons thereby making it suitable for converting to higher value transport grade fuel, thus enhancing overall value of recovered hydrocarbons, wherein the low boiling, free flowing hydrocarbons removed via steam stripping are recovered at a temperature substantially lower than bubble point of composite hydrocarbon mixture, and
wherein sludges with varying emulsion strength by way of varying size of water droplets can be used in different evaporating chambers of multi-effect evaporator with energy enhanced cost advantage on account of their varying boiling point.

32-35. (canceled)

36. An apparatus for boiling sludges, emulsions and water bearing hydrocarbons under intense foaming conditions, said apparatus comprising:
a heating vessel having conical or conical frustum shape, the heating vessel having a surface heated by circulating hot heating oil, the heated surface heating a sludge mixture in the heating vessel thereby forming a mass of foam therein, the heating vessel having a hot water dispenser positioned therein, the hot water dispenser dispersing fine spray of water towards a heating surface at a bottom portion of the heating vessel, the fine spray of water having a diameter in a range of 10 μm to 150 μm, the hot water dispenser dispersing fine droplets only after foam boiling begins to subside for sustaining foaming for a longer period of time; and
a foam breaker receiving the foam from the heating vessel, the foam breaker having a series of heated, inclined tubes positioned therein at a predefined angular orientation, each heated tube having a narrow slit section connected longitudinally across a length thereof, the foam breaker having a very hot heating oil circulating across entire outer surface thereof, the heated tubes having a distended volume for aiding separation of vapors from the foam, the heated tube and narrow slit section rupturing the foam film surrounding said vapors thereby allowing separated vapors with or without entrained liquid droplets to pass through a liquid droplet collector, the thermal foam breaker sending back the liquid into the heating vessel preferably through a bottom portion thereof such that said liquid is not in contact with vapor, the liquid droplet collector removing entrained liquid droplets from outgoing vapor thereby sending back the collected liquid into the heating vessel preferably through a bottom portion thereof such that said liquid is not in contact with vapor and both the thermal foam breaker and liquid droplet collector dispensing collected liquid below the liquid level in heating vessel.

37. The apparatus for boiling as claimed in claim 36,
wherein said apparatus includes a condenser that condenses water and oil vapor formed in the heating vessel and the thermal foam breaker,
wherein the condenser includes radiator type ambient air based heat exchanger where ambient air is driven across said heat exchanger by a blower with variable speed,
wherein hot condensates emerging out of the ambient air cooled radiator type condenser is further cooled below ambient temperature using chilled water in insulated heat exchanger, and
wherein the condensates flowing back into the heating vessel are not allowed to come in contact with foams in order to avoid their wasteful condensation.

38. The apparatus for boiling as claimed in claim 36, wherein heating oil meant for heating vessel as well as thermal foam breaker and liquid droplet collector is circulated in an insulated, electrically heated, oil bath with temperature controller, and
wherein the heating oil used for heating in said heating vessel is circulated in a close path around the heating vessel.

39. The apparatus for boiling as claimed in claim 36,
wherein said apparatus includes a phase separator to separate condensed low boiling, light, free flowing hydrocarbons and water,
wherein the narrow slit section has a width that is ⅕th to 1/20th of the diameter of cylindrical tubes, and
wherein the rate of heat flux transferred through the heating vessel is controlled by temperature and flow rate of heating oil.

40-42. (canceled)

43. The apparatus for boiling as claimed in claim 36,
wherein the heating vessel includes multiple layers of mesh type mechanical foam breaker with varying mesh size to break larger foam bubbles formed therein and thereby enhancing the rate of foam breaking, and
wherein the heating vessel is maintained under up to 30 mBar gauge pressure to drive out vapors formed through downstream equipment utilized in said apparatus.

44. (canceled)

45. The apparatus for boiling as claimed in claim 36,
wherein the liquid droplet collector comprises a tube that enters and exits from top of a wide, conical shaped container such that the vapors entering from said tube change direction as well as reduce velocity before exiting said container,
wherein the liquid droplet collector is heated by circulating hot heating oil,
wherein the liquid droplet collector acts as a secondary thin film evaporator,
wherein the liquid droplet collector is alternatively insulated without being heated by heating oil, and
wherein the liquid droplet collector has a stopper based isolated funnel to feed in a part of free flowing hydrocarbons present in sludge to fill up the oil trap in foam breaker.

46-47. (canceled)

48. The apparatus for boiling as claimed in claim 36,
wherein temperature of the heating oil in the foam breaker is the highest while that in the thin film evaporator and the liquid droplet collector is the lowest while that in foam based boiling vessel is in between,
wherein the flow rate of heating oil is highest in thin film evaporator and liquid droplet collector followed by that in foam based boiling vessel and the least in foam breaker,
wherein the entire foam breaker is inclined at predetermined angle to aid gravity induced flow of collected liquid from therein, and
wherein the inclined top surface of heating vessel acts as a preliminary foam breaker.

49-53. (canceled)

54. The apparatus for boiling as claimed in claim 36,
wherein vapors of water and light hydrocarbons are alternatively cooled by directly using chilled water through insulated heat exchanger,
wherein all connecting passages in between parts of the apparatus carrying hot vapors are thermally insulated or electrically traced and heated or both to avoid needless and wasteful vapor condensation, and
wherein heating oil chamber surrounding the heating vessel, foam breaker and liquid droplets collector are thermally insulated.

55. The apparatus for boiling as claimed in claim 36, wherein the foam breaker has an oil trap to isolate the liquid droplet collector from foams emerging from heating vessel and to ensure that collected liquid hydrocarbons reach the bottom of heating vessel without contacting the foam layer,
wherein the foam breaker includes an impingement plate that directs the foam away from outward flowing liquid going back to the heating vessel,
wherein the foam breaker has a stopper based isolated discharge tube to empty out and collect the free flowing hydrocarbons used to fill up the oil trap therein, and
wherein the thermal foam breaker is surrounded by a compartmentalized heating oil heating system, wherein cooler heating oil enters into said oil heating system at two oppositely located outermost chambers from underneath thereby getting heated by an electrical heater positioned uniformly across its entire cross section while rising therein, and wherein heated oil rises till the edge of the weir and overflows into adjacent inner chamber such that said hot oil emerges at the bottom of the thermal foam breaker and rises along its surface to overflow out into adjacent side chamber for being collected from the bottom of said chamber by a circulating pump followed by sending it back into the heating chamber to uniformly heat the thermal foam breaker along its entire surface.

56-59. (canceled)

60. The apparatus for boiling as claimed in claim 36,
wherein there is a minimum gap of 10 mm between the base of heating vessel and the base of oil bath to ensure adequate forced circulation of heating oil under the main heating surface of that vessel,
wherein the heating vessel includes glass beads to aid formation of vapor bubbles,
wherein the heating vessel is completely submerged within the hot heating oil in oil bath to avoid needless and wasteful condensation of vapors on its surface, and
wherein the heating vessel itself acts as a thin film evaporator once limited amounts of viscous, substantially dewatered hydrocarbons are heated therein.

61-69. (canceled)
